(19) United States
(12) Patent Application Publication
(10) Pub. No.: US 2023/0287204 A1
(43) Pub. Date: Sep. 14, 2023

(54) OXIDIZED POLYISOBUTENE COMPOUNDS AND METHODS OF MAKING THE SAME

(71) Applicant: The Regents Of The University Of California, Oakland, CA (US)

(72) Inventors: John F. Hartwig, Berkeley, CA (US); Liye Chen, Berkeley, CA (US)

(21) Appl. No.: 17/921,516

(22) PCT Filed: Apr. 29, 2021
(86) PCT No.: PCT/US2021/029976

§ 371 Date: Oct. 26, 2022

Related U.S. Application Data
(60) Provisional application No. 63/017,524, filed on Apr. 29, 2020.

(51) Int. Cl. C08L 23/22; C08F 110/10

(52) U.S. Cl. CPC C08L 23/22; C08F 110/10; C08F 2810/20; C08L 2312/08

(57) ABSTRACT

Disclosed herein, inter alia, are oxidized polyisobutene compounds and compositions and methods of making the same.

### CROSS-REFERENCES TO RELATED APPLICATIONS

This application claims the benefit of U.S. Provisional Application No. 63/017,524, filed Apr. 29, 2020, which is incorporated herein by reference in its entirety and for all purposes.

### BACKGROUND

Polyolefins are quintessential commodity plastics of immense commercial importance, but the lack of functionality can limit their use in many advanced applications. In the past decades, C—H functionalization has emerged as a promising strategy for incorporating functionalities into polymers of ethylene and linear α-olefins. However, functionalization of polyolefins derived from branched α-alkenes remains elusive. These polymers are less reactive, due to steric effects, and they undergo side reactions, such as chain scission, that lead to polymer degradation. Disclosed herein, inter alia, are solutions to these and other problems in the art.

### BRIEF SUMMARY

In an aspect is provided an oxidized polyisobutene, including a first oxidized subunit and a non-oxidized subunit.

The first oxidized subunit has the formula:

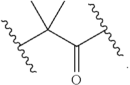 [SMILES: *C(=O)C(*)(C)C]

The non-oxidized subunit has the formula:

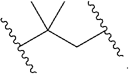 [SMILES: *CC(*)(C)C]

The ratio of the first oxidized subunit to the non-oxidized subunit is from 1:10,000 to 1:5.

The oxidized polyisobutene has a number average molecular weight from 250 Da to 20,000,000 Da.

In an aspect is provided a hydroxylated polyisobutene, including a second oxidized subunit and a non-oxidized subunit. The non-oxidized subunit is as described herein, including in embodiments.

The second oxidized subunit has the formula:

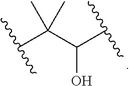 [SMILES: *C(O)C(*)(C)C]

The hydroxylated polyisobutene has a number average molecular weight from 250 Da to 20,000,000 Da.

In an aspect is provided a cross-linked polymer, wherein a first oxidized polyisobutene is covalently bonded to a second oxidized polyisobutene via a covalent linker having the formula:

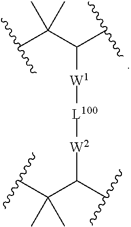

W¹ is —O— or —NR¹—. W² is —O— or —NR²—.
R¹ and R² are independently hydrogen, halogen, —CX³₃, —CHX³₂, —CH₂X³, —OCX³₃, —OCH₂X³, —OCHX³₂, —CN, —SOₙ₃R³, —SOᵥ₃NR³R³, —NR³NR³R³, —ONR³R³,
—NHC(O)NR³NR³R³,
—NHC(O)NR³R³, —N(O)ₘ₃, —NR³R³, —C(O)R³, —C(O)OR³, —C(O)NR³R³, —OR³, —SR³, —NR³SO₂R³,
—NR³C(O)R³, —NR³C(O)OR³, —NR³OR³, —SF₅, —N₃, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl.
R³ is independently hydrogen, oxo,
halogen, —CCl₃, —CBr₃, —CF₃, —CI₃, —CHCl₂, —CHBr₂,
—CHF₂, —CHI₂, —CH₂Cl, —CH₂Br, —CH₂F, —CH₂I, —CN, —OH, —NH₂, —COOH, —CONH₂, —NO₂, —S H,
—SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —OCCl₃, —OCF₃, —OCBr₃, —OCl₃, —OCHCl₂, —OCHBr₂, —OCHI₂, —OCHF₂, —OCH₂Cl, —OCH₂Br, —OCH₂I, —OCH₂F, —N₃, —SF₅, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl; two R³ substituents bonded to the same nitrogen atom may optionally be joined to form a substituted or unsubstituted heterocycloalkyl, or substituted or unsubstituted heteroaryl.
L¹⁰⁰ is -L¹⁰¹-L¹⁰²-L¹⁰³-.
L¹⁰¹ is a bond, —N(R¹⁰¹)—, —S—, —O—, —C(O)—, —C(O)O—, —OC(O)—, —N(R¹⁰¹)C(O)—, —C(O)N(R¹⁰¹)—, —NR¹⁰¹C(O)NR¹⁰¹—, —NR¹⁰¹C(NH)NH—, —C(S)—, —Si(R¹⁰¹)₂—, substituted or unsubstituted alkylene, substituted or unsubstituted heteroalkylene, substituted or unsubstituted cycloalkylene, substituted or unsubstituted heterocycloalkylene, substituted or unsubstituted arylene, or substituted or unsubstituted heteroarylene.
L¹⁰² is a bond, —N(R¹⁰²)—, —S—, —O—, —C(O)—, —C(O)O—, —OC(O)—, —N(R¹⁰²)C(O)—, —C(O)N(R¹⁰²)—, —NR¹⁰²C(O)NR¹⁰²—, —NR¹⁰²C(NH)NH—, —C(S)—, —Si(R¹⁰²)₂—, substituted or unsubstituted alkylene, substituted or unsubstituted heteroalkylene, substituted or unsubstituted cycloalkylene, substituted or unsubstituted heterocycloalkylene, substituted or unsubstituted arylene, or substituted or unsubstituted heteroarylene.
L¹⁰³ is a bond, —N(R¹⁰³)—, —S—, —O—, —C(O)—, —C(O)O—, —OC(O)—, —N(R¹⁰³)C(O)—, —C(O)N(R¹⁰³)—, —NR¹⁰³C(O)NR¹⁰³—, —NR¹⁰³C(NH)NH—, —C(S)—, —Si(R¹⁰³)₂—, substituted or unsubstituted alkylene, substituted or unsubstituted heteroalkylene, substituted or unsubstituted cycloalkylene, substituted or unsubstituted heterocycloalkylene, substituted or unsubstituted arylene, or substituted or unsubstituted heteroarylene
R¹⁰¹, R¹⁰², and R¹⁰³ are independently hydrogen,
halogen, —CX¹⁰⁴₃, —CHX¹⁰⁴₂, —CH₂X¹⁰⁴,
—OCX¹⁰⁴₃, —OCH₂X¹⁰⁴, —OCHX¹⁰⁴², —CN, —SOₙ₁₀₄R¹⁰⁴, —SOᵥ₁₀₄NR¹⁰⁴R¹⁰⁴, —NR¹⁰⁴NR¹⁰⁴R¹⁰⁴, —ONR¹⁰⁴R¹⁰⁴,
—NHC(O)NR¹⁰⁴NR¹⁰⁴R¹⁰⁴, —NHC(O)NR¹⁰⁴R¹⁰⁴, N(O)ₘ₁₀₄, —NR¹⁰⁴R¹⁰⁴, —C(O)R¹⁰⁴, —C(O)OR¹⁰⁴, —C(O)NR¹⁰⁴R¹⁰⁴, —OR¹⁰⁴, —SR¹⁰⁴, —NR¹⁰4SO₂R¹⁰⁴, —NR¹⁰⁴C(O)R¹⁰⁴, —NR¹⁰⁴C(O)OR¹⁰⁴, —NR¹⁰⁴OR¹⁰⁴, —SF₅, —N₃, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl.
R¹⁰⁴ is independently hydrogen, oxo, halogen, —CCl₃, —CBr₃, —CF₃, —CI₃, —CHCl₂, —CHBr₂, —CHF₂, —CHI₂, —CH₂Cl, —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂,
—NHC(O)NH₂,
—NHSO₂H, —NHC(O)H, —NHC(O)OH, —NHOH, —OCCl₃, —OCF₃, —OCBr₃, —OCl₃, —OCHCl₂, —OCHBr₂, —OCHI₂, —OCHF₂, —OCH₂Cl, —OCH₂Br, —OCH₂I, —OCH₂F, —N₃, —SF₅, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl; two R¹⁰⁴ substituents bonded to the same nitrogen atom may optionally be joined to form a substituted or unsubstituted heterocycloalkyl, or substituted or unsubstituted heteroaryl.

X³ and X¹⁰⁴ are independently —F, —Cl, —Br, or —I.

The variables n3 and n104 are independently an integer from 0 to 4.

The variables m3, m104, v3, and v104 are independently 1 or 2.

In an aspect is provided an oxidized polyisobutene in a vessel including an oxidized polyisobutene and one or more additional compounds selected from the groups consisting of: (i) a metal catalyst; (ii) an oxidizing agent; (iii) a reducing agent; (iv) a polyisobutene; and (v) a hydroxylated polyisobutene. The oxidized polyisobutene and hydroxylated polyisobutene are as described herein, including in embodiments. The polyisobutene includes a non-oxidized subunit, wherein the non-oxidized subunit is as described herein.

In an aspect is provided a mixture of polymers including an oxidized polyisobutene and a second polymer. The oxidized polyisobutene is as described herein, including in embodiments.

In an aspect is provided a cross-linked polymer and a second polymer. The cross-linked polymer is as described herein, including in embodiments.

In an aspect is provided a method of making an oxidized polyisobutene, including mixing a polyisobutene, a metal catalyst, and an oxidizing agent. The oxidized polyisobutene, polyisobutene, metal catalyst, and oxidizing agent are as described herein, including in embodiments.

### BRIEF DESCRIPTION OF THE DRAWINGS

FIGS. 1A-1C. Functionalization of polyethylenes (FIG. TA), polypropylenes, and polyisobutene (FIGS. 1B-1C) by free radicals and transition metal catalysis. LDPE: low-density polyethylene; HDPE: high-density polyethylene; LLDPE: linear low-density polyethylene; PP: polypropylene; PIB: polyisobutene. FIG. TA: Previous types of polyolefin functionalization. FIG. 1B: PIB synthesis and free radical-mediated functionalization. FIG. 1C: Ruthenium-catalyzed, chemoselective and regioselective oxidation of polyisobutene.

FIGS. 2A-2B. Transition metal catalyzed oxidation of model alkanes. PDP: 2-({2-[-1-(pyridin-2-ylmethyl)pyrrolidin-2-yl]pyrrolidin-1-yl}methyl) pyridine; Me₄Phen: 3,4,7,8-tetramethyl-1,10-phenanthroline; TPFPP: tetrakis(pentafluorophenyl)porphyrin. FIG. 2A: Selected catalysts for C—H oxidation. FIG. 2B: Selected results.

FIG. 3. Catalytic oxidation of polyisobutene with transition metal complexes. BpyPy₂Me: 6-(1,1-di(pyridin-2-yl)ethyl)-2,2′-bipyridine; OTf: triflate; OEP: octaethyl porphyrin; TMP: tetramesityl porphyrin; TPP: tetraphenyl porphyrin.

FIGS. 4A-4B. FIG. 4A: ¹H-¹³C HSQC NMR spectrum of oxo-PIB. FIG. 4B: GPC traces of PIB before and after oxidation.

FIGS. 5A-5C. FIG. 5A: Competition between oxidation and bromination of polyisobutene. FIG. 5B: Ratio of functionality from oxidation (K) to bromination (Br) plotted against concentration ratio of Ru catalyst to CBr₄. FIG. 5C: possible pathways for oxidation and bromination of polyisobutene.

FIGS. 6A-6B. Overlay of GPC traces of the polyisobutenes before and after the Ni-catalyzed chlorination (FIG. 6A) and the Ru-catalyzed oxidation (FIG. 6B).

FIGS. 7A-7C. Plots of thermogravimetric analysis for oxo-PIB (FIG. 7A), hydroxyl-PIB (FIG. 7B), and crosslinked PIB (FIG. 7C) in comparison with unmodified PIB.

FIGS. 8A-8C. Graphs of differential scanning calorimetry for oxo-PIB (FIG. 8A), hydroxyl-PIB (FIG. 8B), and crosslinked PIB (FIG. 8C) in comparison with unmodified PIB.

FIGS. 9A-9B. Selected pictures of water droplets on films made from HDPE (FIG. 9A) and the polymer blend (FIG. 9B).

FIG. 10. FT-IR spectrum of oxo-PIB.

FIG. 11. FT-IR spectrum of hydroxyl-PIB (lighter, bottom) and oxo-PIB (darker, top).

### DETAILED DESCRIPTION

### I. Definitions

The abbreviations used herein have their conventional meaning within the chemical and biological arts. The chemical structures and formulae set forth herein are constructed according to the standard rules of chemical valency known in the chemical arts.

Where substituent groups are specified by their conventional chemical formulae, written from left to right, they equally encompass the chemically identical substituents that would result from writing the structure from right to left, e.g., —CH₂O— is equivalent to —OCH₂—.

The term “alkyl,” by itself or as part of another substituent, means, unless otherwise stated, a straight (i.e., unbranched) or branched carbon chain (or carbon), or combination thereof, which may be fully saturated, mono- or polyunsaturated and can include mono-, di-, and multivalent radicals. The alkyl may include a designated number of carbons (e.g., C₁-C₁₀ means one to ten carbons). Alkyl is an uncyclized chain. Examples of saturated hydrocarbon radicals include, but are not limited to, groups such as methyl, ethyl, n-propyl, isopropyl, n-butyl, t-butyl, isobutyl, sec-butyl, methyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. An alkoxy is an alkyl attached to the remainder of the molecule via an oxygen linker (—O—). An alkyl moiety may be an alkenyl moiety. An alkyl moiety may be an alkynyl moiety. An alkyl moiety may be fully saturated. An alkenyl may include more than one double bond and/or one or more triple bonds in addition to the one or more double bonds. An alkynyl may include more than one triple bond and/or one or more double bonds in addition to the one or more triple bonds. In embodiments, the alkyl is fully saturated. In embodiments, the alkyl is monounsaturated. In embodiments, the alkyl is polyunsaturated.

The term “alkylene,” by itself or as part of another substituent, means, unless otherwise stated, a divalent radical derived from an alkyl, as exemplified, but not limited by, —CH₂CH₂CH₂CH₂—. Typically, an alkyl (or alkylene) group will have from 1 to 24 carbon atoms, with those groups having 10 or fewer carbon atoms being preferred herein. A “lower alkyl” or “lower alkylene” is a shorter chain alkyl or alkylene group, generally having eight or fewer carbon atoms. The term “alkenylene,” by itself or as part of another substituent, means, unless otherwise stated, a divalent radical derived from an alkene. The term “alkynylene” by itself or as part of another substituent, means, unless otherwise stated, a divalent radical derived from an alkyne. In embodiments, the alkylene is fully saturated. In embodiments, the alkylene is monounsaturated. In embodiments, the alkylene is polyunsaturated. In embodiments, an alkenylene includes one or more double bonds. In embodiments, an alkynylene includes one or more triple bonds.

The term “heteroalkyl,” by itself or in combination with another term, means, unless otherwise stated, a stable straight or branched chain, or combinations thereof, including at least one carbon atom and at least one heteroatom (e.g., O, N, P, Si, and S), and wherein the nitrogen and sulfur atoms may optionally be oxidized, and the nitrogen heteroatom may optionally be quaternized. The heteroatom(s) (e.g., O, N, S, Si, or P) may be placed at any interior position of the heteroalkyl group or at the position at which the alkyl group is attached to the remainder of the molecule. Heteroalkyl is an uncyclized chain. Examples include, but are not limited to: —CH₂—CH₂—O—CH₃, —CH₂—CH₂—NH—CH₃, —CH₂—CH₂—N(CH₃)—CH₃, —CH₂—S—CH₂—CH₃, —CH₂—S—CH₂, —S(O)—CH₃, —CH₂—CH₂—S(O)₂—CH₃, —CH═CHO—CH₃, —Si(CH₃)₃, —CH₂—CH═N—OCH₃, —CH═CH—N(CH₃)—CH₃, —O—CH₃, —O—CH₂—CH₃, and —CN. Up to two or three heteroatoms may be consecutive, such as, for example, —CH₂—NH—OCH₃ and —CH₂—O—Si(CH₃)₃. A heteroalkyl moiety may include one heteroatom (e.g., O, N, S, Si, or P). A heteroalkyl moiety may include two optionally different heteroatoms (e.g., O, N, S, Si, or P). A heteroalkyl moiety may include three optionally different heteroatoms (e.g., O, N, S, Si, or P). A heteroalkyl moiety may include four optionally different heteroatoms (e.g., O, N, S, Si, or P). A heteroalkyl moiety may include five optionally different heteroatoms (e.g., O, N, S, Si, or P). A heteroalkyl moiety may include up to 8 optionally different heteroatoms (e.g., O, N, S, Si, or P). The term “heteroalkenyl,” by itself or in combination with another term, means, unless otherwise stated, a heteroalkyl including at least one double bond. A heteroalkenyl may optionally include more than one double bond and/or one or more triple bonds in additional to the one or more double bonds. The term “heteroalkynyl,” by itself or in combination with another term, means, unless otherwise stated, a heteroalkyl including at least one triple bond. A heteroalkynyl may optionally include more than one triple bond and/or one or more double bonds in additional to the one or more triple bonds. In embodiments, the heteroalkyl is fully saturated. In embodiments, the heteroalkyl is monounsaturated. In embodiments, the heteroalkyl is polyunsaturated.

Similarly, the term “heteroalkylene,” by itself or as part of another substituent, means, unless otherwise stated, a divalent radical derived from heteroalkyl, as exemplified, but not limited by, —CH₂—CH₂—S—CH₂—CH₂— and —CH₂—S—CH₂—CH₂—NH—CH₂—. For heteroalkylene groups, heteroatoms can also occupy either or both of the chain termini (e.g., alkyleneoxy, alkylenedioxy, alkyleneamino, alkylenediamino, and the like). Still further, for alkylene and heteroalkylene linking groups, no orientation of the linking group is implied by the direction in which the formula of the linking group is written. For example, the formula —C(O)₂R′— represents both —C(O)₂R′- and —R′C(O)₂—. As described above, heteroalkyl groups, as used herein, include those groups that are attached to the remainder of the molecule through a heteroatom, such as —C(O)R′, —C(O)NR′, —NR′R″, —OR′, —SR′, and/or —SO₂R′. Where “heteroalkyl” is recited, followed by recitations of specific heteroalkyl groups, such as —NR′R″ or the like, it will be understood that the terms heteroalkyl and —NR′R″ are not redundant or mutually exclusive. Rather, the specific heteroalkyl groups are recited to add clarity. Thus, the term “heteroalkyl” should not be interpreted herein as excluding specific heteroalkyl groups, such as —NR′R″ or the like. The term “heteroalkenylene,” by itself or as part of another substituent, means, unless otherwise stated, a divalent radical derived from a heteroalkene. The term “heteroalkynylene” by itself or as part of another substituent, means, unless otherwise stated, a divalent radical derived from a heteroalkyne. In embodiments, the heteroalkylene is fully saturated. In embodiments, the heteroalkylene is monounsaturated. In embodiments, the heteroalkylene is polyunsaturated. In embodiments, a heteroalkenylene includes one or more double bonds. In embodiments, a heteroalkynylene includes one or more triple bonds.

The terms “cycloalkyl” and “heterocycloalkyl,” by themselves or in combination with other terms, mean, unless otherwise stated, cyclic versions of “alkyl” and “heteroalkyl,” respectively. Cycloalkyl and heterocycloalkyl are not aromatic. Additionally, for heterocycloalkyl, a heteroatom can occupy the position at which the heterocycle is attached to the remainder of the molecule. Examples of cycloalkyl include, but are not limited to, cyclopropyl, cyclobutyl, cyclopentyl, cyclohexyl, 1-cyclohexenyl, 3-cyclohexenyl, cycloheptyl, and the like. Examples of heterocycloalkyl include, but are not limited to, 1-(1,2,5,6-tetrahydropyridyl), 1-piperidinyl, 2-piperidinyl, 3-piperidinyl, 4-morpholinyl, 3-morpholinyl, tetrahydrofuran-2-yl, tetrahydrofuran-3-yl, tetrahydrothien-2-yl, tetrahydrothien-3-yl, 1-piperazinyl, 2-piperazinyl, and the like. A “cycloalkylene” and a “heterocycloalkylene,” alone or as part of another substituent, means a divalent radical derived from a cycloalkyl and heterocycloalkyl, respectively. In embodiments, the cycloalkyl is fully saturated. In embodiments, the cycloalkyl is monounsaturated. In embodiments, the cycloalkyl is polyunsaturated. In embodiments, the heterocycloalkyl is fully saturated. In embodiments, the heterocycloalkyl is monounsaturated. In embodiments, the heterocycloalkyl is polyunsaturated.

In embodiments, the term “cycloalkyl” means a monocyclic, bicyclic, or a multicyclic cycloalkyl ring system. In embodiments, monocyclic ring systems are cyclic hydrocarbon groups containing from 3 to 8 carbon atoms, where such groups can be saturated or unsaturated, but not aromatic. In embodiments, cycloalkyl groups are fully saturated. Examples of monocyclic cycloalkyls include cyclopropyl, cyclobutyl, cyclopentyl, cyclopentenyl, cyclohexyl, cyclohexenyl, cycloheptyl, and cyclooctyl. Bicyclic cycloalkyl ring systems are bridged monocyclic rings or fused bicyclic rings. A bicyclic or multicyclic cycloalkyl ring system refers to multiple rings fused together wherein at least one of the fused rings is a cycloalkyl ring and wherein the multiple rings are attached to the parent molecular moiety through any carbon atom contained within a cycloalkyl ring of the multiple rings. In embodiments, bridged monocyclic rings contain a monocyclic cycloalkyl ring where two non adjacent carbon atoms of the monocyclic ring are linked by an alkylene bridge of between one and three additional carbon atoms (i.e., a bridging group of the form (CH₂)_{w}, where w is 1, 2, or 3). Representative examples of bicyclic ring systems include, but are not limited to, bicyclo[3.1.1]heptane, bicyclo[2.2.1]heptane, bicyclo[2.2.2]octane, bicyclo[3.2.2]nonane, bicyclo[3.3.1]nonane, and bicyclo[4.2.1]nonane. In embodiments, fused bicyclic cycloalkyl ring systems contain a monocyclic cycloalkyl ring fused to either a phenyl, a monocyclic cycloalkyl, a monocyclic cycloalkenyl, a monocyclic heterocyclyl, or a monocyclic heteroaryl. In embodiments, the bridged or fused bicyclic cycloalkyl is attached to the parent molecular moiety through any carbon atom contained within the monocyclic cycloalkyl ring. In embodiments, cycloalkyl groups are optionally substituted with one or two groups which are independently oxo or thia. In embodiments, the fused bicyclic cycloalkyl is a 5 or 6 membered monocyclic cycloalkyl ring fused to either a phenyl ring, a 5 or 6 membered monocyclic cycloalkyl, a 5 or 6 membered monocyclic cycloalkenyl, a 5 or 6 membered monocyclic heterocyclyl, or a 5 or 6 membered monocyclic heteroaryl, wherein the fused bicyclic cycloalkyl is optionally substituted by one or two groups which are independently oxo or thia. In embodiments, multicyclic cycloalkyl ring systems are a monocyclic cycloalkyl ring (base ring) fused to either (i) one ring system selected from the group consisting of a bicyclic aryl, a bicyclic heteroaryl, a bicyclic cycloalkyl, a bicyclic cycloalkenyl, and a bicyclic heterocyclyl; or (ii) two other ring systems independently selected from the group consisting of a phenyl, a bicyclic aryl, a monocyclic or bicyclic heteroaryl, a monocyclic or bicyclic cycloalkyl, a monocyclic or bicyclic cycloalkenyl, and a monocyclic or bicyclic heterocyclyl. In embodiments, the multicyclic cycloalkyl is attached to the parent molecular moiety through any carbon atom contained within the base ring. In embodiments, multicyclic cycloalkyl ring systems are a monocyclic cycloalkyl ring (base ring) fused to either (i) one ring system selected from the group consisting of a bicyclic aryl, a bicyclic heteroaryl, a bicyclic cycloalkyl, a bicyclic cycloalkenyl, and a bicyclic heterocyclyl; or (ii) two other ring systems independently selected from the group consisting of a phenyl, a monocyclic heteroaryl, a monocyclic cycloalkyl, a monocyclic cycloalkenyl, and a monocyclic heterocyclyl. Examples of multicyclic cycloalkyl groups include, but are not limited to tetradecahydrophenanthrenyl, perhydrophenothiazin-1-yl, and perhydrophenoxazin-1-yl.

In embodiments, a cycloalkyl is a cycloalkenyl. The term “cycloalkenyl” is used in accordance with its plain ordinary meaning. In embodiments, a cycloalkenyl is a monocyclic, bicyclic, or a multicyclic cycloalkenyl ring system. In embodiments, monocyclic cycloalkenyl ring systems are cyclic hydrocarbon groups containing from 3 to 8 carbon atoms, where such groups are unsaturated (i.e., containing at least one annular carbon carbon double bond), but not aromatic. Examples of monocyclic cycloalkenyl ring systems include cyclopentenyl and cyclohexenyl. In embodiments, bicyclic cycloalkenyl rings are bridged monocyclic rings or a fused bicyclic rings. In embodiments, bridged monocyclic rings contain a monocyclic cycloalkenyl ring where two non adjacent carbon atoms of the monocyclic ring are linked by an alkylene bridge of between one and three additional carbon atoms (i.e., a bridging group of the form (CH₂)_{w}, where w is 1, 2, or 3). Representative examples of bicyclic cycloalkenyls include, but are not limited to, norbomenyl and bicyclo[2.2.2]oct 2 enyl. In embodiments, fused bicyclic cycloalkenyl ring systems contain a monocyclic cycloalkenyl ring fused to either a phenyl, a monocyclic cycloalkyl, a monocyclic cycloalkenyl, a monocyclic heterocyclyl, or a monocyclic heteroaryl. In embodiments, the bridged or fused bicyclic cycloalkenyl is attached to the parent molecular moiety through any carbon atom contained within the monocyclic cycloalkenyl ring. In embodiments, cycloalkenyl groups are optionally substituted with one or two groups which are independently oxo or thia. In embodiments, multicyclic cycloalkenyl rings contain a monocyclic cycloalkenyl ring (base ring) fused to either (i) one ring system selected from the group consisting of a bicyclic aryl, a bicyclic heteroaryl, a bicyclic cycloalkyl, a bicyclic cycloalkenyl, and a bicyclic heterocyclyl; or (ii) two ring systems independently selected from the group consisting of a phenyl, a bicyclic aryl, a monocyclic or bicyclic heteroaryl, a monocyclic or bicyclic cycloalkyl, a monocyclic or bicyclic cycloalkenyl, and a monocyclic or bicyclic heterocyclyl. In embodiments, the multicyclic cycloalkenyl is attached to the parent molecular moiety through any carbon atom contained within the base ring. In embodiments, multicyclic cycloalkenyl rings contain a monocyclic cycloalkenyl ring (base ring) fused to either (i) one ring system selected from the group consisting of a bicyclic cycloalkyl, a bicyclic cycloalkenyl, and a bicyclic heterocyclyl; or (ii) two ring systems independently selected from the group consisting of a monocyclic cycloalkyl, a monocyclic cycloalkenyl, and a monocyclic heterocyclyl.

In embodiments, the term “heterocycloalkyl” means a monocyclic, bicyclic, or a multicyclic heterocycloalkyl ring system. In embodiments, heterocycloalkyl groups are fully saturated. A bicyclic or multicyclic heterocycloalkyl ring system refers to multiple rings fused together wherein at least one of the fused rings is a heterocycloalkyl ring and wherein the multiple rings are attached to the parent molecular moiety through any atom contained within a heterocycloalkyl ring of the multiple rings. In embodiments, a heterocycloalkyl is a heterocyclyl. The term “heterocyclyl” as used herein, means a monocyclic, bicyclic, or multicyclic heterocycle. The heterocyclyl monocyclic heterocycle is a 3, 4, 5, 6 or 7 membered ring containing at least one heteroatom independently selected from the group consisting of O, N, and S where the ring is saturated or unsaturated, but not aromatic. The 3 or 4 membered ring contains 1 heteroatom selected from the group consisting of O, N, and S. The 5 membered ring can contain zero or one double bond and one, two or three heteroatoms selected from the group consisting of O, N, and S. The 6 or 7 membered ring contains zero, one or two double bonds and one, two or three heteroatoms selected from the group consisting of O, N, and S. The heterocyclyl monocyclic heterocycle is connected to the parent molecular moiety through any carbon atom or any nitrogen atom contained within the heterocyclyl monocyclic heterocycle. Representative examples of heterocyclyl monocyclic heterocycles include, but are not limited to, azetidinyl, azepanyl, aziridinyl, diazepanyl, 1,3-dioxanyl, 1,3-dioxolanyl, 1,3-dithiolanyl, 1,3-dithianyl, imidazolinyl, imidazolidinyl, isothiazolinyl, isothiazolidinyl, isoxazolinyl, isoxazolidinyl, morpholinyl, oxadiazolinyl, oxadiazolidinyl, oxazolinyl, oxazolidinyl, piperazinyl, piperidinyl, pyranyl, pyrazolinyl, pyrazolidinyl, pyrrolinyl, pyrrolidinyl, tetrahydrofuranyl, tetrahydrothienyl, thiadiazolinyl, thiadiazolidinyl, thiazolinyl, thiazolidinyl, thiomorpholinyl, 1,1-dioxidothiomorpholinyl (thiomorpholine sulfone), thiopyranyl, and trithianyl. The heterocyclyl bicyclic heterocycle is a monocyclic heterocycle fused to either a phenyl, a monocyclic cycloalkyl, a monocyclic cycloalkenyl, a monocyclic heterocycle, or a monocyclic heteroaryl. The heterocyclyl bicyclic heterocycle is connected to the parent molecular moiety through any carbon atom or any nitrogen atom contained within the monocyclic heterocycle portion of the bicyclic ring system. Representative examples of bicyclic heterocyclyls include, but are not limited to, 2,3-dihydrobenzofuran-2-yl, 2,3-dihydrobenzofuran-3-yl, indolin-1-yl, indolin-2-yl, indolin-3-yl, 2,3-dihydrobenzothien-2-yl, decahydroquinolinyl, decahydroisoquinolinyl, octahydro-1H-indolyl, and octahydrobenzofuranyl. In embodiments, heterocyclyl groups are optionally substituted with one or two groups which are independently oxo or thia. In certain embodiments, the bicyclic heterocyclyl is a 5 or 6 membered monocyclic heterocyclyl ring fused to a phenyl ring, a 5 or 6 membered monocyclic cycloalkyl, a 5 or 6 membered monocyclic cycloalkenyl, a 5 or 6 membered monocyclic heterocyclyl, or a 5 or 6 membered monocyclic heteroaryl, wherein the bicyclic heterocyclyl is optionally substituted by one or two groups which are independently oxo or thia. Multicyclic heterocyclyl ring systems are a monocyclic heterocyclyl ring (base ring) fused to either (i) one ring system selected from the group consisting of a bicyclic aryl, a bicyclic heteroaryl, a bicyclic cycloalkyl, a bicyclic cycloalkenyl, and a bicyclic heterocyclyl; or (ii) two other ring systems independently selected from the group consisting of a phenyl, a bicyclic aryl, a monocyclic or bicyclic heteroaryl, a monocyclic or bicyclic cycloalkyl, a monocyclic or bicyclic cycloalkenyl, and a monocyclic or bicyclic heterocyclyl. The multicyclic heterocyclyl is attached to the parent molecular moiety through any carbon atom or nitrogen atom contained within the base ring. In embodiments, multicyclic heterocyclyl ring systems are a monocyclic heterocyclyl ring (base ring) fused to either (i) one ring system selected from the group consisting of a bicyclic aryl, a bicyclic heteroaryl, a bicyclic cycloalkyl, a bicyclic cycloalkenyl, and a bicyclic heterocyclyl; or (ii) two other ring systems independently selected from the group consisting of a phenyl, a monocyclic heteroaryl, a monocyclic cycloalkyl, a monocyclic cycloalkenyl, and a monocyclic heterocyclyl. Examples of multicyclic heterocyclyl groups include, but are not limited to 10H-phenothiazin-10-yl, 9,10-dihydroacridin-9-yl, 9,10-dihydroacridin-10-yl, 10H-phenoxazin-10-yl, 10,11-dihydro-5H-dibenzo[b,f]azepin-5-yl, 1,2,3,4-tetrahydropyrido[4,3-g]isoquinolin-2-yl, 12H-benzo[b]phenoxazin-12-yl, and dodecahydro-1H-carbazol-9-yl.

The terms “halo” or “halogen,” by themselves or as part of another substituent, mean, unless otherwise stated, a fluorine, chlorine, bromine, or iodine atom. Additionally, terms such as “haloalkyl” are meant to include monohaloalkyl and polyhaloalkyl. For example, the term “halo(C₁-C₄)alkyl” includes, but is not limited to, fluoromethyl, difluoromethyl, trifluoromethyl, 2,2,2-trifluoroethyl, 4-chlorobutyl, 3-bromopropyl, and the like.

The term “acyl” means, unless otherwise stated, —C(O)R where R is a substituted or unsubstituted alkyl, substituted or unsubstituted cycloalkyl, substituted or unsubstituted heteroalkyl, substituted or unsubstituted heterocycloalkyl, substituted or unsubstituted aryl, or substituted or unsubstituted heteroaryl.

The term “aryl” means, unless otherwise stated, a polyunsaturated, aromatic, hydrocarbon substituent, which can be a single ring or multiple rings (preferably from 1 to 3 rings) that are fused together (i.e., a fused ring aryl) or linked covalently. A fused ring aryl refers to multiple rings fused together wherein at least one of the fused rings is an aryl ring. In embodiments, a fused ring aryl refers to multiple rings fused together wherein at least one of the fused rings is an aryl ring and wherein the multiple rings are attached to the parent molecular moiety through any carbon atom contained within an aryl ring of the multiple rings. The term “heteroaryl” refers to aryl groups (or rings) that contain at least one heteroatom such as N, O, or S, wherein the nitrogen and sulfur atoms are optionally oxidized, and the nitrogen atom(s) are optionally quaternized. Thus, the term “heteroaryl” includes fused ring heteroaryl groups (i.e., multiple rings fused together wherein at least one of the fused rings is a heteroaromatic ring). In embodiments, the term “heteroaryl” includes fused ring heteroaryl groups (i.e., multiple rings fused together wherein at least one of the fused rings is a heteroaromatic ring and wherein the multiple rings are attached to the parent molecular moiety through any atom contained within a heteroaromatic ring of the multiple rings). A 5,6-fused ring heteroarylene refers to two rings fused together, wherein one ring has 5 members and the other ring has 6 members, and wherein at least one ring is a heteroaryl ring. Likewise, a 6,6-fused ring heteroarylene refers to two rings fused together, wherein one ring has 6 members and the other ring has 6 members, and wherein at least one ring is a heteroaryl ring. And a 6,5-fused ring heteroarylene refers to two rings fused together, wherein one ring has 6 members and the other ring has 5 members, and wherein at least one ring is a heteroaryl ring. A heteroaryl group can be attached to the remainder of the molecule through a carbon or heteroatom. Non-limiting examples of aryl and heteroaryl groups include phenyl, naphthyl, pyrrolyl, pyrazolyl, pyridazinyl, triazinyl, pyrimidinyl, imidazolyl, pyrazinyl, purinyl, oxazolyl, isoxazolyl, thiazolyl, furyl, thienyl, pyridyl, pyrimidyl, benzothiazolyl, benzoxazoyl benzimidazolyl, benzofuran, isobenzofuranyl, indolyl, isoindolyl, benzothiophenyl, isoquinolyl, quinoxalinyl, quinolyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below. An “arylene” and a “heteroarylene,” alone or as part of another substituent, mean a divalent radical derived from an aryl and heteroaryl, respectively. A heteroaryl group substituent may be —O— bonded to a ring heteroatom nitrogen.

A fused ring heterocyloalkyl-aryl is an aryl fused to a heterocycloalkyl. A fused ring heterocycloalkyl-heteroaryl is a heteroaryl fused to a heterocycloalkyl. A fused ring heterocycloalkyl-cycloalkyl is a heterocycloalkyl fused to a cycloalkyl. A fused ring heterocycloalkyl-heterocycloalkyl is a heterocycloalkyl fused to another heterocycloalkyl. Fused ring heterocycloalkyl-aryl, fused ring heterocycloalkyl-heteroaryl, fused ring heterocycloalkyl-cycloalkyl, or fused ring heterocycloalkyl-heterocycloalkyl may each independently be unsubstituted or substituted with one or more of the substitutents described herein.

Spirocyclic rings are two or more rings wherein adjacent rings are attached through a single atom. The individual rings within spirocyclic rings may be identical or different. Individual rings in spirocyclic rings may be substituted or unsubstituted and may have different substituents from other individual rings within a set of spirocyclic rings. Possible substituents for individual rings within spirocyclic rings are the possible substituents for the same ring when not part of spirocyclic rings (e.g., substituents for cycloalkyl or heterocycloalkyl rings). Spirocylic rings may be substituted or unsubstituted cycloalkyl, substituted or unsubstituted cycloalkylene, substituted or unsubstituted heterocycloalkyl or substituted or unsubstituted heterocycloalkylene and individual rings within a spirocyclic ring group may be any of the immediately previous list, including having all rings of one type (e.g., all rings being substituted heterocycloalkylene wherein each ring may be the same or different substituted heterocycloalkylene). When referring to a spirocyclic ring system, heterocyclic spirocyclic rings means a spirocyclic rings wherein at least one ring is a heterocyclic ring and wherein each ring may be a different ring. When referring to a spirocyclic ring system, substituted spirocyclic rings means that at least one ring is substituted and each substituent may optionally be different.

The symbol “ [symbol] ” denotes the point of attachment of a chemical moiety to the remainder of a molecule or chemical formula.

The term “oxo,” as used herein, means an oxygen that is double bonded to a carbon atom.

The term “alkylarylene” as an arylene moiety covalently bonded to an alkylene moiety (also referred to herein as an alkylene linker). In embodiments, the alkylarylene group has the formula:

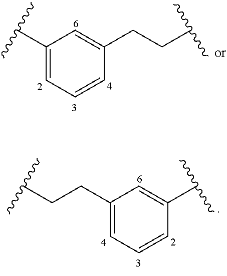 [SMILES: *CCc1cccc(*)c1 ; *CCc1cccc(*)c1]

An alkylarylene moiety may be substituted (e.g., with a substituent group) on the alkylene moiety or the arylene linker (e.g., at carbons 2, 3, 4, or 6) with halogen, oxo, —N₃, —CF₃, —CCl₃, —CBr₃, —CI₃, —CN, —C(O)H, —OH, —NH₂, —COOH, —CONH₂, —NO₂, —SH, —SO₂CH₃, —SO₃H, —OSO₃H, —SO₂NH₂, —NHNH₂, —ONH₂, —NHC(O)NHNH₂, substituted or unsubstituted C₁-C₅ alkyl or substituted or unsubstituted 2 to 5 membered heteroalkyl). In embodiments, the alkylarylene is unsubstituted.

The term “alkylsulfonyl,” as used herein, means a moiety having the formula —S(O₂)—R′, where R′ is a substituted or unsubstituted alkyl group as defined above. R′ may have a specified number of carbons (e.g., “C₁-C₄ alkylsulfonyl”).

Each of the above terms (e.g., “alkyl,” “heteroalkyl,” “cycloalkyl,” “heterocycloalkyl,” “aryl,” and “heteroaryl”) includes both substituted and unsubstituted forms of the indicated radical. Preferred substituents for each type of radical are provided below.

Substituents for the alkyl and heteroalkyl radicals (including those groups often referred to as alkylene, alkenyl, heteroalkylene, heteroalkenyl, alkynyl, cycloalkyl, heterocycloalkyl, cycloalkenyl, and heterocycloalkenyl) can be one or more of a variety of groups selected from, but not limited to, —OR′, ═O, ═NR′, ═N—OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R″′)═NR″″, —NR—C(NR′R″)═NR′″, —S(O)R′, —S(O)₂R′, —S(O)₂NR′R″, —NRSO₂R′, —NR′NR″R′″, —ONR′R″, —NR′C(O)NR″NR″′R″″, —CN, —NO₂, —NR′SO₂R″, —NR′C(O)R″, —NR′C(O)OR″, —NR′OR″, in a number ranging from zero to (2m′+1), where m′ is the total number of carbon atoms in such radical. R, R′, R″, R′″, and R″″ each preferably independently refer to hydrogen, substituted or unsubstituted heteroalkyl, substituted or unsubstituted cycloalkyl, substituted or unsubstituted heterocycloalkyl, substituted or unsubstituted aryl (e.g., aryl substituted with 1-3 halogens), substituted or unsubstituted heteroaryl, substituted or unsubstituted alkyl, alkoxy, or thioalkoxy groups, or arylalkyl groups. When a compound described herein includes more than one R group, for example, each of the R groups is independently selected as are each R′, R″, R′″, and R″″ group when more than one of these groups is present. When R′ and R″ are attached to the same nitrogen atom, they can be combined with the nitrogen atom to form a 4-, 5-, 6-, or 7-membered ring. For example, —NR′R″ includes, but is not limited to, 1-pyrrolidinyl and 4-morpholinyl. From the above discussion of substituents, one of skill in the art will understand that the term “alkyl” is meant to include groups including carbon atoms bound to groups other than hydrogen groups, such as haloalkyl (e.g., —CF₃ and —CH₂CF₃) and acyl (e.g., —C(O)CH₃, —C(O)CF₃, —C(O)CH₂OCH₃, and the like).

Similar to the substituents described for the alkyl radical, substituents for the aryl and heteroaryl groups are varied and are selected from, for example: —OR′, —NR′R″, —SR′, -halogen,
SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R″′)═NR″″, —NR—C(NR′R″)═NR′″, —S(O)R′, —S(O)₂R′, —S(O)₂NR′R″, —NRSO₂R′, —NR′NR″R′″, —ONR′R″, —NR′C(O)NR″NR″′R″″, —CN, —NO₂, —R′, —N₃, —CH(Ph)₂, fluoro(C₁-C₄)alkoxy, and fluoro(C₁-C₄)alkyl, —NR′SO₂R″, —NR′C(O)R″,
—NR′C(O)—OR″, —NR′OR″, in a number ranging from zero to the total number of open valences on the aromatic ring system; and where R′, R″, R′″, and R″″ are preferably independently selected from hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl. When a compound described herein includes more than one R group, for example, each of the R groups is independently selected as are each R′, R″, R′″, and R″″ groups when more than one of these groups is present.

Substituents for rings (e.g., cycloalkyl, heterocycloalkyl, aryl, heteroaryl, cycloalkylene, heterocycloalkylene, arylene, or heteroarylene) may be depicted as substituents on the ring rather than on a specific atom of a ring (commonly referred to as a floating substituent). In such a case, the substituent may be attached to any of the ring atoms (obeying the rules of chemical valency) and in the case of fused rings or spirocyclic rings, a substituent depicted as associated with one member of the fused rings or spirocyclic rings (a floating substituent on a single ring), may be a substituent on any of the fused rings or spirocyclic rings (a floating substituent on multiple rings). When a substituent is attached to a ring, but not a specific atom (a floating substituent), and a subscript for the substituent is an integer greater than one, the multiple substituents may be on the same atom, same ring, different atoms, different fused rings, different spirocyclic rings, and each substituent may optionally be different. Where a point of attachment of a ring to the remainder of a molecule is not limited to a single atom (a floating substituent), the attachment point may be any atom of the ring and in the case of a fused ring or spirocyclic ring, any atom of any of the fused rings or spirocyclic rings while obeying the rules of chemical valency. Where a ring, fused rings, or spirocyclic rings contain one or more ring heteroatoms and the ring, fused rings, or spirocyclic rings are shown with one more floating substituents (including, but not limited to, points of attachment to the remainder of the molecule), the floating substituents may be bonded to the heteroatoms. Where the ring heteroatoms are shown bound to one or more hydrogens (e.g., a ring nitrogen with two bonds to ring atoms and a third bond to a hydrogen) in the structure or formula with the floating substituent, when the heteroatom is bonded to the floating substituent, the substituent will be understood to replace the hydrogen, while obeying the rules of chemical valency.

Two or more substituents may optionally be joined to form aryl, heteroaryl, cycloalkyl, or heterocycloalkyl groups. Such so-called ring-forming substituents are typically, though not necessarily, found attached to a cyclic base structure. In one embodiment, the ring-forming substituents are attached to adjacent members of the base structure. For example, two ring-forming substituents attached to adjacent members of a cyclic base structure create a fused ring structure. In another embodiment, the ring-forming substituents are attached to a single member of the base structure. For example, two ring-forming substituents attached to a single member of a cyclic base structure create a spirocyclic structure. In yet another embodiment, the ring-forming substituents are attached to non-adjacent members of the base structure.

Two of the substituents on adjacent atoms of the aryl or heteroaryl ring may optionally form a ring of the formula -T-C(O)—(CRR′)_{q}—U—, wherein T and U are independently —NR—, —O—,
—CRR′—, or a single bond, and q is an integer of from 0 to 3. Alternatively, two of the substituents on adjacent atoms of the aryl or heteroaryl ring may optionally be replaced with a substituent of the formula -A-(CH₂)ᵣ—B—, wherein A and B are independently —CRR′—, —O—, —NR—, —S—, —S(O)—,
—S(O)₂—, —S(O)₂NR′—, or a single bond, and r is an integer of from 1 to 4. One of the single bonds of the new ring so formed may optionally be replaced with a double bond. Alternatively, two of the substituents on adjacent atoms of the aryl or heteroaryl ring may optionally be replaced with a substituent of the formula —(CRR′)ₛ—X′-(C″RR′″)_{d}—, where s and d are independently integers of from 0 to 3, and X is —O—, —NR′—, —S—, —S(O)—, —S(O)₂—, or —S(O)₂NR′—. The substituents R, R′, R″, and R″′ are preferably independently selected from hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl.

As used herein, the terms “heteroatom” or “ring heteroatom” are meant to include oxygen (O), nitrogen (N), sulfur (S), phosphorus (P), and silicon (Si).

A “substituent group,” as used herein, means a group selected from the following moieties:
(A) oxo, halogen, —CCl₁₃, —CBr₃, —CF₃, —CI₃, CHCl₂, —CHBr₂, —CHF₂, —CHI₂, —CH₂Cl, —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂,
—NHC(O)NH₂, —NHSO₂H, —NHC(O)H,
—NHC(O)OH, —NHOH, —OCCl₃, —OCF₃, —OCBr₃, —OCI₃, —OCHCl₂, —OCHBr₂, —OCHI₂, —OCHF₂, —OCH₂Cl, —OCH₂Br, —OCH₂I, —OCH₂F, —N₃, unsubstituted alkyl (e.g., C₁-C₈ alkyl, C₁-C₆ alkyl, or C₁-C₄ alkyl), unsubstituted heteroalkyl (e.g., 2 to 8 membered heteroalkyl, 2 to 6 membered heteroalkyl, or 2 to 4 membered heteroalkyl), unsubstituted cycloalkyl (e.g., C₃-C₈ cycloalkyl, C₃-C₆ cycloalkyl, or C₅-C₆ cycloalkyl), unsubstituted heterocycloalkyl (e.g., 3 to 8 membered heterocycloalkyl, 3 to 6 membered heterocycloalkyl, or 5 to 6 membered heterocycloalkyl), unsubstituted aryl (e.g., C₆-C₁₀ aryl, C₁₀ aryl, or phenyl), or unsubstituted heteroaryl (e.g., 5 to 10 membered heteroaryl, 5 to 9 membered heteroaryl, or 5 to 6 membered heteroaryl), and
(B) alkyl (e.g., C₁-C₂₀, C₁-C₁₂, C₁-C₈, C₁-C₆, C₁-C₄, or C₁-C₂), heteroalkyl (e.g., 2 to 20 membered, 2 to 12 membered, 2 to 8 membered, 2 to 6 membered, 4 to 6 membered, 2 to 3 membered, or 4 to 5 membered), cycloalkyl (e.g., C₃-C₁₀, C₃-C₈, C₃-C₆, C₄-C₆, or C₅-C₆), heterocycloalkyl (e.g., 3 to 10 membered, 3 to 8 membered, 3 to 6 membered, 4 to 6 membered, 4 to 5 membered, or 5 to 6 membered), aryl (e.g., C₆-C₁₂, C₆-C₁₀, or phenyl), or heteroaryl (e.g., 5 to 12 membered, 5 to 10 membered, 5 to 9 membered, or 5 to 6 membered), substituted with at least one substituent selected from:
   (i) oxo, halogen, —CCl₃, —CBr₃, —CF₃, —CI₃, CHCl₂, —CHBr₂, —CHF₂, —CHI₂, —CH₂Cl, —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H,
      —NHC(O)H, —NHC(O)OH, —NHOH, —OCCl₁₃, —OCF₃, —OCBr₃, —OCI₃, —OCHCl₂, —OCHBr₂, —OCHI₂, —OCHF₂, —OCH₂Cl, —OCH₂Br, —OCH₂I, —OCH₂F, —N₃, unsubstituted alkyl (e.g., C₁-C₈ alkyl, C₁-C₆ alkyl, or C₁-C₄ alkyl), unsubstituted heteroalkyl (e.g., 2 to 8 membered heteroalkyl, 2 to 6 membered heteroalkyl, or 2 to 4 membered heteroalkyl), unsubstituted cycloalkyl (e.g., C₃-C₅ cycloalkyl, C₃-C₆ cycloalkyl, or C₅-C₆ cycloalkyl), unsubstituted heterocycloalkyl (e.g., 3 to 8 membered heterocycloalkyl, 3 to 6 membered heterocycloalkyl, or 5 to 6 membered heterocycloalkyl), unsubstituted aryl (e.g., C₆-C₁₀ aryl, C₁₀ aryl, or phenyl), or unsubstituted heteroaryl (e.g., 5 to 10 membered heteroaryl, 5 to 9 membered heteroaryl, or 5 to 6 membered heteroaryl), and
   (ii) alkyl (e.g., C₁-C₂₀, C₁-C₁₂, C₁-C₈, C₁-C₆, C₁-C₄, or C₁-C₂), heteroalkyl (e.g., 2 to 20 membered, 2 to 12 membered, 2 to 8 membered, 2 to 6 membered, 4 to 6 membered, 2 to 3 membered, or 4 to 5 membered), cycloalkyl (e.g., C₃-C₁₀, C₃-C₈, C₃-C₆, C₄-C₆, or C₅-C₆), heterocycloalkyl (e.g., 3 to 10 membered, 3 to 8 membered, 3 to 6 membered, 4 to 6 membered, 4 to 5 membered, or 5 to 6 membered), aryl (e.g., C₆-C₁₂, C₆-C₁₀, or phenyl), or heteroaryl (e.g., 5 to 12 membered, 5 to 10 membered, 5 to 9 membered, or 5 to 6 membered), substituted with at least one substituent selected from:
      (a) oxo, halogen, —CCl₃, —CBr₃, —CF₃, —CI₃,
      CHCl₂, —CHBr₂, —CHF₂, —CHI₂, —CH₂Cl,
      —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —OCCl₃, —OCF₃, —OCBr₃, —OCl₃, —OCHCl₂, —OCHBr₂, —OCHI₂, —OCHF₂, —OCH₂Cl, —OCH₂Br, —OCH₂I, —OCH₂F, —N₃, unsubstituted alkyl (e.g., C₁-C₅ alkyl, C₁-C₆ alkyl, or C₁-C₄ alkyl), unsubstituted heteroalkyl (e.g., 2 to 8 membered heteroalkyl, 2 to 6 membered heteroalkyl, or 2 to 4 membered heteroalkyl), unsubstituted cycloalkyl (e.g., C₃-C₈ cycloalkyl, C₃-C₆ cycloalkyl, or C₅-C₆ cycloalkyl), unsubstituted heterocycloalkyl (e.g., 3 to 8 membered heterocycloalkyl, 3 to 6 membered heterocycloalkyl, or 5 to 6 membered heterocycloalkyl), unsubstituted aryl (e.g., C₆-C₁₀ aryl, C₁₀ aryl, or phenyl), or unsubstituted heteroaryl (e.g., 5 to 10 membered heteroaryl, 5 to 9 membered heteroaryl, or 5 to 6 membered heteroaryl), and
      (b) alkyl (e.g., C₁-C₂₀, C₁-C₁₂, C₁-C₈, C₁-C₆, C₁-C₄, or C₁-C₂), heteroalkyl (e.g., 2 to 20 membered, 2 to 12 membered, 2 to 8 membered, 2 to 6 membered, 4 to 6 membered, 2 to 3 membered, or 4 to 5 membered), cycloalkyl (e.g., C₃-C₁₀, C₃-C₈, C₃-C₆, C₄-C₆, or C₅-C₆), heterocycloalkyl (e.g., 3 to 10 membered, 3 to 8 membered, 3 to 6 membered, 4 to 6 membered, 4 to 5 membered, or 5 to 6 membered), aryl (e.g., C₆-C₁₂, C₆-C₁₀, or phenyl), or heteroaryl (e.g., 5 to 12 membered, 5 to 10 membered, 5 to 9 membered, or 5 to 6 membered), substituted with at least one substituent selected from: oxo,
      halogen, —CCl₃, —CBr₃, —CF₃, —CI₃, —CHCl₂, —CHBr₂, —CHF₂, —CHI₂, —CH₂Cl, —CH₂Br, —CH₂F, —CH₂I, —CN, —OH, —NH₂, —COOH, —CONH₂,
      —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —OCCl₃, —OCF₃, —OCBr₃, —OCI₃, —OCHCl₂, —OCHBr₂, —OCHI₂, —OCHF₂, —OCH₂Cl, —OCH₂Br, —OCH₂I, —OCH₂F, —N₃, unsubstituted alkyl (e.g., C₁-C₅ alkyl, C₁-C₆ alkyl, or C₁-C₄ alkyl), unsubstituted heteroalkyl (e.g., 2 to 8 membered heteroalkyl, 2 to 6 membered heteroalkyl, or 2 to 4 membered heteroalkyl), unsubstituted cycloalkyl (e.g., C₃-C₈ cycloalkyl, C₃-C₆ cycloalkyl, or C₅-C₆ cycloalkyl), unsubstituted heterocycloalkyl (e.g., 3 to 8 membered heterocycloalkyl, 3 to 6 membered heterocycloalkyl, or 5 to 6 membered heterocycloalkyl), unsubstituted aryl (e.g., C₆-C₁₀ aryl, C₁₀ aryl, or phenyl), or unsubstituted heteroaryl (e.g., 5 to 10 membered heteroaryl, 5 to 9 membered heteroaryl, or 5 to 6 membered heteroaryl).

A “size-limited substituent” or “size-limited substituent group,” as used herein, means a group selected from all of the substituents described above for a “substituent group,” wherein each substituted or unsubstituted alkyl is a substituted or unsubstituted C₁-C₂₀ alkyl, each substituted or unsubstituted heteroalkyl is a substituted or unsubstituted 2 to 20 membered heteroalkyl, each substituted or unsubstituted cycloalkyl is a substituted or unsubstituted C₃-C₈ cycloalkyl, each substituted or unsubstituted heterocycloalkyl is a substituted or unsubstituted 3 to 8 membered heterocycloalkyl, each substituted or unsubstituted aryl is a substituted or unsubstituted C₆-C₁₀ aryl, and each substituted or unsubstituted heteroaryl is a substituted or unsubstituted 5 to 10 membered heteroaryl.

A “lower substituent” or “lower substituent group,” as used herein, means a group selected from all of the substituents described above for a “substituent group,” wherein each substituted or unsubstituted alkyl is a substituted or unsubstituted C₁-C₈ alkyl, each substituted or unsubstituted heteroalkyl is a substituted or unsubstituted 2 to 8 membered heteroalkyl, each substituted or unsubstituted cycloalkyl is a substituted or unsubstituted C₃-C₇ cycloalkyl, each substituted or unsubstituted heterocycloalkyl is a substituted or unsubstituted 3 to 7 membered heterocycloalkyl, each substituted or unsubstituted aryl is a substituted or unsubstituted phenyl, and each substituted or unsubstituted heteroaryl is a substituted or unsubstituted 5 to 6 membered heteroaryl.

In some embodiments, each substituted group described in the compounds herein is substituted with at least one substituent group. More specifically, in some embodiments, each substituted alkyl, substituted heteroalkyl, substituted cycloalkyl, substituted heterocycloalkyl, substituted aryl, substituted heteroaryl, substituted alkylene, substituted heteroalkylene, substituted cycloalkylene, substituted heterocycloalkylene, substituted arylene, and/or substituted heteroarylene described in the compounds herein are substituted with at least one substituent group. In other embodiments, at least one or all of these groups are substituted with at least one size-limited substituent group. In other embodiments, at least one or all of these groups are substituted with at least one lower substituent group.

In other embodiments of the compounds herein, each substituted or unsubstituted alkyl may be a substituted or unsubstituted C₁-C₂₀ alkyl, each substituted or unsubstituted heteroalkyl is a substituted or unsubstituted 2 to 20 membered heteroalkyl, each substituted or unsubstituted cycloalkyl is a substituted or unsubstituted C₃-C₈ cycloalkyl, each substituted or unsubstituted heterocycloalkyl is a substituted or unsubstituted 3 to 8 membered heterocycloalkyl, each substituted or unsubstituted aryl is a substituted or unsubstituted C₆-C₁₀ aryl, and/or each substituted or unsubstituted heteroaryl is a substituted or unsubstituted 5 to 10 membered heteroaryl. In some embodiments of the compounds herein, each substituted or unsubstituted alkylene is a substituted or unsubstituted C₁-C₂₀ alkylene, each substituted or unsubstituted heteroalkylene is a substituted or unsubstituted 2 to 20 membered heteroalkylene, each substituted or unsubstituted cycloalkylene is a substituted or unsubstituted C₃-C₈ cycloalkylene, each substituted or unsubstituted heterocycloalkylene is a substituted or unsubstituted 3 to 8 membered heterocycloalkylene, each substituted or unsubstituted arylene is a substituted or unsubstituted C₆-C₁₀ arylene, and/or each substituted or unsubstituted heteroarylene is a substituted or unsubstituted 5 to 10 membered heteroarylene.

In some embodiments, each substituted or unsubstituted alkyl is a substituted or unsubstituted C₁-C₈ alkyl, each substituted or unsubstituted heteroalkyl is a substituted or unsubstituted 2 to 8 membered heteroalkyl, each substituted or unsubstituted cycloalkyl is a substituted or unsubstituted C₃-C₇ cycloalkyl, each substituted or unsubstituted heterocycloalkyl is a substituted or unsubstituted 3 to 7 membered heterocycloalkyl, each substituted or unsubstituted aryl is a substituted or unsubstituted C₆-C₁₀ aryl, and/or each substituted or unsubstituted heteroaryl is a substituted or unsubstituted 5 to 9 membered heteroaryl. In some embodiments, each substituted or unsubstituted alkylene is a substituted or unsubstituted C₁-C₈ alkylene, each substituted or unsubstituted heteroalkylene is a substituted or unsubstituted 2 to 8 membered heteroalkylene, each substituted or unsubstituted cycloalkylene is a substituted or unsubstituted C₃-C₇ cycloalkylene, each substituted or unsubstituted heterocycloalkylene is a substituted or unsubstituted 3 to 7 membered heterocycloalkylene, each substituted or unsubstituted arylene is a substituted or unsubstituted C₆-C₁₀ arylene, and/or each substituted or unsubstituted heteroarylene is a substituted or unsubstituted 5 to 9 membered heteroarylene. In some embodiments, the compound is a chemical species set forth in the application (e.g., Examples section, claims, embodiments, figures, or tables below).

In embodiments, a substituted or unsubstituted moiety (e.g., substituted or unsubstituted alkyl, substituted or unsubstituted heteroalkyl, substituted or unsubstituted cycloalkyl, substituted or unsubstituted heterocycloalkyl, substituted or unsubstituted aryl, substituted or unsubstituted heteroaryl, substituted or unsubstituted alkylene, substituted or unsubstituted heteroalkylene, substituted or unsubstituted cycloalkylene, substituted or unsubstituted heterocycloalkylene, substituted or unsubstituted arylene, and/or substituted or unsubstituted heteroarylene) is unsubstituted (e.g., is an unsubstituted alkyl, unsubstituted heteroalkyl, unsubstituted cycloalkyl, unsubstituted heterocycloalkyl, unsubstituted aryl, unsubstituted heteroaryl, unsubstituted alkylene, unsubstituted heteroalkylene, unsubstituted cycloalkylene, unsubstituted heterocycloalkylene, unsubstituted arylene, and/or unsubstituted heteroarylene, respectively). In embodiments, a substituted or unsubstituted moiety (e.g., substituted or unsubstituted alkyl, substituted or unsubstituted heteroalkyl, substituted or unsubstituted cycloalkyl, substituted or unsubstituted heterocycloalkyl, substituted or unsubstituted aryl, substituted or unsubstituted heteroaryl, substituted or unsubstituted alkylene, substituted or unsubstituted heteroalkylene, substituted or unsubstituted cycloalkylene, substituted or unsubstituted heterocycloalkylene, substituted or unsubstituted arylene, and/or substituted or unsubstituted heteroarylene) is substituted (e.g., is a substituted alkyl, substituted heteroalkyl, substituted cycloalkyl, substituted heterocycloalkyl, substituted aryl, substituted heteroaryl, substituted alkylene, substituted heteroalkylene, substituted cycloalkylene, substituted heterocycloalkylene, substituted arylene, and/or substituted heteroarylene, respectively).

In embodiments, a substituted moiety (e.g., substituted alkyl, substituted heteroalkyl, substituted cycloalkyl, substituted heterocycloalkyl, substituted aryl, substituted heteroaryl, substituted alkylene, substituted heteroalkylene, substituted cycloalkylene, substituted heterocycloalkylene, substituted arylene, and/or substituted heteroarylene) is substituted with at least one substituent group, wherein if the substituted moiety is substituted with a plurality of substituent groups, each substituent group may optionally be different. In embodiments, if the substituted moiety is substituted with a plurality of substituent groups, each substituent group is different.

In embodiments, a substituted moiety (e.g., substituted alkyl, substituted heteroalkyl, substituted cycloalkyl, substituted heterocycloalkyl, substituted aryl, substituted heteroaryl, substituted alkylene, substituted heteroalkylene, substituted cycloalkylene, substituted heterocycloalkylene, substituted arylene, and/or substituted heteroarylene) is substituted with at least one size-limited substituent group, wherein if the substituted moiety is substituted with a plurality of size-limited substituent groups, each size-limited substituent group may optionally be different. In embodiments, if the substituted moiety is substituted with a plurality of size-limited substituent groups, each size-limited substituent group is different.

In embodiments, a substituted moiety (e.g., substituted alkyl, substituted heteroalkyl, substituted cycloalkyl, substituted heterocycloalkyl, substituted aryl, substituted heteroaryl, substituted alkylene, substituted heteroalkylene, substituted cycloalkylene, substituted heterocycloalkylene, substituted arylene, and/or substituted heteroarylene) is substituted with at least one lower substituent group, wherein if the substituted moiety is substituted with a plurality of lower substituent groups, each lower substituent group may optionally be different. In embodiments, if the substituted moiety is substituted with a plurality of lower substituent groups, each lower substituent group is different.

In embodiments, a substituted moiety (e.g., substituted alkyl, substituted heteroalkyl, substituted cycloalkyl, substituted heterocycloalkyl, substituted aryl, substituted heteroaryl, substituted alkylene, substituted heteroalkylene, substituted cycloalkylene, substituted heterocycloalkylene, substituted arylene, and/or substituted heteroarylene) is substituted with at least one substituent group, size-limited substituent group, or lower substituent group; wherein if the substituted moiety is substituted with a plurality of groups selected from substituent groups, size-limited substituent groups, and lower substituent groups; each substituent group, size-limited substituent group, and/or lower substituent group may optionally be different. In embodiments, if the substituted moiety is substituted with a plurality of groups selected from substituent groups, size-limited substituent groups, and lower substituent groups; each substituent group, size-limited substituent group, and/or lower substituent group is different.

In a recited claim or chemical formula description herein, each R substituent or L linker that is described as being “substituted” without reference as to the identity of any chemical moiety that composes the “substituted” group (also referred to herein as an “open substitution” on an R substituent or L linker or an “openly substituted” R substituent or L linker), the recited R substituent or L linker may, in embodiments, be substituted with one or more first substituent groups as defined below.

The first substituent group is denoted with a corresponding first decimal point numbering system such that, for example, R¹ may be substituted with one or more first substituent groups denoted by R^{1.1}, R² may be substituted with one or more first substituent groups denoted by R^{2.1}, R³ may be substituted with one or more first substituent groups denoted by R^{3.1}, R⁴ may be substituted with one or more first substituent groups denoted by R^{4.1}, R⁵ may be substituted with one or more first substituent groups denoted by R^{5.1}, and the like up to or exceeding an R¹⁰⁰ that may be substituted with one or more first substituent groups denoted by R^{100.1} As a further example, R^{1A} may be substituted with one or more first substituent groups denoted by RIA-1, R^{2A} may be substituted with one or more first substituent groups denoted by R^{2A}0.1, R^{IA} may be substituted with one or more first substituent groups denoted by R^{3A.1}, R^{4A} may be substituted with one or more first substituent groups denoted by R^{4A.1}, R^{5A} may be substituted with one or more first substituent groups denoted by R^{5A.1} and the like up to or exceeding an R^{100A} may be substituted with one or more first substituent groups denoted by R^{100A.1} As a further example, L¹ may be substituted with one or more first substituent groups denoted by R^{L1.1} L² may be substituted with one or more first substituent groups denoted by R^{L2.1} L³ may be substituted with one or more first substituent groups denoted by R^{L3.1} L⁴ may be substituted with one or more first substituent groups denoted by R^{L4.1} L⁵ may be substituted with one or more first substituent groups denoted by R^{L5.1} and the like up to or exceeding an L¹⁰⁰ which may be substituted with one or more first substituent groups denoted by R^{L100.1} Thus, each numbered R group or L group (alternatively referred to herein as R^{WW} or L^{WW} wherein “WW” represents the stated superscript number of the subject R group or L group) described herein may be substituted with one or more first substituent groups referred to herein generally as R^{WW.1} or R^{LWW.1}, respectively. In turn, each first substituent group (e.g., R^{1.1}, R^{2.1}, R^{3.1}, R^{4.1}, R^{5.1}. R^{100.1}; R^{1A.1}, R^{2A.1}, R^{3A.1}, R^{4A.1}, R^{5A.1} . . . R^{100A.1}; R^{L1.1}, R^{L2.1}, R^{L3.1}, R^{L4.1}, R^{L5.1} . . . R^{L100.1}) may be further substituted with one or more second substituent groups (e.g., R^{1.2}, R^{2.2}, R^{3.2}, R^{4.2}, R^{5.2} . . . R^{100.2}; R^{1A.2}, R_{2A.2}, R^{3A.2}, R^{4A.2}, R^{5A.2} . . . R^{100A.2}; R^{L1.2}, R_{L2.2}, R^{L3.2}, R^{L4.2}, R^{L5.2} . . . R^{L100.2}, respectively). Thus, each first substituent group, which may alternatively be represented herein as R″w as described above, may be further substituted with one or more second substituent groups, which may alternatively be represented herein as R^{WW.2}.

Finally, each second substituent group (e.g., R^{1.2}, R^{2.2}, R^{3.2}, R^{4.2}, R^{5.2} . . . R^{100.2}; R^{1A.2}, R^{2A.2}, R^{3A.2}, R^{4A.2}, R^{5A.2} . . . R^{100A.2}; R^{L1.2}, R^{L2.2}, R^{L3.2}, R^{L4.2}, R^{L5.2} . . . R^{L100.2}) may be further substituted with one or more third substituent groups (e.g., R^{1.3}, R^{2.3}, R^{3.3}, R^{4.3}, R^{5.3} . . . R^{100.3}; R^{1A.3}, R^{2A.3}, R^{3A.3}, R^{4A.3}, R^{5A.3} . . . R^{100A.3}; R^{L1.3}, R^{L2.3}, R^{L3.3}, R^{L4.3}, R^{L5.3} . . . R^{L100.3}; respectively). Thus, each second substituent group, which may alternatively be represented herein as R^{WW.2} as described above, may be further substituted with one or more third substituent groups, which may alternatively be represented herein as R^{WW.3}. Each of the first substituent groups may be optionally different. Each of the second substituent groups may be optionally different. Each of the third substituent groups may be optionally different.

Thus, as used herein, R^{WW} represents a substituent recited in a claim or chemical formula description herein which is openly substituted. “WW” represents the stated superscript number of the subject R group (1, 2, 3, 1A, 2A, 3A, 1B, 2B, 3B, etc.). Likewise, L^{WW} is a linker recited in a claim or chemical formula description herein which is openly substituted. Again, “WW” represents the stated superscript number of the subject L group (1, 2, 3, 1A, 2A, 3A, 1B, 2B, 3B, etc.). As stated above, in embodiments, each R″w may be unsubstituted or independently substituted with one or more first substituent groups, referred to herein as R^{WW.1}; each first substituent group, R^{WW.1}, may be unsubstituted or independently substituted with one or more second substituent groups, referred to herein as R^{WW.2}; and each second substituent group may be unsubstituted or independently substituted with one or more third substituent groups, referred to herein as R^{WW.3}. Similarly, each L_{WW} linker may be unsubstituted or independently substituted with one or more first substituent groups, referred to herein as R^{LWW.1}; each first substituent group, R^{LWW.1}, may be unsubstituted or independently substituted with one or more second substituent groups, referred to herein as R^{LWW.2}; and each second substituent group may be unsubstituted or independently substituted with one or more third substituent groups, referred to herein as R^{L}Ww.³. Each first substituent group is optionally different. Each second substituent group is optionally different. Each third substituent group is optionally different. For example, if R^{WW} is phenyl, the said phenyl group is optionally substituted by one or more R^{WW.1} groups as defined herein below, e.g., when R^{WW.1} is R^{WW.2}-substituted or unsubstituted alkyl, examples of groups so formed include but are not limited to itself optionally substituted by 1 or more R^{WW.2}, which R^{WW.2} is optionally substituted by one or more R^{WW.3}. By way of example when the R^{WW} group is phenyl substituted by R^{WW.1}, which is methyl, the methyl group may be further substituted to form groups including but not limited to:

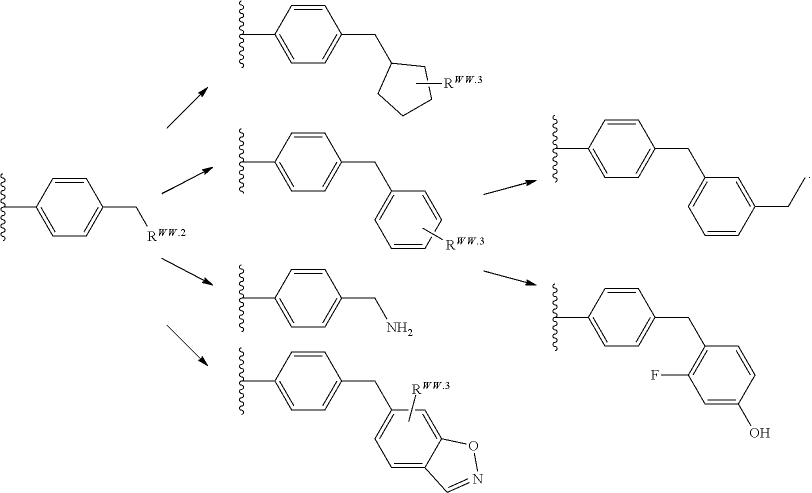

R^{WW.1} is independently oxo,
halogen, —CX^{WW.1}₃, —CHX^{WW.1}₂, —CH₂X^{WW.1}, —OCX^{WW.1}₃,
—OCH₂X^{WW.1}, —OCHX¹², —CN, —OH, —NH₂, —COOH, —CONH₂, —NO₂, —SH, —SO₃H, —OSO₃H,
SO₂NH₂, —NHNH₂, —ONH₂, —NHC(O)NHNH₂, —NHC(O)NH₂, —NHSO₂H, —NHC(O)H, —NHC(O)OH, —NHOH, —N₃, R^{WW.2}-substituted or unsubstituted alkyl (e.g., C₁-C₈, C₁-C₆, C₁-C₄, or C₁-C₂), R^{WW.2}-substituted or unsubstituted heteroalkyl (e.g., 2 to 8 membered, 2 to 6 membered, 4 to 6 membered, 2 to 3 membered, or 4 to 5 membered), R^{WW.2}-substituted or unsubstituted cycloalkyl (e.g., C₃-C₈, C₃-C₆, C₄-C₆, or C₅-C₆), R^{WW.2}-substituted or unsubstituted heterocycloalkyl (e.g., 3 to 8 membered, 3 to 6 membered, 4 to 6 membered, 4 to 5 membered, or 5 to 6 membered), R^{WW.2}-substituted or unsubstituted aryl (e.g., C₆-C₁₂, C₆-C₁₀, or phenyl), or R^{WW.2}-substituted or unsubstituted heteroaryl (e.g., 5 to 12 membered, 5 to 10 membered, 5 to 9 membered, or 5 to 6 membered). In embodiments, R^{WW.1} is independently oxo, halogen,
CX^{WW.1}₃, —CHX^{WW.1}₂, —CH₂X^{WW.1}, —OCX^{WW.1}₃, —OCH₂X^{WW.1}, —OCHX^{WW.1}₂, —CN, —OH, —NH₂—COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —N₃, unsubstituted alkyl (e.g., C₁-C₈, C₁-C₆, C₁-C₄, or C₁-C₂), unsubstituted heteroalkyl (e.g., 2 to 8 membered, 2 to 6 membered, 4 to 6 membered, 2 to 3 membered, or 4 to 5 membered), unsubstituted cycloalkyl (e.g., C₃-C₈, C₃-C₆, C₄-C₆, or C₅-C₆), unsubstituted heterocycloalkyl (e.g., 3 to 8 membered, 3 to 6 membered, 4 to 6 membered, 4 to 5 membered, or 5 to 6 membered), unsubstituted aryl (e.g., C₆-C₁₂, C₆-C₁₀, or phenyl), or unsubstituted heteroaryl (e.g., 5 to 12 membered, 5 to 10 membered, 5 to 9 membered, or 5 to 6 membered). X^{WW.1} is independently —F, —Cl, —Br, or —I.
R^{WW.2} is independently oxo,
halogen, —CX^{WW.2}₃, —CHX^{WW.2}₂, —CH₂X^{WW.2}, —OCX^{WW.2}₃—OCH₂X^{WW.2}, —OCHX^{WW.2}₂, —CN, —OH, —NH₂, —COOH, —CONH₂, —NO₂, —SH, —SO₃H, —OSO₃H,
—SO₂NH₂, —NHNH₂, —ONH₂, —NHC(O)NHNH₂, —NHC(O)NH₂, —NHSO₂H, —NHC(O)H, —NHC(O)OH, —NHOH, —N₃, R^{WW.3}-substituted or unsubstituted alkyl (e.g., C₁-C₈, C₁-C₆, C₁-C₄, or C₁-C₂), R^{WW}0.3-substituted or unsubstituted heteroalkyl (e.g., 2 to 8 membered, 2 to 6 membered, 4 to 6 membered, 2 to 3 membered, or 4 to 5 membered), R^{WW.3}-substituted or unsubstituted cycloalkyl (e.g., C₃-C₅, C₃-C₆, C₄-C₆, or C₅-C₆), R^{WW.3}-substituted or unsubstituted heterocycloalkyl (e.g., 3 to 8 membered, 3 to 6 membered, 4 to 6 membered, 4 to 5 membered, or 5 to 6 membered), R^{WW.3}-substituted or unsubstituted aryl (e.g., C₆-C₁₂, C₆-C₁₀, or phenyl), or R^{WW.3}-substituted or unsubstituted heteroaryl (e.g., 5 to 12 membered, 5 to 10 membered, 5 to 9 membered, or 5 to 6 membered). In embodiments, R^{WW.2} is independently oxo, halogen,
—CX^{WW.2}₃, —CHX^{WW.2}₂, —CH₂X^{WW.2}, —OCX^{WW.2}₃, —OCH₂X^{WW.2}, —OCHX^{WW.2}₂, —CN, —OH, —NH₂
—COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —N₃, unsubstituted alkyl (e.g., C₁-C₈, C₁-C₆, C₁-C₄, or C₁-C₂), unsubstituted heteroalkyl (e.g., 2 to 8 membered, 2 to 6 membered, 4 to 6 membered, 2 to 3 membered, or 4 to 5 membered), unsubstituted cycloalkyl (e.g., C₃-C₅, C₃-C₆, C₄-C₆, or C₅-C₆), unsubstituted heterocycloalkyl (e.g., 3 to 8 membered, 3 to 6 membered, 4 to 6 membered, 4 to 5 membered, or 5 to 6 membered), unsubstituted aryl (e.g., C₆-C₁₂, C₆-C₁₀, or phenyl), or unsubstituted heteroaryl (e.g., 5 to 12 membered, 5 to 10 membered, 5 to 9 membered, or 5 to 6 membered). X^{WW.2} is independently —F, —Cl, —Br, or —I.
R^{WW.3} is independently oxo,
halogen, —CX^{WW.3}₃, —CHX^{WW.3}₂, —CH₂X^{WW.3}, —OCX^{WW.3}₃,
—OCH₂X^{WW.3}, —OCHX^{WW.3}₂, —CN, —OH, —NH₂, —COOH, —CONH₂, —NO₂, —SH, —SO₃H, —OSO₃H,
—SO₂NH₂, —NHNH₂, —ONH₂, —NHC(O)NHNH₂, —NHC(O)NH₂, —NHSO₂H, —NHC(O)H, —NHC(O)OH, —NHOH, —N₃, unsubstituted alkyl (e.g., C₁-C₈, C₁-C₆, C₁-C₄, or C₁-C₂), unsubstituted heteroalkyl (e.g., 2 to 8 membered, 2 to 6 membered, 4 to 6 membered, 2 to 3 membered, or 4 to 5 membered), unsubstituted cycloalkyl (e.g., C₃-C₈, C₃-C₆, C₄-C₆, or C₅-C₆), unsubstituted heterocycloalkyl (e.g., 3 to 8 membered, 3 to 6 membered, 4 to 6 membered, 4 to 5 membered, or 5 to 6 membered), unsubstituted aryl (e.g., C₆-C₁₂, C₆-C₁₀, or phenyl), or unsubstituted heteroaryl (e.g., 5 to 12 membered, 5 to 10 membered, 5 to 9 membered, or 5 to 6 membered). X^{WW.3} is independently —F, —Cl, —Br, or —I.

Where two different R^{WW} substituents are joined together to form an openly substituted ring (e.g., substituted cycloalkyl, substituted heterocycloalkyl, substituted aryl or substituted heteroaryl), in embodiments the openly substituted ring may be independently substituted with one or more first substituent groups, referred to herein as R^{WW.1}; each first substituent group, R^{WW.1}, may be unsubstituted or independently substituted with one or more second substituent groups, referred to herein as R^{WW.2}; and each second substituent group, R^{WW.2}, may be unsubstituted or independently substituted with one or more third substituent groups, referred to herein as R^{WW.3}; and each third substituent group, R^{WW.3}, is unsubstituted. Each first substituent group is optionally different. Each second substituent group is optionally different. Each third substituent group is optionally different. In the context of two different R^{WW} substituents joined together to form an openly substituted ring, the “WW” symbol in the R^{WW.1}, R^{WW.2} and R^{WW.3} refers to the designated number of one of the two different R^{WW} substituents. For example, in embodiments where R^{100A} and R^{100B} are optionally joined together to form an openly substituted ring, R^{WW.1} is R^{100A.1} R^{WW.2} is R^{100A.2}, and R^{WW.3} is R^{100A.3}. Alternatively, in embodiments where R^{100A} and R^{100B} are optionally joined together to form an openly substituted ring, R^{WW.1} is R^{100B.1}, R^{WW.2} is R^{100B.2}, and R^{WW.3} is R^{100B3}. R^{WW.1}, R^{WW.2} and R^{WW.3} in this paragraph are as defined in the preceding paragraphs.
R^{LWW.1} is independently oxo, halogen, —CX^{LWW.1}₃, —CHX^{LWW.1}₂, —CH₂X^{LWW.1}, —OCX^{LWW.1}₃, —OCH₂X^{LWW.1}, —OCHX^{LWW.1}₂—CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —N₃, R^{L} 0.2_substituted or unsubstituted alkyl (e.g., C₁-C₈, C₁-C₆, C₁-C₄, or C₁-C₂), R^{LWW.2}-substituted or unsubstituted heteroalkyl (e.g., 2 to 8 membered, 2 to 6 membered, 4 to 6 membered, 2 to 3 membered, or 4 to 5 membered), R^{LWW.2}-substituted or unsubstituted cycloalkyl (e.g., C₃-C₈, C₃-C₆, C₄-C₆, or C₅-C₆), R^{LWW.2}-substituted or unsubstituted heterocycloalkyl (e.g., 3 to 8 membered, 3 to 6 membered, 4 to 6 membered, 4 to 5 membered, or 5 to 6 membered), R^{LWW.2}-substituted or unsubstituted aryl (e.g., C₆-C₁₂, C₆-C₁₀, or phenyl), or R^{LWW.2}-substituted or unsubstituted heteroaryl (e.g., 5 to 12 membered, 5 to 10 membered, 5 to 9 membered, or 5 to 6 membered). In embodiments, R^{LWW} is independently oxo,
halogen, —CX^{LwW.1}₃, —CHX^{LWW.1}₂—CH₂X^{LWW.1}, —OCX^{LWW.1}₃—OCH₂X^{LWW.1}, —OCHX^{LWW.1}₂, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂,
—NHC(O)NH₂, —NHSO₂H, —NHC(O)H, —NHC(O)OH, —NHOH, —N₃, unsubstituted alkyl (e.g., C₁-C₈, C₁-C₆, C₁-C₄, or C₁-C₂), unsubstituted heteroalkyl (e.g., 2 to 8 membered, 2 to 6 membered, 4 to 6 membered, 2 to 3 membered, or 4 to 5 membered), unsubstituted cycloalkyl (e.g., C₃-C₈, C₃-C₆, C₄-C₆, or C₅-C₆), unsubstituted heterocycloalkyl (e.g., 3 to 8 membered, 3 to 6 membered, 4 to 6 membered, 4 to 5 membered, or 5 to 6 membered), unsubstituted aryl (e.g., C₆-C₁₂, C₆-C₁₀, or phenyl), or unsubstituted heteroaryl (e.g., 5 to 12 membered, 5 to 10 membered, 5 to 9 membered, or 5 to 6 membered). X^{LWW1} is independently —F, —Cl, —Br, or —I.
R^{LWW.2} is independently oxo, halogen, —CX^{LWW.2}₃, —CHX^{LWW.2}₂, —CH₂X^{LWW.1}₂, —OCX^{LWW.2}₃, —OCH₂X^{LWW.2}, —OCHX^{LWW.2}₂, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —N₃, R^{LWW.3}-substituted or unsubstituted alkyl (e.g., C₁-C₈, C₁-C₆, C₁-C₄, or C₁-C₂), R^{L}w 0.3-substituted or unsubstituted heteroalkyl (e.g., 2 to 8 membered, 2 to 6 membered, 4 to 6 membered, 2 to 3 membered, or 4 to 5 membered), R^{WW.3}-substituted or unsubstituted cycloalkyl (e.g., C₃-C₈, C₃-C₆, C₄-C₆, or C₅-C₆), R^{LWW.3}-substituted or unsubstituted heterocycloalkyl (e.g., 3 to 8 membered, 3 to 6 membered, 4 to 6 membered, 4 to 5 membered, or 5 to 6 membered), R^{LWW.3}-substituted or unsubstituted aryl (e.g., C₆-C₁₂, C₆-C₁₀, or phenyl), or R^{LWW.3}-substituted or unsubstituted heteroaryl (e.g., 5 to 12 membered, 5 to 10 membered, 5 to 9 membered, or 5 to 6 membered). In embodiments, R^{LWW.2} is independently oxo,
halogen, —CX^{LWW.2}₃, —CHX^{LWW.2}₂, —CH₂X^{LWW.2}, —OCX^{LWW.2}₃, —OCH₂X^{LWW.2}, —OCHX^{LWW.2}₂, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)—OH, —NHOH, —N₃, unsubstituted alkyl (e.g., C₁-C₈, C₁-C₆, C₁-C₄, or C₁-C₂), unsubstituted heteroalkyl (e.g., 2 to 8 membered, 2 to 6 membered, 4 to 6 membered, 2 to 3 membered, or 4 to 5 membered), unsubstituted cycloalkyl (e.g., C₃-C₈, C₃-C₆, C₄-C₆, or C₅-C₆), unsubstituted heterocycloalkyl (e.g., 3 to 8 membered, 3 to 6 membered, 4 to 6 membered, 4 to 5 membered, or 5 to 6 membered), unsubstituted aryl (e.g., C₆-C₁₂, C₆-C₁₀, or phenyl), or unsubstituted heteroaryl (e.g., 5 to 12 membered, 5 to 10 membered, 5 to 9 membered, or 5 to 6 membered). X^{LWW.2} is independently —F, —Cl, —Br, or —I.
R^{LWW.3} is independently oxo, halogen, —CX^{LWW.3}₃, —CHX^{LWW.3}₂, —CH₂X^{LWW.3}—OCX^{LWW.3}₃, —OCH₂X^{LWW.3}, —OCHX^{LWW.3}₂, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —N₃, unsubstituted alkyl (e.g., C₁-C₈, C₁-C₆, C₁-C₄, or C₁-C₂), unsubstituted heteroalkyl (e.g., 2 to 8 membered, 2 to 6 membered, 4 to 6 membered, 2 to 3 membered, or 4 to 5 membered), unsubstituted cycloalkyl (e.g., C₃-C₈, C₃-C₆, C₄-C₆, or C₅-C₆), unsubstituted heterocycloalkyl (e.g., 3 to 8 membered, 3 to 6 membered, 4 to 6 membered, 4 to 5 membered, or 5 to 6 membered), unsubstituted aryl (e.g., C₆-C₁₂, C₆-C₁₀, or phenyl), or unsubstituted heteroaryl (e.g., 5 to 12 membered, 5 to 10 membered, 5 to 9 membered, or 5 to 6 membered). X^{LWW.3} is independently —F, —Cl, —Br, or —I.

In the event that any R group recited in a claim or chemical formula description set forth herein (R^{WW} substituent) is not specifically defined in this disclosure, then that R group (R^{WW} group) is hereby defined as independently oxo, halogen, —CX^{WW}₃, —C^{HXWW}₂, —CH₂X^{WW},
—OCX^{WW}₃, —OCH₂X^{WW}, —OCHX^{WW}₂, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —N₃, R^{WW.1}-substituted or unsubstituted alkyl (e.g., C₁-C₈, C₁-C₆, C₁-C₄, or C₁-C₂), R^{WW.1}-substituted or unsubstituted heteroalkyl (e.g., 2 to 8 membered, 2 to 6 membered, 4 to 6 membered, 2 to 3 membered, or 4 to 5 membered), R^{WW.1}-substituted or unsubstituted cycloalkyl (e.g., C₃-C₈, C₃-C₆, C₄-C₆, or C₅-C₆), R^{WW}-1-substituted or unsubstituted heterocycloalkyl (e.g., 3 to 8 membered, 3 to 6 membered, 4 to 6 membered, 4 to 5 membered, or 5 to 6 membered), R^{WW.1}-substituted or unsubstituted aryl (e.g., C₆-C₁₂, C₆-C₁₀, or phenyl), or R^{WW.1}-substituted or unsubstituted heteroaryl (e.g., 5 to 12 membered, 5 to 10 membered, 5 to 9 membered, or 5 to 6 membered). X^{WW} is independently —F, —Cl, —Br, or —I. Again, “WW” represents the stated superscript number of the subject R group (e.g., 1, 2, 3, 1A, 2A, 3A, 1B, 2B, 3B, etc.). R^{WW.1}, R^{WW.2}, and R^{WW.3} are as defined above.

In the event that any L linker group recited in a claim or chemical formula description set forth herein (i.e., an L^{WW} substituent) is not explicitly defined, then that L group (L^{WW} group) is herein defined as independently a bond, —O—, —NH—, —C(O)—, —C(O)NH—, —NHC(O)—,
—NHC(O)NH—, —C(O)O—, —OC(O)—, —S—, —SO₂—, —SO₂NH—, R^{LWW.1}-substituted or unsubstituted alkylene (e.g., C₁-C₈, C₁-C₆, C₁-C₄, or C₁-C₂), R^{LWW.1}-substituted or unsubstituted heteroalkylene (e.g., 2 to 8 membered, 2 to 6 membered, 4 to 6 membered, 2 to 3 membered, or 4 to 5 membered), R^{LWW.1}-substituted or unsubstituted cycloalkylene (e.g., C₃-C₈, C₃-C₆, C₄-C₆, or C₅-C₆), R^{L}.¹-substituted or unsubstituted heterocycloalkylene (e.g., 3 to 8 membered, 3 to 6 membered, 4 to 6 membered, 4 to 5 membered, or 5 to 6 membered), R^{LWW.1}-substituted or unsubstituted arylene (e.g., C₆-C₁₂, C₆-C₁₀, or phenyl), or R^{LWW.1}-substituted or unsubstituted heteroarylene (e.g., 5 to 12 membered, 5 to 10 membered, 5 to 9 membered, or 5 to 6 membered). Again, “WW” represents the stated superscript number of the subject L group (1, 2, 3, 1A, 2A, 3A, 1B, 2B, 3B, etc.). R^{LWW.1}, as well as R^{LWW.2} and R^{LWW.3} are as defined above.

Certain compounds of the present disclosure possess asymmetric carbon atoms (optical or chiral centers) or double bonds; the enantiomers, racemates, diastereomers, tautomers, geometric isomers, stereoisometric forms that may be defined, in terms of absolute stereochemistry, as (R)- or (S)- or, as (D)- or (L)- for amino acids, and individual isomers are encompassed within the scope of the present disclosure. The compounds of the present disclosure do not include those that are known in art to be too unstable to synthesize and/or isolate. The present disclosure is meant to include compounds in racemic and optically pure forms. Optically active (R)- and (S)-, or (D)- and (L)-isomers may be prepared using chiral synthons or chiral reagents, or resolved using conventional techniques. When the compounds described herein contain olefinic bonds or other centers of geometric asymmetry, and unless specified otherwise, it is intended that the compounds include both E and Z geometric isomers.

As used herein, the term “isomers” refers to compounds having the same number and kind of atoms, and hence the same molecular weight, but differing in respect to the structural arrangement or configuration of the atoms.

The term “tautomer,” as used herein, refers to one of two or more structural isomers which exist in equilibrium and which are readily converted from one isomeric form to another.

It will be apparent to one skilled in the art that certain compounds of this disclosure may exist in tautomeric forms, all such tautomeric forms of the compounds being within the scope of the disclosure.

Unless otherwise stated, structures depicted herein are also meant to include all stereochemical forms of the structure; i.e., the R and S configurations for each asymmetric center. Therefore, single stereochemical isomers as well as enantiomeric and diastereomeric mixtures of the present compounds are within the scope of the disclosure.

Unless otherwise stated, structures depicted herein are also meant to include compounds which differ only in the presence of one or more isotopically enriched atoms. For example, compounds having the present structures except for the replacement of a hydrogen by a deuterium or tritium, or the replacement of a carbon by ¹³C- or ¹⁴C-enriched carbon are within the scope of this disclosure.

The compounds of the present disclosure may also contain unnatural proportions of atomic isotopes at one or more of the atoms that constitute such compounds. For example, the compounds may be radiolabeled with radioactive isotopes, such as for example tritium (³H), iodine-125 (¹²⁵I), or carbon-14 (¹⁴C). All isotopic variations of the compounds of the present disclosure, whether radioactive or not, are encompassed within the scope of the present disclosure.

It should be noted that throughout the application that alternatives are written in Markush groups, for example, each amino acid position that contains more than one possible amino acid. It is specifically contemplated that each member of the Markush group should be considered separately, thereby comprising another embodiment, and the Markush group is not to be read as a single unit.

“Analog” or “analogue” is used in accordance with its plain ordinary meaning within Chemistry and Biology and refers to a chemical compound that is structurally similar to another compound (i.e., a so-called “reference” compound) but differs in composition, e.g., in the replacement of one atom by an atom of a different element, or in the presence of a particular functional group, or the replacement of one functional group by another functional group, or the absolute stereochemistry of one or more chiral centers of the reference compound. Accordingly, an analog is a compound that is similar or comparable in function and appearance but not in structure or origin to a reference compound.

The terms “a” or “an”, as used in herein means one or more. In addition, the phrase “substituted with a[n]”, as used herein, means the specified group may be substituted with one or more of any or all of the named substituents. For example, where a group, such as an alkyl or heteroaryl group, is “substituted with an unsubstituted C₁-C₂₀ alkyl, or unsubstituted 2 to 20 membered heteroalkyl”, the group may contain one or more unsubstituted C₁-C₂₀ alkyls, and/or one or more unsubstituted 2 to 20 membered heteroalkyls.

Moreover, where a moiety is substituted with an R substituent, the group may be referred to as “R-substituted.” Where a moiety is R-substituted, the moiety is substituted with at least one R substituent and each R substituent is optionally different. Where a particular R group is present in the description of a chemical genus (such as Formula (I)), a Roman alphabetic symbol may be used to distinguish each appearance of that particular R group. For example, where multiple R¹³ substituents are present, each R¹³ substituent may be distinguished as R¹³A, R^{13B}, R^{13C}, R^{13D}, etc., wherein each of R¹³A, R^{13B}, R^{13C}, R^{13D}, etc. is defined within the scope of the definition of R¹³ and optionally differently.

Radioactive substances (e.g., radioisotopes) that may be used as imaging and/or labeling agents in accordance with the embodiments of the disclosure include, but are not limited to, ¹⁸F, ³²P, ³³P, ⁴⁵Ti, ⁴⁷Sc, ⁵²Fe, ⁵⁹Fe, ⁶²Cu, ⁶⁴Cu, ⁶⁷Cu, ⁶⁷Ga, ⁶⁸Ga, ⁷⁷As, ⁸⁶Y, ⁹⁰Y ⁸⁹Sr, ⁸⁹Zr, ⁹⁴Tc, ⁹⁴Tc, ^{99m}Tc, ⁹⁹Mo, ¹⁰⁵Pd, ¹⁰⁵R, ¹¹¹Ag, ¹¹¹In, ¹²³I, ¹²⁴I ¹²⁵I, ¹³¹I, ¹⁴²Pr, ¹⁴³Pr, ¹⁴⁹Pm, ¹⁵³Sm, ¹⁵⁴⁻¹⁵⁸¹Gd, ¹⁶¹Tb, ¹⁶⁶Dy, ¹⁶⁶Ho, ¹⁶⁹Er, ¹⁷⁵Lu, ¹⁷⁷Lu, ¹⁸⁶Re, ¹⁸⁸Re, ¹⁸⁹Re, ¹⁹⁴Ir, ¹⁹⁸Au, ¹⁹⁹Au, ²¹¹At, ²¹¹Pb, ²¹²Pb, ²¹²Bi, ²¹³Bi, ²²³Ra, and ²²⁵Ac. Paramagnetic ions that may be used as additional imaging agents in accordance with the embodiments of the disclosure include, but are not limited to, ions of transition and lanthanide metals (e.g., metals having atomic numbers of 21-29, 42, 43, 44, or 57-71). These metals include ions of Cr, V, Mn, Fe, Co, Ni, Cu, La, Ce, Pr, Nd, Pm, Sm, Eu, Gd, Tb, Dy, Ho, Er, Tm, Yb, and Lu.

Descriptions of compounds of the present disclosure are limited by principles of chemical bonding known to those skilled in the art. Accordingly, where a group may be substituted by one or more of a number of substituents, such substitutions are selected so as to comply with principles of chemical bonding and to give compounds which are not inherently unstable and/or would be known to one of ordinary skill in the art as likely to be unstable under ambient conditions, such as aqueous, neutral, and several known physiological conditions. For example, a heterocycloalkyl or heteroaryl is attached to the remainder of the molecule via a ring heteroatom in compliance with principles of chemical bonding known to those skilled in the art thereby avoiding inherently unstable compounds.

A person of ordinary skill in the art will understand when a variable (e.g., moiety or linker) of a compound or of a compound genus (e.g., a genus described herein) is described by a name or formula of a standalone compound with all valencies filled, the unfilled valence(s) of the variable will be dictated by the context in which the variable is used. For example, when a variable of a compound as described herein is connected (e.g., bonded) to the remainder of the compound through a single bond, that variable is understood to represent a monovalent form (i.e., capable of forming a single bond due to an unfilled valence) of a standalone compound (e.g., if the variable is named “methane” in an embodiment but the variable is known to be attached by a single bond to the remainder of the compound, a person of ordinary skill in the art would understand that the variable is actually a monovalent form of methane, i.e., methyl or
—CH₃). Likewise, for a linker variable (e.g., L¹, L², or L³ as described herein), a person of ordinary skill in the art will understand that the variable is the divalent form of a standalone compound (e.g., if the variable is assigned to “PEG” or “polyethylene glycol” in an embodiment but the variable is connected by two separate bonds to the remainder of the compound, a person of ordinary skill in the art would understand that the variable is a divalent (i.e., capable of forming two bonds through two unfilled valences) form of PEG instead of the standalone compound PEG).

As used herein, the term “salt” refers to acid or base salts of the compounds used in the methods of the present invention. Illustrative examples of acceptable salts are mineral acid (hydrochloric acid, hydrobromic acid, phosphoric acid, and the like) salts, organic acid (acetic acid, propionic acid, glutamic acid, citric acid and the like) salts, quaternary ammonium (methyl iodide, ethyl iodide, and the like) salts.

Thus, the compounds of the present disclosure may exist as salts. The present disclosure includes such salts. Non-limiting examples of such salts include hydrochlorides, hydrobromides, phosphates, sulfates, methanesulfonates, nitrates, maleates, acetates, citrates, fumarates, proprionates, tartrates (e.g., (+)-tartrates, (−)-tartrates, or mixtures thereof including racemic mixtures), succinates, benzoates, and salts with amino acids such as glutamic acid, and quaternary ammonium salts (e.g., methyl iodide, ethyl iodide, and the like). These salts may be prepared by methods known to those skilled in the art.

The neutral forms of the compounds are preferably regenerated by contacting the salt with a base or acid and isolating the parent compound in the conventional manner. The parent form of the compound may differ from the various salt forms in certain physical properties, such as solubility in polar solvents.

Certain compounds of the present disclosure can exist in unsolvated forms as well as solvated forms, including hydrated forms. In general, the solvated forms are equivalent to unsolvated forms and are encompassed within the scope of the present disclosure. Certain compounds of the present disclosure may exist in multiple crystalline or amorphous forms. In general, all physical forms are equivalent for the uses contemplated by the present disclosure and are intended to be within the scope of the present disclosure.

As used herein, the term “about” means a range of values including the specified value, which a person of ordinary skill in the art would consider reasonably similar to the specified value. In embodiments, about means within a standard deviation using measurements generally acceptable in the art. In embodiments, about means a range extending to +/−10% of the specified value. In embodiments, about includes the specified value.

“Contacting” is used in accordance with its plain ordinary meaning and refers to the process of allowing at least two distinct species (e.g., chemical compounds including biomolecules or cells) to become sufficiently proximal to react, interact or physically touch. It should be appreciated; however, the resulting reaction product can be produced directly from a reaction between the added reagents or from an intermediate from one or more of the added reagents that can be produced in the reaction mixture.

In this disclosure, “comprises,” “comprising,” “containing” and “having” and the like can have the meaning ascribed to them in U.S. Patent law and can mean “includes,” “including,” and the like. “Consisting essentially of” or “consists essentially” likewise has the meaning ascribed in U.S. Patent law and the term is open-ended, allowing for the presence of more than that which is recited so long as basic or novel characteristics of that which is recited is not changed by the presence of more than that which is recited, but excludes prior art embodiments.

The term “polymer” is used in accordance with its plain ordinary meaning in the art, and refers to a molecule including repeating subunits (e.g., polymerized monomers).

The term “cross-linked polymer” is used in accordance with its plain ordinary meaning in the art, and refers to polymer wherein a first polymer chain is connected to a second polymer chain via a linker.

The term “polyisobutene” or “PIB” is used in accordance with its plain ordinary meaning in the art, and refers to a class of organic polymers prepared by polymerization of isobutene.

The term “oxidation” is used in accordance with its plain ordinary meaning in the art, and refers to a loss of electrons or an increase in the oxidation state of a species (e.g., atom, ion, or certain atoms in a molecule). The term “oxidized” is used to describe a species (e.g., atom, ion, or certain atoms in a molecule) that has undergone an oxidation reaction.

The term “oxidizing agent” is used in accordance with its plain ordinary meaning in the art, and refers to a species that removes electrons from other reactants during a redox reaction. A “redox reaction” or “oxidation-reduction reaction” is a type of chemical reaction that involves a transfer of electrons between two species. Examples of oxidizing agents include, but are not limited to, oxygen, ozone, peroxides (e.g., hydrogen peroxide), or N-oxides (e.g., pyridine N-oxide), nitric acid, sulfuric acid, peroxydisulfuric acid, chlorite, chlorate, perchlorate, hypochlorite, permanaganate compounds (e.g., potassium permanganate), sodium perborate, nitrous oxide, or potassium nitrate.

The term “reducing agent” is used in accordance with its plain ordinary meaning in the art, and refers to a species that loses an electron to an electron recipient during a redox reaction. Examples of reducing agents include, but are not limited to, lithium aluminum hydride, atomic hydrogen, hydrogen without or with a suitable catalyst (e.g., Lindlar catalyst), sodium amalgam, sodium-lead alloy, zinc amalgam, diborane, sodium borohydride, iron(II) sulfate, tin(II) chloride, sulfur dioxide, dithionates, thiosulfates, iodides, hydrazine, or diisobutylaluminum hydride.

The term “catalyst” is used in accordance with its plain ordinary meaning in the art, and refers to a species that increases the rate of a chemical reaction. The catalyst is not consumed in the reaction and can continue to act repeatedly.

The term “metal catalyst” as used herein refers to a catalyst including a transition metal. A “transition metal” refers to an element whose atom has a partially filled d sub-shell, or which can give rise to cations with an incomplete d sub-shell. A person having skill in the art would understand a transition metal to be any element in the d-block of the periodic table, which includes groups 3 to 12 on the periodic table.

The term “high-density polyethylene” or “HDPE” refers to a thermoplastic polymer produced from the monomer ethylene and is known for its high strength-to-density ratio. Typically, the density of HDPE ranges from about 0.93 g/cm³ to about 0.97 g/cm³. HDPE has minimal branching of its polymer chains and is therefore denser than low-density polyethylene.

The term “low-density polyethylene” or “LDPE” refers to a thermoplastic polymer produced from the monomer ethylene. Typically, the density of LDPE ranges from about 0.917 g/cm³ to about 0.930 g/cm³.

The term “linear low-density polyethylene” or “LLDPE” refers to a substantially linear polyethylene with significant numbers of short branches. LLDPE differs from LDPE because of the absence of long chain branching. Typically, the density of LLDPE ranges from about 0.91 g/cm³ to about 0.94 g/cm³.

### II. Compounds

In an aspect is provided an oxidized polyisobutene, including a first oxidized subunit and a non-oxidized subunit.

The first oxidized subunit has the formula:

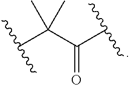 [SMILES: *C(=O)C(*)(C)C]

The non-oxidized subunit has the formula:

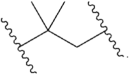 [SMILES: *CC(*)(C)C]

The ratio of the first oxidized subunit to the non-oxidized subunit is from 1:10,000 to 1:5.

The oxidized polyisobutene has a number average molecular weight from 250 Da to 20,000,000 Da.

In embodiments, the oxidized polyisobutene further includes a second oxidized subunit, wherein the second oxidized subunit has the formula:

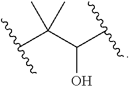 [SMILES: *C(O)C(*)(C)C]

The ratio of the first and second oxidized subunits to the non-oxidized subunit is from 1:10,000 to 1:5.

In embodiments, the oxidized polyisobutene consists of only the first oxidized subunit and the non-oxidized subunit. In embodiments, the oxidized polyisobutene consists of only the first oxidized subunit, the second oxidized subunit, and the non-oxidized subunit.

In embodiments, the ratio of the first oxidized subunit to the non-oxidized subunit is from 1:8000 to 1:5. In embodiments, the ratio of the first oxidized subunit to the non-oxidized subunit is from 1:6000 to 1:5. In embodiments, the ratio of the first oxidized subunit to the non-oxidized subunit is from 1:4000 to 1:5. In embodiments, the ratio of the first oxidized subunit to the non-oxidized subunit is from 1:2000 to 1:5. In embodiments, the ratio of the first oxidized subunit to the non-oxidized subunit is from 1:1000 to 1:5. In embodiments, the ratio of the first oxidized subunit to the non-oxidized subunit is from 1:800 to 1:5. In embodiments, the ratio of the first oxidized subunit to the non-oxidized subunit is from 1:600 to 1:5. In embodiments, the ratio of the first oxidized subunit to the non-oxidized subunit is from 1:400 to 1:5. In embodiments, the ratio of the first oxidized subunit to the non-oxidized subunit is from 1:200 to 1:5. In embodiments, the ratio of the first oxidized subunit to the non-oxidized subunit is from 1:100 to 1:5. In embodiments, the ratio of the first oxidized subunit to the non-oxidized subunit is from 1:50 to 1:5. In embodiments, the ratio of the first oxidized subunit to the non-oxidized subunit is from 1:10,000 to 1:10. In embodiments, the ratio of the first oxidized subunit to the non-oxidized subunit is from 1:8000 to 1:10. In embodiments, the ratio of the first oxidized subunit to the non-oxidized subunit is from 1:6000 to 1:10. In embodiments, the ratio of the first oxidized subunit to the non-oxidized subunit is from 1:4000 to 1:10. In embodiments, the ratio of the first oxidized subunit to the non-oxidized subunit is from 1:2000 to 1:10. In embodiments, the ratio of the first oxidized subunit to the non-oxidized subunit is from 1:1000 to 1:10. In embodiments, the ratio of the first oxidized subunit to the non-oxidized subunit is from 1:800 to 1:10. In embodiments, the ratio of the first oxidized subunit to the non-oxidized subunit is from 1:600 to 1:10. In embodiments, the ratio of the first oxidized subunit to the non-oxidized subunit is from 1:400 to 1:10. In embodiments, the ratio of the first oxidized subunit to the non-oxidized subunit is from 1:200 to 1:10. In embodiments, the ratio of the first oxidized subunit to the non-oxidized subunit is from 1:100 to 1:10. In embodiments, the ratio of the first oxidized subunit to the non-oxidized subunit is from 1:50 to 1:10.

In embodiments, the ratio of the first oxidized subunit to the non-oxidized subunit is from about 1:10,000 to about 1:5. In embodiments, the ratio of the first oxidized subunit to the non-oxidized subunit is from about 1:8000 to about 1:5. In embodiments, the ratio of the first oxidized subunit to the non-oxidized subunit is from about 1:6000 to about 1:5. In embodiments, the ratio of the first oxidized subunit to the non-oxidized subunit is from about 1:4000 to about 1:5. In embodiments, the ratio of the first oxidized subunit to the non-oxidized subunit is from about 1:2000 to about 1:5. In embodiments, the ratio of the first oxidized subunit to the non-oxidized subunit is from about 1:1000 to about 1:5. In embodiments, the ratio of the first oxidized subunit to the non-oxidized subunit is from about 1:800 to about 1:5. In embodiments, the ratio of the first oxidized subunit to the non-oxidized subunit is from about 1:600 to about 1:5. In embodiments, the ratio of the first oxidized subunit to the non-oxidized subunit is from about 1:400 to about 1:5. In embodiments, the ratio of the first oxidized subunit to the non-oxidized subunit is from about 1:200 to about 1:5. In embodiments, the ratio of the first oxidized subunit to the non-oxidized subunit is from about 1:100 to about 1:5. In embodiments, the ratio of the first oxidized subunit to the non-oxidized subunit is from about 1:50 to about 1:5. In embodiments, the ratio of the first oxidized subunit to the non-oxidized subunit is from about 1:10,000 to about 1:10. In embodiments, the ratio of the first oxidized subunit to the non-oxidized subunit is from about 1:8000 to about 1:10. In embodiments, the ratio of the first oxidized subunit to the non-oxidized subunit is from about 1:6000 to about 1:10. In embodiments, the ratio of the first oxidized subunit to the non-oxidized subunit is from about 1:4000 to about 1:10. In embodiments, the ratio of the first oxidized subunit to the non-oxidized subunit is from about 1:2000 to about 1:10. In embodiments, the ratio of the first oxidized subunit to the non-oxidized subunit is from about 1:1000 to about 1:10. In embodiments, the ratio of the first oxidized subunit to the non-oxidized subunit is from about 1:800 to about 1:10. In embodiments, the ratio of the first oxidized subunit to the non-oxidized subunit is from about 1:600 to about 1:10. In embodiments, the ratio of the first oxidized subunit to the non-oxidized subunit is from about 1:400 to about 1:10. In embodiments, the ratio of the first oxidized subunit to the non-oxidized subunit is from about 1:200 to about 1:10. In embodiments, the ratio of the first oxidized subunit to the non-oxidized subunit is from about 1:100 to about 1:10. In embodiments, the ratio of the first oxidized subunit to the non-oxidized subunit is from about 1:50 to about 1:10.

In embodiments, the oxidized polyisobutene has a number average molecular weight from 250 Da to 15,000,000 Da. In embodiments, the oxidized polyisobutene has a number average molecular weight from 250 Da to 10,000,000 Da. In embodiments, the oxidized polyisobutene has a number average molecular weight from 250 Da to 5,000,000 Da. In embodiments, the oxidized polyisobutene has a number average molecular weight from 250 Da to 2,000,000 Da. In embodiments, the oxidized polyisobutene has a number average molecular weight from 250 Da to 1,000,000 Da. In embodiments, the oxidized polyisobutene has a number average molecular weight from 250 Da to 500,000 Da. In embodiments, the oxidized polyisobutene has a number average molecular weight from 250 Da to 200,000 Da. In embodiments, the oxidized polyisobutene has a number average molecular weight from 250 Da to 100,000 Da. In embodiments, the oxidized polyisobutene has a number average molecular weight from 250 Da to 50,000 Da. In embodiments, the oxidized polyisobutene has a number average molecular weight from 250 Da to 20,000 Da. In embodiments, the oxidized polyisobutene has a number average molecular weight from 250 Da to 10,000 Da. In embodiments, the oxidized polyisobutene has a number average molecular weight from 250 Da to 5000 Da. In embodiments, the oxidized polyisobutene has a number average molecular weight from 250 Da to 2000 Da. In embodiments, the oxidized polyisobutene has a number average molecular weight from 250 Da to 1000 Da. In embodiments, the oxidized polyisobutene has a number average molecular weight from 500 Da to 20,000,000 Da. In embodiments, the oxidized polyisobutene has a number average molecular weight from 500 Da to 15,000,000 Da. In embodiments, the oxidized polyisobutene has a number average molecular weight from 500 Da to 10,000,000 Da. In embodiments, the oxidized polyisobutene has a number average molecular weight from 500 Da to 5,000,000 Da. In embodiments, the oxidized polyisobutene has a number average molecular weight from 500 Da to 2,000,000 Da. In embodiments, the oxidized polyisobutene has a number average molecular weight from 500 Da to 1,000,000 Da. In embodiments, the oxidized polyisobutene has a number average molecular weight from 500 Da to 500,000 Da. In embodiments, the oxidized polyisobutene has a number average molecular weight from 500 Da to 200,000 Da. In embodiments, the oxidized polyisobutene has a number average molecular weight from 500 Da to 100,000 Da. In embodiments, the oxidized polyisobutene has a number average molecular weight from 500 Da to 50,000 Da. In embodiments, the oxidized polyisobutene has a number average molecular weight from 500 Da to 20,000 Da. In embodiments, the oxidized polyisobutene has a number average molecular weight from 500 Da to 10,000 Da. In embodiments, the oxidized polyisobutene has a number average molecular weight from 500 Da to 5000 Da. In embodiments, the oxidized polyisobutene has a number average molecular weight from 500 Da to 2000 Da. In embodiments, the oxidized polyisobutene has a number average molecular weight from 500 Da to 1000 Da. In embodiments, the oxidized polyisobutene has a number average molecular weight from 750 Da to 20,000,000 Da. In embodiments, the oxidized polyisobutene has a number average molecular weight from 750 Da to 15,000,000 Da. In embodiments, the oxidized polyisobutene has a number average molecular weight from 750 Da to 10,000,000 Da. In embodiments, the oxidized polyisobutene has a number average molecular weight from 750 Da to 5,000,000 Da. In embodiments, the oxidized polyisobutene has a number average molecular weight from 750 Da to 2,000,000 Da. In embodiments, the oxidized polyisobutene has a number average molecular weight from 750 Da to 1,000,000 Da. In embodiments, the oxidized polyisobutene has a number average molecular weight from 750 Da to 500,000 Da. In embodiments, the oxidized polyisobutene has a number average molecular weight from 750 Da to 200,000 Da. In embodiments, the oxidized polyisobutene has a number average molecular weight from 750 Da to 100,000 Da. In embodiments, the oxidized polyisobutene has a number average molecular weight from 750 Da to 50,000 Da. In embodiments, the oxidized polyisobutene has a number average molecular weight from 750 Da to 20,000 Da. In embodiments, the oxidized polyisobutene has a number average molecular weight from 750 Da to 10,000 Da. In embodiments, the oxidized polyisobutene has a number average molecular weight from 750 Da to 5000 Da. In embodiments, the oxidized polyisobutene has a number average molecular weight from 750 Da to 2000 Da. In embodiments, the oxidized polyisobutene has a number average molecular weight from 750 Da to 1000 Da. In embodiments, the oxidized polyisobutene has a number average molecular weight from 1000 Da to 20,000,000 Da. In embodiments, the oxidized polyisobutene has a number average molecular weight from 1000 Da to 15,000,000 Da. In embodiments, the oxidized polyisobutene has a number average molecular weight from 1000 Da to 10,000,000 Da. In embodiments, the oxidized polyisobutene has a number average molecular weight from 1000 Da to 5,000,000 Da. In embodiments, the oxidized polyisobutene has a number average molecular weight from 1000 Da to 2,000,000 Da. In embodiments, the oxidized polyisobutene has a number average molecular weight from 1000 Da to 1,000,000 Da. In embodiments, the oxidized polyisobutene has a number average molecular weight from 1000 Da to 500,000 Da. In embodiments, the oxidized polyisobutene has a number average molecular weight from 1000 Da to 200,000 Da. In embodiments, the oxidized polyisobutene has a number average molecular weight from 1000 Da to 100,000 Da. In embodiments, the oxidized polyisobutene has a number average molecular weight from 1000 Da to 50,000 Da. In embodiments, the oxidized polyisobutene has a number average molecular weight from 1000 Da to 20,000 Da. In embodiments, the oxidized polyisobutene has a number average molecular weight from 1000 Da to 10,000 Da. In embodiments, the oxidized polyisobutene has a number average molecular weight from 1000 Da to 5000 Da. In embodiments, the oxidized polyisobutene has a number average molecular weight from 1000 Da to 2000 Da.

In embodiments, the oxidized polyisobutene has a number average molecular weight from about 250 Da to about 20,000,000 Da. In embodiments, the oxidized polyisobutene has a number average molecular weight from about 250 Da to about 15,000,000 Da. In embodiments, the oxidized polyisobutene has a number average molecular weight from about 250 Da to about 10,000,000 Da. In embodiments, the oxidized polyisobutene has a number average molecular weight from about 250 Da to about 5,000,000 Da. In embodiments, the oxidized polyisobutene has a number average molecular weight from about 250 Da to about 2,000,000 Da. In embodiments, the oxidized polyisobutene has a number average molecular weight from about 250 Da to about 1,000,000 Da. In embodiments, the oxidized polyisobutene has a number average molecular weight from about 250 Da to about 500,000 Da. In embodiments, the oxidized polyisobutene has a number average molecular weight from about 250 Da to about 200,000 Da. In embodiments, the oxidized polyisobutene has a number average molecular weight from about 250 Da to about 100,000 Da. In embodiments, the oxidized polyisobutene has a number average molecular weight from about 250 Da to about 50,000 Da. In embodiments, the oxidized polyisobutene has a number average molecular weight from about 250 Da to about 20,000 Da. In embodiments, the oxidized polyisobutene has a number average molecular weight from about 250 Da to about 10,000 Da. In embodiments, the oxidized polyisobutene has a number average molecular weight from about 250 Da to about 5000 Da. In embodiments, the oxidized polyisobutene has a number average molecular weight from about 250 Da to about 2000 Da. In embodiments, the oxidized polyisobutene has a number average molecular weight from about 250 Da to about 1000 Da. In embodiments, the oxidized polyisobutene has a number average molecular weight from about 500 Da to about 20,000,000 Da. In embodiments, the oxidized polyisobutene has a number average molecular weight from about 500 Da to about 15,000,000 Da. In embodiments, the oxidized polyisobutene has a number average molecular weight from about 500 Da to about 10,000,000 Da. In embodiments, the oxidized polyisobutene has a number average molecular weight from about 500 Da to about 5,000,000 Da. In embodiments, the oxidized polyisobutene has a number average molecular weight from about 500 Da to about 2,000,000 Da. In embodiments, the oxidized polyisobutene has a number average molecular weight from about 500 Da to about 1,000,000 Da. In embodiments, the oxidized polyisobutene has a number average molecular weight from about 500 Da to about 500,000 Da. In embodiments, the oxidized polyisobutene has a number average molecular weight from about 500 Da to about 200,000 Da. In embodiments, the oxidized polyisobutene has a number average molecular weight from about 500 Da to about 100,000 Da. In embodiments, the oxidized polyisobutene has a number average molecular weight from about 500 Da to about 50,000 Da. In embodiments, the oxidized polyisobutene has a number average molecular weight from about 500 Da to about 20,000 Da. In embodiments, the oxidized polyisobutene has a number average molecular weight from about 500 Da to about 10,000 Da. In embodiments, the oxidized polyisobutene has a number average molecular weight from about 500 Da to about 5000 Da. In embodiments, the oxidized polyisobutene has a number average molecular weight from about 500 Da to about 2000 Da. In embodiments, the oxidized polyisobutene has a number average molecular weight from about 500 Da to about 1000 Da. In embodiments, the oxidized polyisobutene has a number average molecular weight from about 750 Da to about 20,000,000 Da. In embodiments, the oxidized polyisobutene has a number average molecular weight from about 750 Da to about 15,000,000 Da. In embodiments, the oxidized polyisobutene has a number average molecular weight from about 750 Da to about 10,000,000 Da. In embodiments, the oxidized polyisobutene has a number average molecular weight from about 750 Da to about 5,000,000 Da. In embodiments, the oxidized polyisobutene has a number average molecular weight from about 750 Da to about 2,000,000 Da. In embodiments, the oxidized polyisobutene has a number average molecular weight from about 750 Da to about 1,000,000 Da. In embodiments, the oxidized polyisobutene has a number average molecular weight from about 750 Da to about 500,000 Da. In embodiments, the oxidized polyisobutene has a number average molecular weight from about 750 Da to about 200,000 Da. In embodiments, the oxidized polyisobutene has a number average molecular weight from about 750 Da to about 100,000 Da. In embodiments, the oxidized polyisobutene has a number average molecular weight from about 750 Da to about 50,000 Da. In embodiments, the oxidized polyisobutene has a number average molecular weight from about 750 Da to about 20,000 Da. In embodiments, the oxidized polyisobutene has a number average molecular weight from about 750 Da to about 10,000 Da. In embodiments, the oxidized polyisobutene has a number average molecular weight from about 750 Da to about 5000 Da. In embodiments, the oxidized polyisobutene has a number average molecular weight from about 750 Da to about 2000 Da. In embodiments, the oxidized polyisobutene has a number average molecular weight from about 750 Da to about 1000 Da. In embodiments, the oxidized polyisobutene has a number average molecular weight from about 1000 Da to about 20,000,000 Da. In embodiments, the oxidized polyisobutene has a number average molecular weight from about 1000 Da to about 15,000,000 Da. In embodiments, the oxidized polyisobutene has a number average molecular weight from about 1000 Da to about 10,000,000 Da. In embodiments, the oxidized polyisobutene has a number average molecular weight from about 1000 Da to about 5,000,000 Da. In embodiments, the oxidized polyisobutene has a number average molecular weight from about 1000 Da to about 2,000,000 Da. In embodiments, the oxidized polyisobutene has a number average molecular weight from about 1000 Da to about 1,000,000 Da. In embodiments, the oxidized polyisobutene has a number average molecular weight from about 1000 Da to about 500,000 Da. In embodiments, the oxidized polyisobutene has a number average molecular weight from about 1000 Da to about 200,000 Da. In embodiments, the oxidized polyisobutene has a number average molecular weight from about 1000 Da to about 100,000 Da. In embodiments, the oxidized polyisobutene has a number average molecular weight from about 1000 Da to about 50,000 Da. In embodiments, the oxidized polyisobutene has a number average molecular weight from about 1000 Da to about 20,000 Da. In embodiments, the oxidized polyisobutene has a number average molecular weight from about 1000 Da to about 10,000 Da. In embodiments, the oxidized polyisobutene has a number average molecular weight from about 1000 Da to about 5000 Da. In embodiments, the oxidized polyisobutene has a number average molecular weight from about 1000 Da to about 2000 Da.

In embodiments, the oxidized polyisobutene has from 5 to 300,000 number of total subunits. In embodiments, the oxidized polyisobutene has from 5 to 200,000 number of total subunits. In embodiments, the oxidized polyisobutene has from 5 to 150,000 number of total subunits. In embodiments, the oxidized polyisobutene has from 5 to 100,000 number of total subunits. In embodiments, the oxidized polyisobutene has from 5 to 50,000 number of total subunits. In embodiments, the oxidized polyisobutene has from 5 to 20,000 number of total subunits. In embodiments, the oxidized polyisobutene has from 5 to 10,000 number of total subunits. In embodiments, the oxidized polyisobutene has from 5 to 5000 number of total subunits. In embodiments, the oxidized polyisobutene has from 5 to 2000 number of total subunits. In embodiments, the oxidized polyisobutene has from 5 to 1000 number of total subunits. In embodiments, the oxidized polyisobutene has from 5 to 500 number of total subunits. In embodiments, the oxidized polyisobutene has from 5 to 200 number of total subunits. In embodiments, the oxidized polyisobutene has from 5 to 100 number of total subunits. In embodiments, the oxidized polyisobutene has from 5 to 50 number of total subunits. In embodiments, the oxidized polyisobutene has from 5 to 20 number of total subunits. In embodiments, the oxidized polyisobutene has from 10 to 300,000 number of total subunits. In embodiments, the oxidized polyisobutene has from 10 to 200,000 number of total subunits. In embodiments, the oxidized polyisobutene has from 10 to 150,000 number of total subunits. In embodiments, the oxidized polyisobutene has from 10 to 100,000 number of total subunits. In embodiments, the oxidized polyisobutene has from 10 to 50,000 number of total subunits. In embodiments, the oxidized polyisobutene has from 10 to 20,000 number of total subunits. In embodiments, the oxidized polyisobutene has from 10 to 10,000 number of total subunits. In embodiments, the oxidized polyisobutene has from 10 to 5000 number of total subunits. In embodiments, the oxidized polyisobutene has from 10 to 2000 number of total subunits. In embodiments, the oxidized polyisobutene has from 10 to 1000 number of total subunits. In embodiments, the oxidized polyisobutene has from 10 to 500 number of total subunits. In embodiments, the oxidized polyisobutene has from 10 to 200 number of total subunits. In embodiments, the oxidized polyisobutene has from 10 to 100 number of total subunits. In embodiments, the oxidized polyisobutene has from 10 to 50 number of total subunits. In embodiments, the oxidized polyisobutene has from 10 to 20 number of total subunits. In embodiments, the oxidized polyisobutene has from 15 to 300,000 number of total subunits. In embodiments, the oxidized polyisobutene has from 15 to 200,000 number of total subunits. In embodiments, the oxidized polyisobutene has from 15 to 150,000 number of total subunits. In embodiments, the oxidized polyisobutene has from 15 to 100,000 number of total subunits. In embodiments, the oxidized polyisobutene has from 15 to 50,000 number of total subunits. In embodiments, the oxidized polyisobutene has from 15 to 20,000 number of total subunits. In embodiments, the oxidized polyisobutene has from 15 to 10,000 number of total subunits. In embodiments, the oxidized polyisobutene has from 15 to 5000 number of total subunits. In embodiments, the oxidized polyisobutene has from 15 to 2000 number of total subunits. In embodiments, the oxidized polyisobutene has from 15 to 1000 number of total subunits. In embodiments, the oxidized polyisobutene has from 15 to 500 number of total subunits. In embodiments, the oxidized polyisobutene has from 15 to 200 number of total subunits. In embodiments, the oxidized polyisobutene has from 15 to 100 number of total subunits. In embodiments, the oxidized polyisobutene has from 15 to 50 number of total subunits. In embodiments, the oxidized polyisobutene has from 15 to 20 number of total subunits. In embodiments, the oxidized polyisobutene has from 20 to 300,000 number of total subunits. In embodiments, the oxidized polyisobutene has from 20 to 200,000 number of total subunits. In embodiments, the oxidized polyisobutene has from 20 to 150,000 number of total subunits. In embodiments, the oxidized polyisobutene has from 20 to 100,000 number of total subunits. In embodiments, the oxidized polyisobutene has from 20 to 50,000 number of total subunits. In embodiments, the oxidized polyisobutene has from 20 to 20,000 number of total subunits. In embodiments, the oxidized polyisobutene has from 20 to 10,000 number of total subunits. In embodiments, the oxidized polyisobutene has from 20 to 5000 number of total subunits. In embodiments, the oxidized polyisobutene has from 20 to 2000 number of total subunits. In embodiments, the oxidized polyisobutene has from 20 to 1000 number of total subunits. In embodiments, the oxidized polyisobutene has from 20 to 500 number of total subunits. In embodiments, the oxidized polyisobutene has from 20 to 200 number of total subunits. In embodiments, the oxidized polyisobutene has from 20 to 100 number of total subunits. In embodiments, the oxidized polyisobutene has from 20 to 50 number of total subunits.

In embodiments, the oxidized polyisobutene has from about 5 to about 300,000 number of total subunits. In embodiments, the oxidized polyisobutene has from about 5 to about 200,000 number of total subunits. In embodiments, the oxidized polyisobutene has from about 5 to about 150,000 number of total subunits. In embodiments, the oxidized polyisobutene has from about 5 to about 100,000 number of total subunits. In embodiments, the oxidized polyisobutene has from about 5 to about 50,000 number of total subunits. In embodiments, the oxidized polyisobutene has from about 5 to about 20,000 number of total subunits. In embodiments, the oxidized polyisobutene has from about 5 to about 10,000 number of total subunits. In embodiments, the oxidized polyisobutene has from about 5 to about 5000 number of total subunits. In embodiments, the oxidized polyisobutene has from about 5 to about 2000 number of total subunits. In embodiments, the oxidized polyisobutene has from about 5 to about 1000 number of total subunits. In embodiments, the oxidized polyisobutene has from about 5 to about 500 number of total subunits. In embodiments, the oxidized polyisobutene has from about 5 to about 200 number of total subunits. In embodiments, the oxidized polyisobutene has from about 5 to about 100 number of total subunits. In embodiments, the oxidized polyisobutene has from about 5 to about 50 number of total subunits. In embodiments, the oxidized polyisobutene has from about 5 to about 20 number of total subunits. In embodiments, the oxidized polyisobutene has from about 10 to about 300,000 number of total subunits. In embodiments, the oxidized polyisobutene has from about 10 to about 200,000 number of total subunits. In embodiments, the oxidized polyisobutene has from about 10 to about 150,000 number of total subunits. In embodiments, the oxidized polyisobutene has from about 10 to about 100,000 number of total subunits. In embodiments, the oxidized polyisobutene has from about 10 to about 50,000 number of total subunits. In embodiments, the oxidized polyisobutene has from about 10 to about 20,000 number of total subunits. In embodiments, the oxidized polyisobutene has from about 10 to about 10,000 number of total subunits. In embodiments, the oxidized polyisobutene has from about 10 to about 5000 number of total subunits. In embodiments, the oxidized polyisobutene has from about 10 to about 2000 number of total subunits. In embodiments, the oxidized polyisobutene has from about 10 to about 1000 number of total subunits. In embodiments, the oxidized polyisobutene has from about 10 to about 500 number of total subunits. In embodiments, the oxidized polyisobutene has from about 10 to about 200 number of total subunits. In embodiments, the oxidized polyisobutene has from about 10 to about 100 number of total subunits. In embodiments, the oxidized polyisobutene has from about 10 to about 50 number of total subunits. In embodiments, the oxidized polyisobutene has from about 10 to about 20 number of total subunits. In embodiments, the oxidized polyisobutene has from about 15 to about 300,000 number of total subunits. In embodiments, the oxidized polyisobutene has from about 15 to about 200,000 number of total subunits. In embodiments, the oxidized polyisobutene has from about 15 to about 150,000 number of total subunits. In embodiments, the oxidized polyisobutene has from about 15 to about 100,000 number of total subunits. In embodiments, the oxidized polyisobutene has from about 15 to about 50,000 number of total subunits. In embodiments, the oxidized polyisobutene has from about 15 to about 20,000 number of total subunits. In embodiments, the oxidized polyisobutene has from about 15 to about 10,000 number of total subunits. In embodiments, the oxidized polyisobutene has from about 15 to about 5000 number of total subunits. In embodiments, the oxidized polyisobutene has from about 15 to about 2000 number of total subunits. In embodiments, the oxidized polyisobutene has from about 15 to about 1000 number of total subunits. In embodiments, the oxidized polyisobutene has from about 15 to about 500 number of total subunits. In embodiments, the oxidized polyisobutene has from about 15 to about 200 number of total subunits. In embodiments, the oxidized polyisobutene has from about 15 to about 100 number of total subunits. In embodiments, the oxidized polyisobutene has from about 15 to about 50 number of total subunits. In embodiments, the oxidized polyisobutene has from about 15 to about 20 number of total subunits. In embodiments, the oxidized polyisobutene has from about 20 to about 300,000 number of total subunits. In embodiments, the oxidized polyisobutene has from about 20 to about 200,000 number of total subunits. In embodiments, the oxidized polyisobutene has from about 20 to about 150,000 number of total subunits. In embodiments, the oxidized polyisobutene has from about 20 to about 100,000 number of total subunits. In embodiments, the oxidized polyisobutene has from about 20 to about 50,000 number of total subunits. In embodiments, the oxidized polyisobutene has from about 20 to about 20,000 number of total subunits. In embodiments, the oxidized polyisobutene has from about 20 to about 10,000 number of total subunits. In embodiments, the oxidized polyisobutene has from about 20 to about 5000 number of total subunits. In embodiments, the oxidized polyisobutene has from about 20 to about 2000 number of total subunits. In embodiments, the oxidized polyisobutene has from about 20 to about 1000 number of total subunits. In embodiments, the oxidized polyisobutene has from about 20 to about 500 number of total subunits. In embodiments, the oxidized polyisobutene has from about 20 to about 200 number of total subunits. In embodiments, the oxidized polyisobutene has from about 20 to about 100 number of total subunits. In embodiments, the oxidized polyisobutene has from about 20 to about 50 number of total subunits.

In an aspect is provided a hydroxylated polyisobutene, including a second oxidized subunit and a non-oxidized subunit. The second oxidized subunit and the non-oxidized subunit are as described herein, including in embodiments. The hydroxylated polyisobutene has a number average molecular weight from 250 Da to 20,000,000 Da.

In embodiments, the hydroxylated polyisobutene consists of only the second oxidized subunit and the non-oxidized subunit.

In embodiments, the ratio of the second oxidized subunit to the non-oxidized subunit in the hydroxylated polyisobutene is from 1:10,000 to 1:5. In embodiments, the ratio of the second oxidized subunit to the non-oxidized subunit in the hydroxylated polyisobutene is from 1:8000 to 1:5. In embodiments, the ratio of the second oxidized subunit to the non-oxidized subunit in the hydroxylated polyisobutene is from 1:6000 to 1:5. In embodiments, the ratio of the second oxidized subunit to the non-oxidized subunit in the hydroxylated polyisobutene is from 1:4000 to 1:5. In embodiments, the ratio of the second oxidized subunit to the non-oxidized subunit in the hydroxylated polyisobutene is from 1:2000 to 1:5. In embodiments, the ratio of the second oxidized subunit to the non-oxidized subunit in the hydroxylated polyisobutene is from 1:1000 to 1:5. In embodiments, the ratio of the second oxidized subunit to the non-oxidized subunit in the hydroxylated polyisobutene is from 1:800 to 1:5. In embodiments, the ratio of the second oxidized subunit to the non-oxidized subunit in the hydroxylated polyisobutene is from 1:600 to 1:5. In embodiments, the ratio of the second oxidized subunit to the non-oxidized subunit in the hydroxylated polyisobutene is from 1:400 to 1:5. In embodiments, the ratio of the second oxidized subunit to the non-oxidized subunit in the hydroxylated polyisobutene is from 1:200 to 1:5. In embodiments, the ratio of the second oxidized subunit to the non-oxidized subunit in the hydroxylated polyisobutene is from 1:100 to 1:5. In embodiments, the ratio of the second oxidized subunit to the non-oxidized subunit in the hydroxylated polyisobutene is from 1:50 to 1:5. In embodiments, the ratio of the second oxidized subunit to the non-oxidized subunit in the hydroxylated polyisobutene is from 1:10,000 to 1:10. In embodiments, the ratio of the second oxidized subunit to the non-oxidized subunit in the hydroxylated polyisobutene is from 1:8000 to 1:10. In embodiments, the ratio of the second oxidized subunit to the non-oxidized subunit in the hydroxylated polyisobutene is from 1:6000 to 1:10. In embodiments, the ratio of the second oxidized subunit to the non-oxidized subunit in the hydroxylated polyisobutene is from 1:4000 to 1:10. In embodiments, the ratio of the second oxidized subunit to the non-oxidized subunit in the hydroxylated polyisobutene is from 1:2000 to 1:10. In embodiments, the ratio of the second oxidized subunit to the non-oxidized subunit in the hydroxylated polyisobutene is from 1:1000 to 1:10. In embodiments, the ratio of the second oxidized subunit to the non-oxidized subunit in the hydroxylated polyisobutene is from 1:800 to 1:10. In embodiments, the ratio of the second oxidized subunit to the non-oxidized subunit in the hydroxylated polyisobutene is from 1:600 to 1:10. In embodiments, the ratio of the second oxidized subunit to the non-oxidized subunit in the hydroxylated polyisobutene is from 1:400 to 1:10. In embodiments, the ratio of the second oxidized subunit to the non-oxidized subunit in the hydroxylated polyisobutene is from 1:200 to 1:10. In embodiments, the ratio of the second oxidized subunit to the non-oxidized subunit in the hydroxylated polyisobutene is from 1:100 to 1:10. In embodiments, the ratio of the second oxidized subunit to the non-oxidized subunit in the hydroxylated polyisobutene is from 1:50 to 1:10.

In embodiments, the ratio of the second oxidized subunit to the non-oxidized subunit in the hydroxylated polyisobutene is from about 1:10,000 to about 1:5. In embodiments, the ratio of the second oxidized subunit to the non-oxidized subunit in the hydroxylated polyisobutene is from about 1:8000 to about 1:5. In embodiments, the ratio of the second oxidized subunit to the non-oxidized subunit in the hydroxylated polyisobutene is from about 1:6000 to about 1:5. In embodiments, the ratio of the second oxidized subunit to the non-oxidized subunit in the hydroxylated polyisobutene is from about 1:4000 to about 1:5. In embodiments, the ratio of the second oxidized subunit to the non-oxidized subunit in the hydroxylated polyisobutene is from about 1:2000 to about 1:5. In embodiments, the ratio of the second oxidized subunit to the non-oxidized subunit in the hydroxylated polyisobutene is from about 1:1000 to about 1:5. In embodiments, the ratio of the second oxidized subunit to the non-oxidized subunit in the hydroxylated polyisobutene is from about 1:800 to about 1:5. In embodiments, the ratio of the second oxidized subunit to the non-oxidized subunit in the hydroxylated polyisobutene is from about 1:600 to about 1:5. In embodiments, the ratio of the second oxidized subunit to the non-oxidized subunit in the hydroxylated polyisobutene is from about 1:400 to about 1:5. In embodiments, the ratio of the second oxidized subunit to the non-oxidized subunit in the hydroxylated polyisobutene is from about 1:200 to about 1:5. In embodiments, the ratio of the second oxidized subunit to the non-oxidized subunit in the hydroxylated polyisobutene is from about 1:100 to about 1:5. In embodiments, the ratio of the second oxidized subunit to the non-oxidized subunit in the hydroxylated polyisobutene is from about 1:50 to about 1:5. In embodiments, the ratio of the second oxidized subunit to the non-oxidized subunit in the hydroxylated polyisobutene is from about 1:10,000 to about 1:10. In embodiments, the ratio of the second oxidized subunit to the non-oxidized subunit in the hydroxylated polyisobutene is from about 1:8000 to about 1:10. In embodiments, the ratio of the second oxidized subunit to the non-oxidized subunit in the hydroxylated polyisobutene is from about 1:6000 to about 1:10. In embodiments, the ratio of the second oxidized subunit to the non-oxidized subunit in the hydroxylated polyisobutene is from about 1:4000 to about 1:10. In embodiments, the ratio of the second oxidized subunit to the non-oxidized subunit in the hydroxylated polyisobutene is from about 1:2000 to about 1:10. In embodiments, the ratio of the second oxidized subunit to the non-oxidized subunit in the hydroxylated polyisobutene is from about 1:1000 to about 1:10. In embodiments, the ratio of the second oxidized subunit to the non-oxidized subunit in the hydroxylated polyisobutene is from about 1:800 to about 1:10. In embodiments, the ratio of the second oxidized subunit to the non-oxidized subunit in the hydroxylated polyisobutene is from about 1:600 to about 1:10. In embodiments, the ratio of the second oxidized subunit to the non-oxidized subunit in the hydroxylated polyisobutene is from about 1:400 to about 1:10. In embodiments, the ratio of the second oxidized subunit to the non-oxidized subunit in the hydroxylated polyisobutene is from about 1:200 to about 1:10. In embodiments, the ratio of the second oxidized subunit to the non-oxidized subunit in the hydroxylated polyisobutene is from about 1:100 to about 1:10. In embodiments, the ratio of the second oxidized subunit to the non-oxidized subunit in the hydroxylated polyisobutene is from about 1:50 to about 1:10.

In embodiments, the hydroxylated polyisobutene has a number average molecular weight from 250 Da to 15,000,000 Da. In embodiments, the hydroxylated polyisobutene has a number average molecular weight from 250 Da to 10,000,000 Da. In embodiments, the hydroxylated polyisobutene has a number average molecular weight from 250 Da to 5,000,000 Da. In embodiments, the hydroxylated polyisobutene has a number average molecular weight from 250 Da to 2,000,000 Da. In embodiments, the hydroxylated polyisobutene has a number average molecular weight from 250 Da to 1,000,000 Da. In embodiments, the hydroxylated polyisobutene has a number average molecular weight from 250 Da to 500,000 Da. In embodiments, the hydroxylated polyisobutene has a number average molecular weight from 250 Da to 200,000 Da. In embodiments, the hydroxylated polyisobutene has a number average molecular weight from 250 Da to 100,000 Da. In embodiments, the hydroxylated polyisobutene has a number average molecular weight from 250 Da to 50,000 Da. In embodiments, the hydroxylated polyisobutene has a number average molecular weight from 250 Da to 20,000 Da. In embodiments, the hydroxylated polyisobutene has a number average molecular weight from 250 Da to 10,000 Da. In embodiments, the hydroxylated polyisobutene has a number average molecular weight from 250 Da to 5000 Da. In embodiments, the hydroxylated polyisobutene has a number average molecular weight from 250 Da to 2000 Da. In embodiments, the hydroxylated polyisobutene has a number average molecular weight from 250 Da to 1000 Da. In embodiments, the hydroxylated polyisobutene has a number average molecular weight from 500 Da to 20,000,000 Da. In embodiments, the hydroxylated polyisobutene has a number average molecular weight from 500 Da to 15,000,000 Da. In embodiments, the hydroxylated polyisobutene has a number average molecular weight from 500 Da to 10,000,000 Da. In embodiments, the hydroxylated polyisobutene has a number average molecular weight from 500 Da to 5,000,000 Da. In embodiments, the hydroxylated polyisobutene has a number average molecular weight from 500 Da to 2,000,000 Da. In embodiments, the hydroxylated polyisobutene has a number average molecular weight from 500 Da to 1,000,000 Da. In embodiments, the hydroxylated polyisobutene has a number average molecular weight from 500 Da to 500,000 Da. In embodiments, the hydroxylated polyisobutene has a number average molecular weight from 500 Da to 200,000 Da. In embodiments, the hydroxylated polyisobutene has a number average molecular weight from 500 Da to 100,000 Da. In embodiments, the hydroxylated polyisobutene has a number average molecular weight from 500 Da to 50,000 Da. In embodiments, the hydroxylated polyisobutene has a number average molecular weight from 500 Da to 20,000 Da. In embodiments, the hydroxylated polyisobutene has a number average molecular weight from 500 Da to 10,000 Da. In embodiments, the hydroxylated polyisobutene has a number average molecular weight from 500 Da to 5000 Da. In embodiments, the hydroxylated polyisobutene has a number average molecular weight from 500 Da to 2000 Da. In embodiments, the hydroxylated polyisobutene has a number average molecular weight from 500 Da to 1000 Da. In embodiments, the hydroxylated polyisobutene has a number average molecular weight from 750 Da to 20,000,000 Da. In embodiments, the hydroxylated polyisobutene has a number average molecular weight from 750 Da to 15,000,000 Da. In embodiments, the hydroxylated polyisobutene has a number average molecular weight from 750 Da to 10,000,000 Da. In embodiments, the hydroxylated polyisobutene has a number average molecular weight from 750 Da to 5,000,000 Da. In embodiments, the hydroxylated polyisobutene has a number average molecular weight from 750 Da to 2,000,000 Da. In embodiments, the hydroxylated polyisobutene has a number average molecular weight from 750 Da to 1,000,000 Da. In embodiments, the hydroxylated polyisobutene has a number average molecular weight from 750 Da to 500,000 Da. In embodiments, the hydroxylated polyisobutene has a number average molecular weight from 750 Da to 200,000 Da. In embodiments, the hydroxylated polyisobutene has a number average molecular weight from 750 Da to 100,000 Da. In embodiments, the hydroxylated polyisobutene has a number average molecular weight from 750 Da to 50,000 Da. In embodiments, the hydroxylated polyisobutene has a number average molecular weight from 750 Da to 20,000 Da. In embodiments, the hydroxylated polyisobutene has a number average molecular weight from 750 Da to 10,000 Da. In embodiments, the hydroxylated polyisobutene has a number average molecular weight from 750 Da to 5000 Da. In embodiments, the hydroxylated polyisobutene has a number average molecular weight from 750 Da to 2000 Da. In embodiments, the hydroxylated polyisobutene has a number average molecular weight from 750 Da to 1000 Da. In embodiments, the hydroxylated polyisobutene has a number average molecular weight from 1000 Da to 20,000,000 Da. In embodiments, the hydroxylated polyisobutene has a number average molecular weight from 1000 Da to 15,000,000 Da. In embodiments, the hydroxylated polyisobutene has a number average molecular weight from 1000 Da to 10,000,000 Da. In embodiments, the hydroxylated polyisobutene has a number average molecular weight from 1000 Da to 5,000,000 Da. In embodiments, the hydroxylated polyisobutene has a number average molecular weight from 1000 Da to 2,000,000 Da. In embodiments, the hydroxylated polyisobutene has a number average molecular weight from 1000 Da to 1,000,000 Da. In embodiments, the hydroxylated polyisobutene has a number average molecular weight from 1000 Da to 500,000 Da. In embodiments, the hydroxylated polyisobutene has a number average molecular weight from 1000 Da to 200,000 Da. In embodiments, the hydroxylated polyisobutene has a number average molecular weight from 1000 Da to 100,000 Da. In embodiments, the hydroxylated polyisobutene has a number average molecular weight from 1000 Da to 50,000 Da. In embodiments, the hydroxylated polyisobutene has a number average molecular weight from 1000 Da to 20,000 Da. In embodiments, the hydroxylated polyisobutene has a number average molecular weight from 1000 Da to 10,000 Da. In embodiments, the hydroxylated polyisobutene has a number average molecular weight from 1000 Da to 5000 Da. In embodiments, the hydroxylated polyisobutene has a number average molecular weight from 1000 Da to 2000 Da.

In embodiments, the hydroxylated polyisobutene has a number average molecular weight from about 250 Da to about 20,000,000 Da. In embodiments, the hydroxylated polyisobutene has a number average molecular weight from about 250 Da to about 15,000,000 Da. In embodiments, the hydroxylated polyisobutene has a number average molecular weight from about 250 Da to about 10,000,000 Da. In embodiments, the hydroxylated polyisobutene has a number average molecular weight from about 250 Da to about 5,000,000 Da. In embodiments, the hydroxylated polyisobutene has a number average molecular weight from about 250 Da to about 2,000,000 Da. In embodiments, the hydroxylated polyisobutene has a number average molecular weight from about 250 Da to about 1,000,000 Da. In embodiments, the hydroxylated polyisobutene has a number average molecular weight from about 250 Da to about 500,000 Da. In embodiments, the hydroxylated polyisobutene has a number average molecular weight from about 250 Da to about 200,000 Da. In embodiments, the hydroxylated polyisobutene has a number average molecular weight from about 250 Da to about 100,000 Da. In embodiments, the hydroxylated polyisobutene has a number average molecular weight from about 250 Da to about 50,000 Da. In embodiments, the hydroxylated polyisobutene has a number average molecular weight from about 250 Da to about 20,000 Da. In embodiments, the hydroxylated polyisobutene has a number average molecular weight from about 250 Da to about 10,000 Da. In embodiments, the hydroxylated polyisobutene has a number average molecular weight from about 250 Da to about 5000 Da. In embodiments, the hydroxylated polyisobutene has a number average molecular weight from about 250 Da to about 2000 Da. In embodiments, the hydroxylated polyisobutene has a number average molecular weight from about 250 Da to about 1000 Da. In embodiments, the hydroxylated polyisobutene has a number average molecular weight from about 500 Da to about 20,000,000 Da. In embodiments, the hydroxylated polyisobutene has a number average molecular weight from about 500 Da to about 15,000,000 Da. In embodiments, the hydroxylated polyisobutene has a number average molecular weight from about 500 Da to about 10,000,000 Da. In embodiments, the hydroxylated polyisobutene has a number average molecular weight from about 500 Da to about 5,000,000 Da. In embodiments, the hydroxylated polyisobutene has a number average molecular weight from about 500 Da to about 2,000,000 Da. In embodiments, the hydroxylated polyisobutene has a number average molecular weight from about 500 Da to about 1,000,000 Da. In embodiments, the hydroxylated polyisobutene has a number average molecular weight from about 500 Da to about 500,000 Da. In embodiments, the hydroxylated polyisobutene has a number average molecular weight from about 500 Da to about 200,000 Da. In embodiments, the hydroxylated polyisobutene has a number average molecular weight from about 500 Da to about 100,000 Da. In embodiments, the hydroxylated polyisobutene has a number average molecular weight from about 500 Da to about 50,000 Da. In embodiments, the hydroxylated polyisobutene has a number average molecular weight from about 500 Da to about 20,000 Da. In embodiments, the hydroxylated polyisobutene has a number average molecular weight from about 500 Da to about 10,000 Da. In embodiments, the hydroxylated polyisobutene has a number average molecular weight from about 500 Da to about 5000 Da. In embodiments, the hydroxylated polyisobutene has a number average molecular weight from about 500 Da to about 2000 Da. In embodiments, the hydroxylated polyisobutene has a number average molecular weight from about 500 Da to about 1000 Da. In embodiments, the hydroxylated polyisobutene has a number average molecular weight from about 750 Da to about 20,000,000 Da. In embodiments, the hydroxylated polyisobutene has a number average molecular weight from about 750 Da to about 15,000,000 Da. In embodiments, the hydroxylated polyisobutene has a number average molecular weight from about 750 Da to about 10,000,000 Da. In embodiments, the hydroxylated polyisobutene has a number average molecular weight from about 750 Da to about 5,000,000 Da. In embodiments, the hydroxylated polyisobutene has a number average molecular weight from about 750 Da to about 2,000,000 Da. In embodiments, the hydroxylated polyisobutene has a number average molecular weight from about 750 Da to about 1,000,000 Da. In embodiments, the hydroxylated polyisobutene has a number average molecular weight from about 750 Da to about 500,000 Da. In embodiments, the hydroxylated polyisobutene has a number average molecular weight from about 750 Da to about 200,000 Da. In embodiments, the hydroxylated polyisobutene has a number average molecular weight from about 750 Da to about 100,000 Da. In embodiments, the hydroxylated polyisobutene has a number average molecular weight from about 750 Da to about 50,000 Da. In embodiments, the hydroxylated polyisobutene has a number average molecular weight from about 750 Da to about 20,000 Da. In embodiments, the hydroxylated polyisobutene has a number average molecular weight from about 750 Da to about 10,000 Da. In embodiments, the hydroxylated polyisobutene has a number average molecular weight from about 750 Da to about 5000 Da. In embodiments, the hydroxylated polyisobutene has a number average molecular weight from about 750 Da to about 2000 Da. In embodiments, the hydroxylated polyisobutene has a number average molecular weight from about 750 Da to about 1000 Da. In embodiments, the hydroxylated polyisobutene has a number average molecular weight from about 1000 Da to about 20,000,000 Da. In embodiments, the hydroxylated polyisobutene has a number average molecular weight from about 1000 Da to about 15,000,000 Da. In embodiments, the hydroxylated polyisobutene has a number average molecular weight from about 1000 Da to about 10,000,000 Da. In embodiments, the hydroxylated polyisobutene has a number average molecular weight from about 1000 Da to about 5,000,000 Da. In embodiments, the hydroxylated polyisobutene has a number average molecular weight from about 1000 Da to about 2,000,000 Da. In embodiments, the hydroxylated polyisobutene has a number average molecular weight from about 1000 Da to about 1,000,000 Da. In embodiments, the hydroxylated polyisobutene has a number average molecular weight from about 1000 Da to about 500,000 Da. In embodiments, the hydroxylated polyisobutene has a number average molecular weight from about 1000 Da to about 200,000 Da. In embodiments, the hydroxylated polyisobutene has a number average molecular weight from about 1000 Da to about 100,000 Da. In embodiments, the hydroxylated polyisobutene has a number average molecular weight from about 1000 Da to about 50,000 Da. In embodiments, the hydroxylated polyisobutene has a number average molecular weight from about 1000 Da to about 20,000 Da. In embodiments, the hydroxylated polyisobutene has a number average molecular weight from about 1000 Da to about 10,000 Da. In embodiments, the hydroxylated polyisobutene has a number average molecular weight from about 1000 Da to about 5000 Da. In embodiments, the hydroxylated polyisobutene has a number average molecular weight from about 1000 Da to about 2000 Da.

In embodiments, the hydroxylated polyisobutene has from 5 to 300,000 number of total subunits. In embodiments, the hydroxylated polyisobutene has from 5 to 200,000 number of total subunits. In embodiments, the hydroxylated polyisobutene has from 5 to 150,000 number of total subunits. In embodiments, the hydroxylated polyisobutene has from 5 to 100,000 number of total subunits. In embodiments, the hydroxylated polyisobutene has from 5 to 50,000 number of total subunits. In embodiments, the hydroxylated polyisobutene has from 5 to 20,000 number of total subunits. In embodiments, the hydroxylated polyisobutene has from 5 to 10,000 number of total subunits. In embodiments, the hydroxylated polyisobutene has from 5 to 5000 number of total subunits. In embodiments, the hydroxylated polyisobutene has from 5 to 2000 number of total subunits. In embodiments, the hydroxylated polyisobutene has from 5 to 1000 number of total subunits. In embodiments, the hydroxylated polyisobutene has from 5 to 500 number of total subunits. In embodiments, the hydroxylated polyisobutene has from 5 to 200 number of total subunits. In embodiments, the hydroxylated polyisobutene has from 5 to 100 number of total subunits. In embodiments, the hydroxylated polyisobutene has from 5 to 50 number of total subunits. In embodiments, the hydroxylated polyisobutene has from 5 to 20 number of total subunits. In embodiments, the hydroxylated polyisobutene has from 10 to 300,000 number of total subunits. In embodiments, the hydroxylated polyisobutene has from 10 to 200,000 number of total subunits. In embodiments, the hydroxylated polyisobutene has from 10 to 150,000 number of total subunits. In embodiments, the hydroxylated polyisobutene has from 10 to 100,000 number of total subunits. In embodiments, the hydroxylated polyisobutene has from 10 to 50,000 number of total subunits. In embodiments, the hydroxylated polyisobutene has from 10 to 20,000 number of total subunits. In embodiments, the hydroxylated polyisobutene has from 10 to 10,000 number of total subunits. In embodiments, the hydroxylated polyisobutene has from 10 to 5000 number of total subunits. In embodiments, the hydroxylated polyisobutene has from 10 to 2000 number of total subunits. In embodiments, the hydroxylated polyisobutene has from 10 to 1000 number of total subunits. In embodiments, the hydroxylated polyisobutene has from 10 to 500 number of total subunits. In embodiments, the hydroxylated polyisobutene has from 10 to 200 number of total subunits. In embodiments, the hydroxylated polyisobutene has from 10 to 100 number of total subunits. In embodiments, the hydroxylated polyisobutene has from 10 to 50 number of total subunits. In embodiments, the hydroxylated polyisobutene has from 10 to 20 number of total subunits. In embodiments, the hydroxylated polyisobutene has from 15 to 300,000 number of total subunits. In embodiments, the hydroxylated polyisobutene has from 15 to 200,000 number of total subunits. In embodiments, the hydroxylated polyisobutene has from 15 to 150,000 number of total subunits. In embodiments, the hydroxylated polyisobutene has from 15 to 100,000 number of total subunits. In embodiments, the hydroxylated polyisobutene has from 15 to 50,000 number of total subunits. In embodiments, the hydroxylated polyisobutene has from 15 to 20,000 number of total subunits. In embodiments, the hydroxylated polyisobutene has from 15 to 10,000 number of total subunits. In embodiments, the hydroxylated polyisobutene has from 15 to 5000 number of total subunits. In embodiments, the hydroxylated polyisobutene has from 15 to 2000 number of total subunits. In embodiments, the hydroxylated polyisobutene has from 15 to 1000 number of total subunits. In embodiments, the hydroxylated polyisobutene has from 15 to 500 number of total subunits. In embodiments, the hydroxylated polyisobutene has from 15 to 200 number of total subunits. In embodiments, the hydroxylated polyisobutene has from 15 to 100 number of total subunits. In embodiments, the hydroxylated polyisobutene has from 15 to 50 number of total subunits. In embodiments, the hydroxylated polyisobutene has from 15 to 20 number of total subunits. In embodiments, the hydroxylated polyisobutene has from 20 to 300,000 number of total subunits. In embodiments, the hydroxylated polyisobutene has from 20 to 200,000 number of total subunits. In embodiments, the hydroxylated polyisobutene has from 20 to 150,000 number of total subunits. In embodiments, the hydroxylated polyisobutene has from 20 to 100,000 number of total subunits. In embodiments, the hydroxylated polyisobutene has from 20 to 50,000 number of total subunits. In embodiments, the hydroxylated polyisobutene has from 20 to 20,000 number of total subunits. In embodiments, the hydroxylated polyisobutene has from 20 to 10,000 number of total subunits. In embodiments, the hydroxylated polyisobutene has from 20 to 5000 number of total subunits. In embodiments, the hydroxylated polyisobutene has from 20 to 2000 number of total subunits. In embodiments, the hydroxylated polyisobutene has from 20 to 1000 number of total subunits. In embodiments, the hydroxylated polyisobutene has from 20 to 500 number of total subunits. In embodiments, the hydroxylated polyisobutene has from 20 to 200 number of total subunits. In embodiments, the hydroxylated polyisobutene has from 20 to 100 number of total subunits. In embodiments, the hydroxylated polyisobutene has from 20 to 50 number of total subunits.

In embodiments, the hydroxylated polyisobutene has from about 5 to about 300,000 number of total subunits. In embodiments, the hydroxylated polyisobutene has from about 5 to about 200,000 number of total subunits. In embodiments, the hydroxylated polyisobutene has from about 5 to about 150,000 number of total subunits. In embodiments, the hydroxylated polyisobutene has from about 5 to about 100,000 number of total subunits. In embodiments, the hydroxylated polyisobutene has from about 5 to about 50,000 number of total subunits. In embodiments, the hydroxylated polyisobutene has from about 5 to about 20,000 number of total subunits. In embodiments, the hydroxylated polyisobutene has from about 5 to about 10,000 number of total subunits. In embodiments, the hydroxylated polyisobutene has from about 5 to about 5000 number of total subunits. In embodiments, the hydroxylated polyisobutene has from about 5 to about 2000 number of total subunits. In embodiments, the hydroxylated polyisobutene has from about 5 to about 1000 number of total subunits. In embodiments, the hydroxylated polyisobutene has from about 5 to about 500 number of total subunits. In embodiments, the hydroxylated polyisobutene has from about 5 to about 200 number of total subunits. In embodiments, the hydroxylated polyisobutene has from about 5 to about 100 number of total subunits. In embodiments, the hydroxylated polyisobutene has from about 5 to about 50 number of total subunits. In embodiments, the hydroxylated polyisobutene has from about 5 to about 20 number of total subunits. In embodiments, the hydroxylated polyisobutene has from about 10 to about 300,000 number of total subunits. In embodiments, the hydroxylated polyisobutene has from about 10 to about 200,000 number of total subunits. In embodiments, the hydroxylated polyisobutene has from about 10 to about 150,000 number of total subunits. In embodiments, the hydroxylated polyisobutene has from about 10 to about 100,000 number of total subunits. In embodiments, the hydroxylated polyisobutene has from about 10 to about 50,000 number of total subunits. In embodiments, the hydroxylated polyisobutene has from about 10 to about 20,000 number of total subunits. In embodiments, the hydroxylated polyisobutene has from about 10 to about 10,000 number of total subunits. In embodiments, the hydroxylated polyisobutene has from about 10 to about 5000 number of total subunits. In embodiments, the hydroxylated polyisobutene has from about 10 to about 2000 number of total subunits. In embodiments, the hydroxylated polyisobutene has from about 10 to about 1000 number of total subunits. In embodiments, the hydroxylated polyisobutene has from about 10 to about 500 number of total subunits. In embodiments, the hydroxylated polyisobutene has from about 10 to about 200 number of total subunits. In embodiments, the hydroxylated polyisobutene has from about 10 to about 100 number of total subunits. In embodiments, the hydroxylated polyisobutene has from about 10 to about 50 number of total subunits. In embodiments, the hydroxylated polyisobutene has from about 10 to about 20 number of total subunits. In embodiments, the hydroxylated polyisobutene has from about 15 to about 300,000 number of total subunits. In embodiments, the hydroxylated polyisobutene has from about 15 to about 200,000 number of total subunits. In embodiments, the hydroxylated polyisobutene has from about 15 to about 150,000 number of total subunits. In embodiments, the hydroxylated polyisobutene has from about 15 to about 100,000 number of total subunits. In embodiments, the hydroxylated polyisobutene has from about 15 to about 50,000 number of total subunits. In embodiments, the hydroxylated polyisobutene has from about 15 to about 20,000 number of total subunits. In embodiments, the hydroxylated polyisobutene has from about 15 to about 10,000 number of total subunits. In embodiments, the hydroxylated polyisobutene has from about 15 to about 5000 number of total subunits. In embodiments, the hydroxylated polyisobutene has from about 15 to about 2000 number of total subunits. In embodiments, the hydroxylated polyisobutene has from about 15 to about 1000 number of total subunits. In embodiments, the hydroxylated polyisobutene has from about 15 to about 500 number of total subunits. In embodiments, the hydroxylated polyisobutene has from about 15 to about 200 number of total subunits. In embodiments, the hydroxylated polyisobutene has from about 15 to about 100 number of total subunits. In embodiments, the hydroxylated polyisobutene has from about 15 to about 50 number of total subunits. In embodiments, the hydroxylated polyisobutene has from about 15 to about 20 number of total subunits. In embodiments, the hydroxylated polyisobutene has from about 20 to about 300,000 number of total subunits. In embodiments, the hydroxylated polyisobutene has from about 20 to about 200,000 number of total subunits. In embodiments, the hydroxylated polyisobutene has from about 20 to about 150,000 number of total subunits. In embodiments, the hydroxylated polyisobutene has from about 20 to about 100,000 number of total subunits. In embodiments, the hydroxylated polyisobutene has from about 20 to about 50,000 number of total subunits. In embodiments, the hydroxylated polyisobutene has from about 20 to about 20,000 number of total subunits. In embodiments, the hydroxylated polyisobutene has from about 20 to about 10,000 number of total subunits. In embodiments, the hydroxylated polyisobutene has from about 20 to about 5000 number of total subunits. In embodiments, the hydroxylated polyisobutene has from about 20 to about 2000 number of total subunits. In embodiments, the hydroxylated polyisobutene has from about 20 to about 1000 number of total subunits. In embodiments, the hydroxylated polyisobutene has from about 20 to about 500 number of total subunits. In embodiments, the hydroxylated polyisobutene has from about 20 to about 200 number of total subunits. In embodiments, the hydroxylated polyisobutene has from about 20 to about 100 number of total subunits. In embodiments, the hydroxylated polyisobutene has from about 20 to about 50 number of total subunits.

In an aspect is provided a cross-linked polymer, wherein a first oxidized polyisobutene (e.g., as described herein) is covalently bonded to a second oxidized polyisobutene (e.g., as described herein) via a covalent linker having the formula:

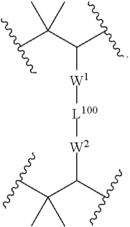

W¹ is —O— or —NR¹—.

W² is —O— or —NR²—.

R¹ and R² are independently hydrogen, halogen, —CX³₃, —CHX³₂, —CH₂X³, —OCX³₃, —OCH₂X³, —OCHX³₂, —CN, —SO₃R³, —SOᵥ₃NR³R³, —NR³NR³R³, —ONR³R³,
—NHC(O)NR³NR³R³,
—NHC(O)NR³R³, —N(O)ₘ₃, —NR³R³, —C(O)R³, —C(O)OR³, —C(O)NR³R³, —OR³, —SR³, —NR³SO₂R³,
—NR³C(O)R³, —NR³C(O)OR³, —NR³OR³, —SF₅, —N₃, substituted or unsubstituted alkyl (e.g., C₁-C₈, C₁-C₆, C₁-C₄, or C₁-C₂), substituted or unsubstituted heteroalkyl (e.g., 2 to 8 membered, 2 to 6 membered, 4 to 6 membered, or 2 to 3 membered), substituted or unsubstituted cycloalkyl (e.g., C₃-C₈, C₃-C₆, C₄-C₆, or C₅-C₆), substituted or unsubstituted heterocycloalkyl (e.g., 3 to 8 membered, 3 to 6 membered, 4 to 6 membered, 4 to 5 membered, or 5 to 6 membered), substituted or unsubstituted aryl (e.g., C₆-C₁₀ or phenyl), or substituted or unsubstituted heteroaryl (e.g., 5 to 10 membered, 5 to 9 membered, or 5 to 6 membered).

R³ is independently hydrogen, oxo,
halogen, —CCl₁₃, —CBr₃, —CF₃, —CI₃, —CHCl₂, —CHBr₂,
—CHF₂, —CHI₂, —CH₂Cl, —CH₂Br, —CH₂F, —CH₂I, —CN, —OH, —NH₂, —COOH, —CONH₂, —NO₂, —S H,
—SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —OCCl₁₃, —OCF₃, —OCBr₃, —OCI₃, —OCHCl₂, —OCHBr₂, —OCHI₂, —OCHF₂, —OCH₂Cl, —OCH₂Br, —OCH₂I, —OCH₂F, —N₃, —SF₅, substituted or unsubstituted alkyl (e.g., C₁-C₈, C₁-C₆, C₁-C₄, or C₁-C₂), substituted or unsubstituted heteroalkyl (e.g., 2 to 8 membered, 2 to 6 membered, 4 to 6 membered, or 2 to 3 membered), substituted or unsubstituted cycloalkyl (e.g., C₃-C₈, C₃-C₆, C₄-C₆, or C₅-C₆), substituted or unsubstituted heterocycloalkyl (e.g., 3 to 8 membered, 3 to 6 membered, 4 to 6 membered, 4 to 5 membered, or 5 to 6 membered), substituted or unsubstituted aryl (e.g., C₆-C₁₀ or phenyl), or substituted or unsubstituted heteroaryl (e.g., 5 to 10 membered, 5 to 9 membered, or 5 to 6 membered); two R³ substituents bonded to the same nitrogen atom may optionally be joined to form a substituted or unsubstituted heterocycloalkyl (e.g., 3 to 8 membered, 3 to 6 membered, 4 to 6 membered, 4 to 5 membered, or 5 to 6 membered), or substituted or unsubstituted heteroaryl (e.g., 5 to 10 membered, 5 to 9 membered, or 5 to 6 membered).

L¹⁰⁰ is -L¹⁰¹-L¹⁰²-L¹⁰³-.

L¹⁰¹ is a bond, —N(R¹⁰¹)—, —S—, —O—, —C(O)—, —C(O)O—, —OC(O)—, —N(R¹⁰¹)C(O)—, —C(O)N(R¹⁰¹)—, —NR¹⁰¹C(O)NR¹⁰¹—, —NR¹⁰¹C(NH)NH—, —C(S)—, —Si(R¹⁰¹)₂—, substituted or unsubstituted alkylene (e.g., C₁-C₅, C₁-C₆, C₁-C₄, or C₁-C₂), substituted or unsubstituted heteroalkylene (e.g., 2 to 8 membered, 2 to 6 membered, 4 to 6 membered, or 2 to 3 membered), substituted or unsubstituted cycloalkylene (e.g., C₃-C₈, C₃-C₆, C₄-C₆, or C₅-C₆), substituted or unsubstituted heterocycloalkylene (e.g., 3 to 8 membered, 3 to 6 membered, 4 to 6 membered, 4 to 5 membered, or 5 to 6 membered), substituted or unsubstituted arylene (e.g., C₆-C₁₀ or phenylene), or substituted or unsubstituted heteroarylene (e.g., 5 to 10 membered, 5 to 9 membered, or 5 to 6 membered).

L¹⁰² is a bond, —N(R¹⁰²)—, —S—, —O—, —C(O)—, —C(O)O—, —OC(O)—, —N(R¹⁰²)C(O)—, —C(O)N(R¹⁰²)—, —NR¹⁰²C(O)NR¹⁰²—, —NR¹⁰²C(NH)NH—, —C(S)—, —Si(R¹⁰²)₂—, substituted or unsubstituted alkylene (e.g., C₁-C₈, C₁-C₆, C₁-C₄, or C₁-C₂), substituted or unsubstituted heteroalkylene (e.g., 2 to 8 membered, 2 to 6 membered, 4 to 6 membered, or 2 to 3 membered), substituted or unsubstituted cycloalkylene (e.g., C₃-C₈, C₃-C₆, C₄-C₆, or C₅-C₆), substituted or unsubstituted heterocycloalkylene (e.g., 3 to 8 membered, 3 to 6 membered, 4 to 6 membered, 4 to 5 membered, or 5 to 6 membered), substituted or unsubstituted arylene (e.g., C₆-C₁₀ or phenylene), or substituted or unsubstituted heteroarylene (e.g., 5 to 10 membered, 5 to 9 membered, or 5 to 6 membered).

L¹⁰³ is a bond, —N(R¹⁰³)—, —S—, —O—, —C(O)—, —C(O)O—, —OC(O)—, —N(R¹⁰³)C(O)—, —C(O)N(R¹⁰³)—, —NR¹⁰³C(O)NR¹⁰³—, —NR¹⁰³C(NH)NH—, —C(S)—, —Si(R¹⁰³)₂—, substituted or unsubstituted alkylene (e.g., C₁-C₈, C₁-C₆, C₁-C₄, or C₁-C₂), substituted or unsubstituted heteroalkylene (e.g., 2 to 8 membered, 2 to 6 membered, 4 to 6 membered, or 2 to 3 membered), substituted or unsubstituted cycloalkylene (e.g., C₃-C₈, C₃-C₆, C₄-C₆, or C₅-C₆), substituted or unsubstituted heterocycloalkylene (e.g., 3 to 8 membered, 3 to 6 membered, 4 to 6 membered, 4 to 5 membered, or 5 to 6 membered), substituted or unsubstituted arylene (e.g., C₆-C₁₀ or phenylene), or substituted or unsubstituted heteroarylene (e.g., 5 to 10 membered, 5 to 9 membered, or 5 to 6 membered).

R¹⁰¹, R¹⁰², and R¹⁰³ are independently hydrogen, halogen, —CX¹⁰⁴₃, —CHX¹⁰⁴₂, —CH₂X¹⁰⁴,
—OCX¹⁰⁴₃, —OCH₂X¹⁰⁴, —OCHX¹⁰⁴², —CN, —SOₙ₁₀₄R¹⁰⁴, —SOᵥ₁₀₄NR¹⁰⁴R¹⁰⁴, —NR¹⁰⁴NR¹⁰⁴R¹⁰⁴, —ONR¹⁰⁴R¹⁰⁴,
—NHC(O)NR¹⁰⁴NR¹⁰⁴R¹⁰⁴, —NHC(O)NR¹⁰⁴R¹⁰⁴, N(O)ₘ₁₀₄, —NR¹⁰⁴R¹⁰⁴, —C(O)R¹⁰⁴, —C(O)OR¹⁰⁴, —C(O)NR¹⁰⁴R¹⁰⁴, —OR¹⁰⁴, —SR¹⁰⁴, —NR¹⁰4SO₂R¹⁰⁴, —NR¹⁰⁴C(O)R¹⁰⁴, —NR¹⁰⁴C(O)OR¹⁰⁴, —NR¹⁰⁴OR¹⁰⁴, —SF₅, —N₃, substituted or unsubstituted alkyl (e.g., C₁-C₈, C₁-C₆, C₁-C₄, or C₁-C₂), substituted or unsubstituted heteroalkyl (e.g., 2 to 8 membered, 2 to 6 membered, 4 to 6 membered, or 2 to 3 membered), substituted or unsubstituted cycloalkyl (e.g., C₃-C₈, C₃-C₆, C₄-C₆, or C₅-C₆), substituted or unsubstituted heterocycloalkyl (e.g., 3 to 8 membered, 3 to 6 membered, 4 to 6 membered, 4 to 5 membered, or 5 to 6 membered), substituted or unsubstituted aryl (e.g., C₆-C₁₀ or phenyl), or substituted or unsubstituted heteroaryl (e.g., 5 to 10 membered, 5 to 9 membered, or 5 to 6 membered).

R¹⁰⁴ is independently hydrogen, oxo, halogen, —CCl₃, —CBr₃, —CF₃, —CI₃, —CHCl₂, —CHBr₂, —CHF₂, —CHI₂, —CH₂Cl, —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —OCCl₁₃, —OCF₃, —OCBr₃, —OCI₃, —OCHCl₂, —OCHBr₂, —OCHI₂, —OCHF₂, —OCH₂Cl, —OCH₂Br, —OCH₂I, —OCH₂F, —N₃, —SF₅, substituted or unsubstituted alkyl (e.g., C₁-C₈, C₁-C₆, C₁-C₄, or C₁-C₂), substituted or unsubstituted heteroalkyl (e.g., 2 to 8 membered, 2 to 6 membered, 4 to 6 membered, or 2 to 3 membered), substituted or unsubstituted cycloalkyl (e.g., C₃-C₅, C₃-C₆, C₄-C₆, or C₅-C₆), substituted or unsubstituted heterocycloalkyl (e.g., 3 to 8 membered, 3 to 6 membered, 4 to 6 membered, 4 to 5 membered, or 5 to 6 membered), substituted or unsubstituted aryl (e.g., C₆-C₁₀ or phenyl), or substituted or unsubstituted heteroaryl (e.g., 5 to 10 membered, 5 to 9 membered, or 5 to 6 membered); two R¹⁰⁴ substituents bonded to the same nitrogen atom may optionally be joined to form a substituted or unsubstituted heterocycloalkyl (e.g., 3 to 8 membered, 3 to 6 membered, 4 to 6 membered, 4 to 5 membered, or 5 to 6 membered), or substituted or unsubstituted heteroaryl (e.g., 5 to 10 membered, 5 to 9 membered, or 5 to 6 membered).

X³ and X¹⁰⁴ are independently —F, —Cl, —Br, or —I.

The variables n3 and n104 are independently an integer from 0 to 4.

The variables m3, m104, v3, and v104 are independently 1 or 2.

In embodiments, W¹ is —O— or —NH—. In embodiments, W¹ is —O—. In embodiments, W¹ is —NH—. In embodiments, W¹ is independently —NR¹—; R¹ is as described herein, including in embodiments.

In embodiments, a substituted R¹ (e.g., substituted alkyl, substituted heteroalkyl, substituted cycloalkyl, substituted heterocycloalkyl, substituted aryl, and/or substituted heteroaryl) is substituted with at least one substituent group, size-limited substituent group, or lower substituent group; wherein if the substituted R¹ is substituted with a plurality of groups selected from substituent groups, size-limited substituent groups, and lower substituent groups; each substituent group, size-limited substituent group, and/or lower substituent group may optionally be different. In embodiments, when R¹ is substituted, it is substituted with at least one substituent group. In embodiments, when R¹ is substituted, it is substituted with at least one size-limited substituent group. In embodiments, when R¹ is substituted, it is substituted with at least one lower substituent group.

In embodiments, R¹ is independently hydrogen, halogen, —CCl₁₃, —CBr₃, —CF₃, —CI₃, —CHCl₂, —CHBr₂, —CHF₂, —CHI₂, —CH₂Cl, —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —OCCl₃, —OCF₃, —OCBr₃, —OCI₃, —OCHCl₂, —OCHBr₂, —OCHI₂, —OCHF₂, —OCH₂Cl, —OCH₂Br, —OCH₂I, —OCH₂F, —N₃, —SF₅, substituted or unsubstituted alkyl (e.g., C₁-C₈, C₁-C₆, C₁-C₄, or C₁-C₂), substituted or unsubstituted heteroalkyl (e.g., 2 to 8 membered, 2 to 6 membered, 4 to 6 membered, or 2 to 3 membered), substituted or unsubstituted cycloalkyl (e.g., C₃-C₈, C₃-C₆, C₄-C₆, or C₅-C₆), substituted or unsubstituted heterocycloalkyl (e.g., 3 to 8 membered, 3 to 6 membered, 4 to 6 membered, 4 to 5 membered, or 5 to 6 membered), substituted or unsubstituted aryl (e.g., C₆-C₁₀ or phenyl), or substituted or unsubstituted heteroaryl (e.g., 5 to 10 membered, 5 to 9 membered, or 5 to 6 membered).

In embodiments, R¹ is independently hydrogen. In embodiments, R¹ is independently unsubstituted C₁-C₄ alkyl. In embodiments, R¹ is independently unsubstituted methyl. In embodiments, R¹ is independently unsubstituted ethyl. In embodiments, R¹ is independently unsubstituted propyl. In embodiments, R¹ is independently unsubstituted n-propyl. In embodiments, R¹ is independently unsubstituted isopropyl. In embodiments, R¹ is independently unsubstituted butyl. In embodiments, R¹ is independently unsubstituted n-butyl. In embodiments, R¹ is independently unsubstituted tert-butyl.

In embodiments, W² is —O— or —NH—. In embodiments, W² is —O—. In embodiments, W² is —NH—. In embodiments, W² is independently —NR²—; R² is as described herein, including in embodiments.

In embodiments, a substituted R² (e.g., substituted alkyl, substituted heteroalkyl, substituted cycloalkyl, substituted heterocycloalkyl, substituted aryl, and/or substituted heteroaryl) is substituted with at least one substituent group, size-limited substituent group, or lower substituent group; wherein if the substituted R² is substituted with a plurality of groups selected from substituent groups, size-limited substituent groups, and lower substituent groups; each substituent group, size-limited substituent group, and/or lower substituent group may optionally be different. In embodiments, when R² is substituted, it is substituted with at least one substituent group. In embodiments, when R² is substituted, it is substituted with at least one size-limited substituent group. In embodiments, when R² is substituted, it is substituted with at least one lower substituent group.

In embodiments, R² is independently hydrogen, halogen, —CCl₃, —CBr₃, —CF₃, —CI₃, —CHCl₂, —CHBr₂, —CHF₂, —CHI₂, —CH₂Cl, —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —OCCl₃, —OCF₃, —OCBr₃, —OCI₃, —OCHCl₂, —OCHBr₂, —OCHI₂, —OCHF₂, —OCH₂Cl, —OCH₂Br, —OCH₂I, —OCH₂F, —N₃, —SF₅, substituted or unsubstituted alkyl (e.g., C₁-C₈, C₁-C₆, C₁-C₄, or C₁-C₂), substituted or unsubstituted heteroalkyl (e.g., 2 to 8 membered, 2 to 6 membered, 4 to 6 membered, or 2 to 3 membered), substituted or unsubstituted cycloalkyl (e.g., C₃-C₈, C₃-C₆, C₄-C₆, or C₅-C₆), substituted or unsubstituted heterocycloalkyl (e.g., 3 to 8 membered, 3 to 6 membered, 4 to 6 membered, 4 to 5 membered, or 5 to 6 membered), substituted or unsubstituted aryl (e.g., C₆-C₁₀ or phenyl), or substituted or unsubstituted heteroaryl (e.g., 5 to 10 membered, 5 to 9 membered, or 5 to 6 membered).

In embodiments, R² is independently hydrogen. In embodiments, R² is independently unsubstituted C₁-C₄ alkyl. In embodiments, R² is independently unsubstituted methyl. In embodiments, R² is independently unsubstituted ethyl. In embodiments, R² is independently unsubstituted propyl. In embodiments, R² is independently unsubstituted n-propyl. In embodiments, R² is independently unsubstituted isopropyl. In embodiments, R² is independently unsubstituted butyl. In embodiments, R² is independently unsubstituted n-butyl. In embodiments, R² is independently unsubstituted tert-butyl.

In embodiments, a substituted R³ (e.g., substituted alkyl, substituted heteroalkyl, substituted cycloalkyl, substituted heterocycloalkyl, substituted aryl, and/or substituted heteroaryl) is substituted with at least one substituent group, size-limited substituent group, or lower substituent group; wherein if the substituted R³ is substituted with a plurality of groups selected from substituent groups, size-limited substituent groups, and lower substituent groups; each substituent group, size-limited substituent group, and/or lower substituent group may optionally be different. In embodiments, when R³ is substituted, it is substituted with at least one substituent group. In embodiments, when R³ is substituted, it is substituted with at least one size-limited substituent group. In embodiments, when R³ is substituted, it is substituted with at least one lower substituent group.

In embodiments, a substituted ring formed when two R³ substituents bonded to the same nitrogen atom are joined (e.g., substituted heterocycloalkyl and/or substituted heteroaryl) is substituted with at least one substituent group, size-limited substituent group, or lower substituent group; wherein if the substituted ring formed when two R³ substituents bonded to the same nitrogen atom are joined is substituted with a plurality of groups selected from substituent groups, size-limited substituent groups, and lower substituent groups; each substituent group, size-limited substituent group, and/or lower substituent group may optionally be different. In embodiments, when the substituted ring formed when two R³ substituents bonded to the same nitrogen atom are joined is substituted, it is substituted with at least one substituent group. In embodiments, when the substituted ring formed when two R³ substituents bonded to the same nitrogen atom are joined is substituted, it is substituted with at least one size-limited substituent group. In embodiments, when the substituted ring formed when two R³ substituents bonded to the same nitrogen atom are joined is substituted, it is substituted with at least one lower substituent group.

In embodiments, a substituted L¹⁰¹ (e.g., substituted alkylene, substituted heteroalkylene, substituted cycloalkylene, substituted heterocycloalkylene, substituted arylene, and/or substituted heteroarylene) is substituted with at least one substituent group, size-limited substituent group, or lower substituent group; wherein if the substituted L¹⁰ is substituted with a plurality of groups selected from substituent groups, size-limited substituent groups, and lower substituent groups; each substituent group, size-limited substituent group, and/or lower substituent group may optionally be different. In embodiments, when L¹⁰ is substituted, it is substituted with at least one substituent group. In embodiments, when L¹⁰ is substituted, it is substituted with at least one size-limited substituent group. In embodiments, when L¹⁰ is substituted, it is substituted with at least one lower substituent group.

In embodiments, L¹⁰¹ is a bond, —S—, —O—, —C(O)—, —C(O)O—, —OC(O)—, —C(O)N(R¹⁰¹)—, —C(S)—, —Si(R¹⁰¹)₂—, substituted or unsubstituted alkylene (e.g., C₁-C₈, C₁-C₆, C₁-C₄, or C₁-C₂), substituted or unsubstituted heteroalkylene (e.g., 2 to 8 membered, 2 to 6 membered, 4 to 6 membered, or 2 to 3 membered), substituted or unsubstituted cycloalkylene (e.g., C₃-C₈, C₃-C₆, C₄-C₆, or C₅-C₆), substituted or unsubstituted heterocycloalkylene (e.g., 3 to 8 membered, 3 to 6 membered, 4 to 6 membered, 4 to 5 membered, or 5 to 6 membered), substituted or unsubstituted arylene (e.g., C₆-C₁₀ or phenylene), or substituted or unsubstituted heteroarylene (e.g., 5 to 10 membered, 5 to 9 membered, or 5 to 6 membered).

In embodiments, L₁₀₁ is a
bond, —NH—, —S—, —O—, —C(O)—, —C(O)O—, —OC(O)—, —NHC(O)—, —C(O)NH—, —NHC(O)NH—, —NHC(NH)NH—, —C(S)—, —Si(OH)₂—, substituted or unsubstituted alkylene (e.g., C₁-C₈, C₁-C₆, C₁-C₄, or C₁-C₂), substituted or unsubstituted heteroalkylene (e.g., 2 to 8 membered, 2 to 6 membered, 4 to 6 membered, or 2 to 3 membered), substituted or unsubstituted cycloalkylene (e.g., C₃-C₈, C₃-C₆, C₄-C₆, or C₅-C₆), substituted or unsubstituted heterocycloalkylene (e.g., 3 to 8 membered, 3 to 6 membered, 4 to 6 membered, 4 to 5 membered, or 5 to 6 membered), substituted or unsubstituted arylene (e.g., C₆-C₁₀ or phenylene), or substituted or unsubstituted heteroarylene (e.g., 5 to 10 membered, 5 to 9 membered, or 5 to 6 membered).

In embodiments, L¹⁰¹ is a
bond, —S—, —O—, —C(O)—, —C(O)O—, —OC(O)—, —C(O)NH—, —C(S)—, —Si(OH)₂—, substituted or unsubstituted alkylene (e.g., C₁-C₈, C₁-C₆, C₁-C₄, or C₁-C₂), substituted or unsubstituted heteroalkylene (e.g., 2 to 8 membered, 2 to 6 membered, 4 to 6 membered, or 2 to 3 membered), substituted or unsubstituted cycloalkylene (e.g., C₃-C₈, C₃-C₆, C₄-C₆, or C₅-C₆), substituted or unsubstituted heterocycloalkylene (e.g., 3 to 8 membered, 3 to 6 membered, 4 to 6 membered, 4 to 5 membered, or 5 to 6 membered), substituted or unsubstituted arylene (e.g., C₆-C₁₀ or phenylene), or substituted or unsubstituted heteroarylene (e.g., 5 to 10 membered, 5 to 9 membered, or 5 to 6 membered).

In embodiments, L¹⁰¹ is —C(O)—, —C(O)NH—, or —Si(R¹⁰¹)₂—; R¹⁰¹ is as described herein, including in embodiments. In embodiments, L¹⁰¹ is —C(O)—. In embodiments, L¹⁰¹ is —C(O)NH—. In embodiments, L¹⁰¹ is —Si(OH)₂—. In embodiments, L¹⁰¹ is —Si(Cl)₂—.

In embodiments, L¹⁰¹ is —Si(R¹⁰¹)₂—; R¹⁰¹ is as described herein, including in embodiments.

In embodiments, a substituted R¹⁰¹ (e.g., substituted alkyl, substituted heteroalkyl, substituted cycloalkyl, substituted heterocycloalkyl, substituted aryl, and/or substituted heteroaryl) is substituted with at least one substituent group, size-limited substituent group, or lower substituent group; wherein if the substituted R¹⁰¹ is substituted with a plurality of groups selected from substituent groups, size-limited substituent groups, and lower substituent groups; each substituent group, size-limited substituent group, and/or lower substituent group may optionally be different. In embodiments, when R¹⁰¹ is substituted, it is substituted with at least one substituent group. In embodiments, when R¹⁰¹ is substituted, it is substituted with at least one size-limited substituent group. In embodiments, when R¹⁰¹ is substituted, it is substituted with at least one lower substituent group.

In embodiments, R¹⁰¹ is independently hydrogen, halogen, —CCl₁₃, —CBr₃, —CF₃, —CI₃, —CHCl₂, —CHBr₂, —CHF₂, —CHI₂, —CH₂Cl, —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —OCCl₃, —OCF₃, —OCBr₃, —OCI₃, —OCHCl₂, —OCHBr₂, —OCHI₂, —OCHF₂, —OCH₂Cl, —OCH₂Br, —OCH₂I, —OCH₂F, —OSi(OH)₃, —N₃, —SF₅, substituted or unsubstituted alkyl (e.g., C₁-C₈, C₁-C₆, C₁-C₄, or C₁-C₂), substituted or unsubstituted heteroalkyl (e.g., 2 to 8 membered, 2 to 6 membered, 4 to 6 membered, or 2 to 3 membered), substituted or unsubstituted cycloalkyl (e.g., C₃-C₈, C₃-C₆, C₄-C₆, or C₅-C₆), substituted or unsubstituted heterocycloalkyl (e.g., 3 to 8 membered, 3 to 6 membered, 4 to 6 membered, 4 to 5 membered, or 5 to 6 membered), substituted or unsubstituted aryl (e.g., C₆-C₁₀ or phenyl), or substituted or unsubstituted heteroaryl (e.g., 5 to 10 membered, 5 to 9 membered, or 5 to 6 membered).

In embodiments, R¹⁰¹ is independently halogen, —OH, —NH₂, —OSi(OH)₃, or substituted or unsubstituted heteroalkylene. In embodiments, R¹⁰¹ is independently halogen, —OH, —NH₂, or substituted or unsubstituted heteroalkylene. In embodiments, R¹⁰¹ is independently —Cl or —OH. In embodiments, R¹⁰¹ is independently —F. In embodiments, R¹⁰¹ is independently —C₁. In embodiments, R¹⁰¹ is independently —Br. In embodiments, R¹⁰¹ is independently —I. In embodiments, R¹⁰¹ is independently —OH. In embodiments, R¹⁰¹ is independently —NH₂. In embodiments, R¹⁰¹ is independently —OSi(OH)₃. In embodiments, R¹⁰¹ is independently substituted or unsubstituted heteroalkylene. In embodiments, R¹⁰¹ is independently unsubstituted heteroalkylene. In embodiments, R¹⁰¹ is independently unsubstituted alkoxy. In embodiments, R¹⁰¹ is independently —O(C₁-C₄ alkyl). In embodiments, R¹⁰¹ is independently unsubstituted methoxy. In embodiments, R¹⁰¹ is independently unsubstituted ethoxy. In embodiments, R¹⁰¹ is independently unsubstituted propoxy. In embodiments, R¹⁰¹ is independently unsubstituted n-propoxy. In embodiments, R¹⁰¹ is independently unsubstituted isopropoxy. In embodiments, R¹⁰¹ is independently unsubstituted butoxy. In embodiments, R¹⁰¹ is independently unsubstituted n-butoxy. In embodiments, R¹⁰¹ is independently unsubstituted tert-butoxy.

In embodiments, L¹⁰¹ is —Si(R¹⁰¹)₂—; and R¹⁰¹ is independently an oxidized polyisobutene, including a subunit having the formula:

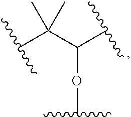 [SMILES: *OC(*)C(*)(C)C]

wherein the oxygen atom is connected to the silicon atom.

In embodiments, a substituted L¹⁰² (e.g., substituted alkylene, substituted heteroalkylene, substituted cycloalkylene, substituted heterocycloalkylene, substituted arylene, and/or substituted heteroarylene) is substituted with at least one substituent group, size-limited substituent group, or lower substituent group; wherein if the substituted L¹⁰² is substituted with a plurality of groups selected from substituent groups, size-limited substituent groups, and lower substituent groups; each substituent group, size-limited substituent group, and/or lower substituent group may optionally be different. In embodiments, when L¹⁰² is substituted, it is substituted with at least one substituent group. In embodiments, when L¹⁰² is substituted, it is substituted with at least one size-limited substituent group. In embodiments, when L¹⁰² is substituted, it is substituted with at least one lower substituent group.

In embodiments, L¹⁰² is a
bond, —NH—, —S—, —O—, —C(O)—, —C(O)O—, —OC(O)—, —NHC(O)—, —C(O)NH—, —NHC(O)NH—, —NHC(NH)NH—, —C(S)—, —Si(OH)₂—, substituted or unsubstituted alkylene (e.g., C₁-C₈, C₁-C₆, C₁-C₄, or C₁-C₂), substituted or unsubstituted heteroalkylene (e.g., 2 to 8 membered, 2 to 6 membered, 4 to 6 membered, or 2 to 3 membered), substituted or unsubstituted cycloalkylene (e.g., C₃-C₈, C₃-C₆, C₄-C₆, or C₅-C₆), substituted or unsubstituted heterocycloalkylene (e.g., 3 to 8 membered, 3 to 6 membered, 4 to 6 membered, 4 to 5 membered, or 5 to 6 membered), substituted or unsubstituted arylene (e.g., C₆-C₁₀ or phenylene), or substituted or unsubstituted heteroarylene (e.g., 5 to 10 membered, 5 to 9 membered, or 5 to 6 membered).

In embodiments, L¹⁰² is a substituted or unsubstituted alkylene. In embodiments, L¹⁰² is a substituted or unsubstituted C₁-C₂₀ alkylene. In embodiments, L¹⁰² is a substituted C₁-C₂₀ alkylene. In embodiments, L¹⁰² is an unsubstituted C₁-C₂₀ alkylene. In embodiments, L¹⁰² is an unsubstituted C₁-C₁₂ alkylene. In embodiments, L¹⁰² is an unsubstituted C₁-C₈ alkylene. In embodiments, L¹⁰² is an unsubstituted C₁-C₆ alkylene. In embodiments, L¹⁰² is a bond.

In embodiments, a substituted R¹⁰² (e.g., substituted alkyl, substituted heteroalkyl, substituted cycloalkyl, substituted heterocycloalkyl, substituted aryl, and/or substituted heteroaryl) is substituted with at least one substituent group, size-limited substituent group, or lower substituent group; wherein if the substituted R¹⁰² is substituted with a plurality of groups selected from substituent groups, size-limited substituent groups, and lower substituent groups; each substituent group, size-limited substituent group, and/or lower substituent group may optionally be different. In embodiments, when R¹⁰² is substituted, it is substituted with at least one substituent group. In embodiments, when R¹⁰² is substituted, it is substituted with at least one size-limited substituent group. In embodiments, when R¹⁰² is substituted, it is substituted with at least one lower substituent group.

In embodiments, R¹⁰² is independently hydrogen, halogen, —CCl₁₃, —CBr₃, —CF₃, —CI₃, —CHCl₂, —CHBr₂, —CHF₂, —CHI₂, —CH₂Cl, —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —OCCl₃, —OCF₃, —OCBr₃, —OCI₃,
—OCHCl₂, —OCHBr₂, —OCHI₂, —OCHF₂, —OCH₂Cl, —OCH₂Br, —OCH₂I, —OCH₂F, —OSi(OH)₃, —N₃,
—SF₅, substituted or unsubstituted alkyl (e.g., C₁-C₈, C₁-C₆, C₁-C₄, or C₁-C₂), substituted or unsubstituted heteroalkyl (e.g., 2 to 8 membered, 2 to 6 membered, 4 to 6 membered, or 2 to 3 membered), substituted or unsubstituted cycloalkyl (e.g., C₃-C₈, C₃-C₆, C₄-C₆, or C₅-C₆), substituted or unsubstituted heterocycloalkyl (e.g., 3 to 8 membered, 3 to 6 membered, 4 to 6 membered, 4 to 5 membered, or 5 to 6 membered), substituted or unsubstituted aryl (e.g., C₆-C₁₀ or phenyl), or substituted or unsubstituted heteroaryl (e.g., 5 to 10 membered, 5 to 9 membered, or 5 to 6 membered).

In embodiments, a substituted L¹⁰³ (e.g., substituted alkylene, substituted heteroalkylene, substituted cycloalkylene, substituted heterocycloalkylene, substituted arylene, and/or substituted heteroarylene) is substituted with at least one substituent group, size-limited substituent group, or lower substituent group; wherein if the substituted L¹⁰³ is substituted with a plurality of groups selected from substituent groups, size-limited substituent groups, and lower substituent groups; each substituent group, size-limited substituent group, and/or lower substituent group may optionally be different. In embodiments, when L¹⁰³ is substituted, it is substituted with at least one substituent group. In embodiments, when L¹⁰³ is substituted, it is substituted with at least one size-limited substituent group. In embodiments, when L¹⁰³ is substituted, it is substituted with at least one lower substituent group.

In embodiments, L¹⁰³ is a bond, —S—, —O—, —C(O)—, —C(O)O—, —OC(O)—, —N(R¹⁰³)C(O)—, —C(S)—, —Si(R¹⁰³)₂—, substituted or unsubstituted alkylene (e.g., C₁-C₈, C₁-C₆, C₁-C₄, or C₁-C₂), substituted or unsubstituted heteroalkylene (e.g., 2 to 8 membered, 2 to 6 membered, 4 to 6 membered, or 2 to 3 membered), substituted or unsubstituted cycloalkylene (e.g., C₃-C₈, C₃-C₆, C₄-C₆, or C₅-C₆), substituted or unsubstituted heterocycloalkylene (e.g., 3 to 8 membered, 3 to 6 membered, 4 to 6 membered, 4 to 5 membered, or 5 to 6 membered), substituted or unsubstituted arylene (e.g., C₆-C₁₀ or phenylene), or substituted or unsubstituted heteroarylene (e.g., 5 to 10 membered, 5 to 9 membered, or 5 to 6 membered).

In embodiments, L¹⁰³ is a
bond, —NH—, —S—, —O—, —C(O)—, —C(O)O—, —OC(O)—, —NHC(O)—, —C(O)NH—, —NHC(O)NH—, —NHC(NH)NH—, —C(S)—, —Si(OH)₂—, substituted or unsubstituted alkylene (e.g., C₁-C₈, C₁-C₆, C₁-C₄, or C₁-C₂), substituted or unsubstituted heteroalkylene (e.g., 2 to 8 membered, 2 to 6 membered, 4 to 6 membered, or 2 to 3 membered), substituted or unsubstituted cycloalkylene (e.g., C₃-C₈, C₃-C₆, C₄-C₆, or C₅-C₆), substituted or unsubstituted heterocycloalkylene (e.g., 3 to 8 membered, 3 to 6 membered, 4 to 6 membered, 4 to 5 membered, or 5 to 6 membered), substituted or unsubstituted arylene (e.g., C₆-C₁₀ or phenylene), or substituted or unsubstituted heteroarylene (e.g., 5 to 10 membered, 5 to 9 membered, or 5 to 6 membered).

In embodiments, L¹⁰³ is a bond, —S—, —O—, —C(O)—, —C(O)O—, —OC(O)—, —NHC(O)—, —C(S)—, —Si(OH)₂—, substituted or unsubstituted alkylene (e.g., C₁-C₈, C₁-C₆, C₁-C₄, or C₁-C₂), substituted or unsubstituted heteroalkylene (e.g., 2 to 8 membered, 2 to 6 membered, 4 to 6 membered, or 2 to 3 membered), substituted or unsubstituted cycloalkylene (e.g., C₃-C₈, C₃-C₆, C₄-C₆, or C₅-C₆), substituted or unsubstituted heterocycloalkylene (e.g., 3 to 8 membered, 3 to 6 membered, 4 to 6 membered, 4 to 5 membered, or 5 to 6 membered), substituted or unsubstituted arylene (e.g., C₆-C₁₀ or phenylene), or substituted or unsubstituted heteroarylene (e.g., 5 to 10 membered, 5 to 9 membered, or 5 to 6 membered).

In embodiments, L¹⁰³ is —C(O)—, —NHC(O)—, or —Si(R¹⁰³)₂—; R¹⁰³ is as described herein, including in embodiments. In embodiments, L¹⁰³ is —C(O)—. In embodiments, L¹⁰³ is —NHC(O)—. In embodiments, L¹⁰³ is —Si(OH)₂—. In embodiments, L¹⁰³ is —Si(C₁)₂—. In embodiments, L¹⁰³ is a bond.

In embodiments, L¹⁰³ is —Si(R¹⁰³)₂—; R¹⁰³ is as described herein, including in embodiments.

In embodiments, a substituted R¹⁰³ (e.g., substituted alkyl, substituted heteroalkyl, substituted cycloalkyl, substituted heterocycloalkyl, substituted aryl, and/or substituted heteroaryl) is substituted with at least one substituent group, size-limited substituent group, or lower substituent group; wherein if the substituted R¹⁰³ is substituted with a plurality of groups selected from substituent groups, size-limited substituent groups, and lower substituent groups; each substituent group, size-limited substituent group, and/or lower substituent group may optionally be different. In embodiments, when R¹⁰³ is substituted, it is substituted with at least one substituent group. In embodiments, when R¹⁰³ is substituted, it is substituted with at least one size-limited substituent group. In embodiments, when R¹⁰³ is substituted, it is substituted with at least one lower substituent group.

In embodiments, R¹⁰³ is independently hydrogen, halogen, —CCl₁₃, —CBr₃, —CF₃, —CI₃, —CHCl₂, —CHBr₂, —CHF₂, —CHI₂, —CH₂Cl, —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —OCCl₃, —OCF₃, —OCBr₃, —OCI₃,
—OCHCl₂, —OCHBr₂, —OCHI₂, —OCHF₂, —OCH₂Cl, —OCH₂Br, —OCH₂I, —OCH₂F, —OSi(OH)₃, —N₃,
—SF₅, substituted or unsubstituted alkyl (e.g., C₁-C₈, C₁-C₆, C₁-C₄, or C₁-C₂), substituted or unsubstituted heteroalkyl (e.g., 2 to 8 membered, 2 to 6 membered, 4 to 6 membered, or 2 to 3 membered), substituted or unsubstituted cycloalkyl (e.g., C₃-C₈, C₃-C₆, C₄-C₆, or C₅-C₆), substituted or unsubstituted heterocycloalkyl (e.g., 3 to 8 membered, 3 to 6 membered, 4 to 6 membered, 4 to 5 membered, or 5 to 6 membered), substituted or unsubstituted aryl (e.g., C₆-C₁₀ or phenyl), or substituted or unsubstituted heteroaryl (e.g., 5 to 10 membered, 5 to 9 membered, or 5 to 6 membered).

In embodiments, R¹⁰³ is independently halogen, —OH, —NH₂, —OSi(OH)₃, or substituted or unsubstituted heteroalkylene. In embodiments, R¹⁰³ is independently halogen, —OH, —NH₂, or substituted or unsubstituted heteroalkylene. In embodiments, R¹⁰³ is independently —Cl or —OH. In embodiments, R¹⁰³ is independently —F. In embodiments, R¹⁰³ is independently —Cl. In embodiments, R¹⁰³ is independently —Br. In embodiments, R¹⁰³ is independently —I. In embodiments, R¹⁰³ is independently —OH. In embodiments, R¹⁰³ is independently —NH₂. In embodiments, R¹⁰³ is independently —OSi(OH)₃. In embodiments, R¹⁰³ is independently substituted or unsubstituted heteroalkylene. In embodiments, R¹⁰³ is independently unsubstituted heteroalkylene. In embodiments, R¹⁰³ is independently unsubstituted alkoxy. In embodiments, R¹⁰³ is independently —O(C₁-C₄ alkyl). In embodiments, R¹⁰³ is independently unsubstituted methoxy. In embodiments, R¹⁰³ is independently unsubstituted ethoxy. In embodiments, R¹⁰³ is independently unsubstituted propoxy. In embodiments, R¹⁰³ is independently unsubstituted n-propoxy. In embodiments, R¹⁰³ is independently unsubstituted isopropoxy. In embodiments, R¹⁰³ is independently unsubstituted butoxy. In embodiments, R¹⁰³ is independently unsubstituted n-butoxy. In embodiments, R¹⁰³ is independently unsubstituted tert-butoxy.

In embodiments, L¹⁰³ is —Si(R¹⁰³)₂—; and R¹⁰³ is independently an oxidized polyisobutene, including a subunit having the formula:

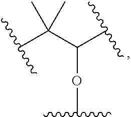 [SMILES: *OC(*)C(*)(C)C]

wherein the oxygen atom is connected to the silicon atom.

In embodiments, a substituted R¹⁰⁴ (e.g., substituted alkyl, substituted heteroalkyl, substituted cycloalkyl, substituted heterocycloalkyl, substituted aryl, and/or substituted heteroaryl) is substituted with at least one substituent group, size-limited substituent group, or lower substituent group; wherein if the substituted R¹⁰⁴ is substituted with a plurality of groups selected from substituent groups, size-limited substituent groups, and lower substituent groups; each substituent group, size-limited substituent group, and/or lower substituent group may optionally be different. In embodiments, when R¹⁰⁴ is substituted, it is substituted with at least one substituent group. In embodiments, when R¹⁰⁴ is substituted, it is substituted with at least one size-limited substituent group. In embodiments, when R¹⁰⁴ is substituted, it is substituted with at least one lower substituent group.

In embodiments, a substituted ring formed when two R¹⁰⁴ substituents bonded to the same nitrogen atom are joined (e.g., substituted heterocycloalkyl and/or substituted heteroaryl) is substituted with at least one substituent group, size-limited substituent group, or lower substituent group; wherein if the substituted ring formed when two R¹⁰⁴ substituents bonded to the same nitrogen atom are joined is substituted with a plurality of groups selected from substituent groups, size-limited substituent groups, and lower substituent groups; each substituent group, size-limited substituent group, and/or lower substituent group may optionally be different. In embodiments, when the substituted ring formed when two R¹⁰⁴ substituents bonded to the same nitrogen atom are joined is substituted, it is substituted with at least one substituent group. In embodiments, when the substituted ring formed when two R¹⁰⁴ substituents bonded to the same nitrogen atom are joined is substituted, it is substituted with at least one size-limited substituent group. In embodiments, when the substituted ring formed when two R¹⁰⁴ substituents bonded to the same nitrogen atom are joined is substituted, it is substituted with at least one lower substituent group.

In embodiments, L¹⁰¹ is —C(O)—, —NHC(O)—, —C(O)NH—, or —Si(R¹⁰¹)₂—; R¹⁰¹ is halogen, —OH, —NH₂, or substituted or unsubstituted heteroalkylene; L¹⁰² is an unsubstituted alkylene; L¹⁰³ is —C(O)—, —NHC(O)—, —C(O)NH—, or —Si(R¹⁰³)₂—; and R¹⁰³ is halogen, —OH, —NH₂, or substituted or unsubstituted heteroalkylene.

In embodiments, L¹⁰⁰ is

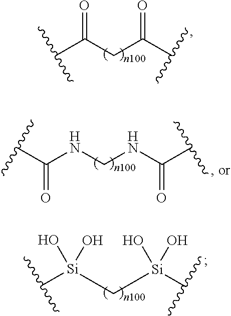

and n100 is an integer from 1 to 20. In embodiments, L¹⁰⁰ is

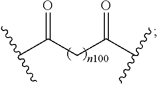

and n100 is an integer from 1 to 20. In embodiments, L¹⁰⁰ is

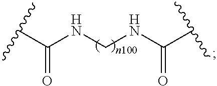

and n100 is an integer from 1 to 20. In embodiments, L¹⁰⁰ is

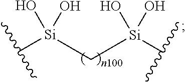

and n100 is an integer from 1 to 20.

In embodiments, L¹⁰¹ is —Si(R¹⁰¹)₂—; R¹⁰¹ is as described herein, including in embodiments; L¹⁰² is a bond; and L¹⁰³ is a bond.

In embodiments, n100 is 1. In embodiments, n100 is 2. In embodiments, n100 is 3. In embodiments, n100 is 4. In embodiments, n100 is 5. In embodiments, n100 is 6. In embodiments, n100 is 7. In embodiments, n100 is 8. In embodiments, n100 is 9. In embodiments, n100 is 10. In embodiments, n100 is 11. In embodiments, n100 is 12. In embodiments, n100 is 13. In embodiments, n100 is 14. In embodiments, n100 is 15. In embodiments, n100 is 16. In embodiments, n100 is 17. In embodiments, n100 is 18. In embodiments, n100 is 19. In embodiments, n100 is 20.

In embodiments, when R¹ is substituted, R¹ is substituted with one or more first substituent groups denoted by R^{1.1} as explained in the definitions section above in the description of “first substituent group(s)”. In embodiments, when an R^{1.1} substituent group is substituted, the R^{1.1} substituent group is substituted with one or more second substituent groups denoted by R^{1.2} as explained in the definitions section above in the description of “first substituent group(s)”. In embodiments, when an R^{1.2} substituent group is substituted, the R^{1.2} substituent group is substituted with one or more third substituent groups denoted by R^{1.3} as explained in the definitions section above in the description of “first substituent group(s)”. In the above embodiments, R¹, R^{1.1}, R^{1.2}, and R^{1.3} have values corresponding to the values of R^{WW}, R^{WW.1}, R^{WW.2}, and R^{WW.3}, respectively, as explained in the definitions section above in the description of “first substituent group(s)”, wherein R^{WW}, R^{WW.1}, R^{WW.2}, and R^{WW.3} correspond to R¹, R^{1.1}, R^{1.2}, and R^{1.3}, respectively.

In embodiments, when R² is substituted, R² is substituted with one or more first substituent groups denoted by R^{2.1} as explained in the definitions section above in the description of “first substituent group(s)”. In embodiments, when an R^{2.1} substituent group is substituted, the R^{2.1} substituent group is substituted with one or more second substituent groups denoted by R^{2.2} as explained in the definitions section above in the description of “first substituent group(s)”. In embodiments, when an R^{2.2} substituent group is substituted, the R^{2.2} substituent group is substituted with one or more third substituent groups denoted by R^{2.3} as explained in the definitions section above in the description of “first substituent group(s)”. In the above embodiments, R², R^{2.1}, R^{2.2}, and R^{2.3} have values corresponding to the values of R^{WW}, R^{WW.1}, R^{WW.2}, and R^{WW.3}, respectively, as explained in the definitions section above in the description of “first substituent group(s)”, wherein R^{WW}, R^{WW.1}, R^{WW.2}, and R^{WW.3} correspond to R², R^{2.1}, R^{2.2}, and R^{2.3}, respectively.

In embodiments, when R³ is substituted, R³ is substituted with one or more first substituent groups denoted by R^{3.1} as explained in the definitions section above in the description of “first substituent group(s)”. In embodiments, when an R^{3.1} substituent group is substituted, the R^{3.1} substituent group is substituted with one or more second substituent groups denoted by R^{3.2} as explained in the definitions section above in the description of “first substituent group(s)”. In embodiments, when an R^{3.2} substituent group is substituted, the R^{3.2} substituent group is substituted with one or more third substituent groups denoted by R^{3.3} as explained in the definitions section above in the description of “first substituent group(s)”. In the above embodiments, R³, R^{3.1}, R^{3.2}, and R^{3.3} have values corresponding to the values of R^{WW}, R^{WW.1}, R^{WW.2}, and R^{WW.3}, respectively, as explained in the definitions section above in the description of “first substituent group(s)”, wherein R^{WW}, R^{WW.1}, R^{WW.2}, and R^{WW.3} correspond to R³, R^{3.1}, R^{3.2}, and R^{3.3}, respectively.

In embodiments, when two R³ substituents bonded to the same nitrogen atom are optionally joined to form a moiety that is substituted (e.g., a substituted heterocycloalkyl or substituted heteroaryl), the moiety is substituted with one or more first substituent groups denoted by R^{3.1} as explained in the definitions section above in the description of “first substituent group(s)”. In embodiments, when an R^{3.1} substituent group is substituted, the R^{3.1} substituent group is substituted with one or more second substituent groups denoted by R^{3.2} as explained in the definitions section above in the description of “first substituent group(s)”. In embodiments, when an R^{3.2} substituent group is substituted, the R^{3.2} substituent group is substituted with one or more third substituent groups denoted by R^{3.3} as explained in the definitions section above in the description of “first substituent group(s)”. In the above embodiments, R^{3.1}, R^{3.2}, and R^{3.3} have values corresponding to the values of R^{WW.1}, R^{WW.2}, and R^{WW.3}, respectively, as explained in the definitions section above in the description of “first substituent group(s)”, wherein R^{WW.1}, R^{WW.2}, and R^{WW.3} correspond to R^{3.1}, R^{3.2}, and R^{3.3}, respectively.

In embodiments, when R¹⁰¹ is substituted, R¹⁰¹ is substituted with one or more first substituent groups denoted by R¹⁰¹¹ as explained in the definitions section above in the description of “first substituent group(s)”. In embodiments, when an R^{101.1} substituent group is substituted, the R^{101.1} substituent group is substituted with one or more second substituent groups denoted by R^{101.2} as explained in the definitions section above in the description of “first substituent group(s)”. In embodiments, when an R^{101.2} substituent group is substituted, the R^{101.2} substituent group is substituted with one or more third substituent groups denoted by R^{101.3} as explained in the definitions section above in the description of “first substituent group(s)”. In the above embodiments, R¹⁰¹, R^{101.1}, R^{101.2}, and R^{101.3} have values corresponding to the values of R^{WW}, R^{WW.1}, R^{WW.2}, and R^{WW.3}, respectively, as explained in the definitions section above in the description of “first substituent group(s)”, wherein R″w, R^{WW.1}, R^{WW.2}, and R^{WW.3} correspond to R¹⁰¹, R^{101.1}, R^{101.2}, and R^{101.3}, respectively.

In embodiments, when R¹⁰² is substituted, R¹⁰² is substituted with one or more first substituent groups denoted by R^{102.1} as explained in the definitions section above in the description of “first substituent group(s)”. In embodiments, when an R^{102.1} substituent group is substituted, the R^{102.1} substituent group is substituted with one or more second substituent groups denoted by R^{102.2} as explained in the definitions section above in the description of “first substituent group(s)”. In embodiments, when an R^{102.2} substituent group is substituted, the R^{102.2} substituent group is substituted with one or more third substituent groups denoted by R^{102.3} as explained in the definitions section above in the description of “first substituent group(s)”. In the above embodiments, R¹⁰², R^{102.1}, R^{102.2}, and R^{102.3} have values corresponding to the values of R^{WW}, R^{WW.1}, R^{WW.2}, and R^{WW.3}, respectively, as explained in the definitions section above in the description of “first substituent group(s)”, wherein R^{WW}, R^{WW.1}, R^{WW.2}, and R^{WW.3} correspond to R¹⁰², R^{102.1}, R^{102.2}, and R^{102.3}, respectively.

In embodiments, when R¹⁰³ is substituted, R¹⁰³ is substituted with one or more first substituent groups denoted by R^{103.1} as explained in the definitions section above in the description of “first substituent group(s)”. In embodiments, when an R^{103.1} substituent group is substituted, the R^{103.1} substituent group is substituted with one or more second substituent groups denoted by R^{103.2} as explained in the definitions section above in the description of “first substituent group(s)”. In embodiments, when an R^{103.2} substituent group is substituted, the R^{103.2} substituent group is substituted with one or more third substituent groups denoted by R^{103.3} as explained in the definitions section above in the description of “first substituent group(s)”. In the above embodiments, R¹⁰³, R^{103.1}, R^{103.2} and R^{103.3} have values corresponding to the values of R^{WW}, R^{WW.1}, R^{WW.2}, and R^{WW.3}, respectively, as explained in the definitions section above in the description of “first substituent group(s)”, wherein R^{WW}, R^{WW.1}, R^{WW.2}, and R^{WW.3} correspond to R¹⁰³, R^{103.1}, R^{103.2}, and R^{103.3}, respectively.

In embodiments, when R¹⁰⁴ is substituted, R¹⁰⁴ is substituted with one or more first substituent groups denoted by R^{104.1} as explained in the definitions section above in the description of “first substituent group(s)”. In embodiments, when an R^{104.1} substituent group is substituted, the R^{104.1} substituent group is substituted with one or more second substituent groups denoted by R^{104.2} as explained in the definitions section above in the description of “first substituent group(s)”. In embodiments, when an R^{104.2} substituent group is substituted, the R^{104.2} substituent group is substituted with one or more third substituent groups denoted by R^{104.3} as explained in the definitions section above in the description of “first substituent group(s)”. In the above embodiments, R¹⁰⁴, R^{104.1}, R^{104.2} and R^{104.3} have values corresponding to the values of R^{WW}, R^{WW.1}, R^{WW.2}, and R^{WW.3}, respectively, as explained in the definitions section above in the description of “first substituent group(s)”, wherein R^{WW}, R^{WW.1}, R^{WW.2}, and R^{WW.3} correspond to R¹⁰⁴, R^{104.1}, R^{104.2}, and R¹⁰⁴₃, respectively.

In embodiments, when two R¹⁰⁴ substituents bonded to the same nitrogen atom are optionally joined to form a moiety that is substituted (e.g., a substituted heterocycloalkyl or substituted heteroaryl), the moiety is substituted with one or more first substituent groups denoted by R^{104.1} as explained in the definitions section above in the description of “first substituent group(s)”. In embodiments, when an R^{104.1} substituent group is substituted, the R^{104.1} substituent group is substituted with one or more second substituent groups denoted by R^{104.2} as explained in the definitions section above in the description of “first substituent group(s)”. In embodiments, when an R^{104.2} substituent group is substituted, the R^{104.2} substituent group is substituted with one or more third substituent groups denoted by R^{104.3} as explained in the definitions section above in the description of “first substituent group(s)”. In the above embodiments, R^{104.1}, R^{104.2}, and R^{104.3} have values corresponding to the values of R^{WW.1}, R^{WW.2}, and R^{WW.3}, respectively, as explained in the definitions section above in the description of “first substituent group(s)”, wherein R^{WW.1}, R^{WW.2}, and R^{WW.3} correspond to R^{104.1}, R^{104.2}, and R¹⁰⁴₃, respectively.

In embodiments, when L¹⁰¹ is substituted, L¹⁰¹ is substituted with one or more first substituent groups denoted by R^{L101.1} as explained in the definitions section above in the description of “first substituent group(s)”. In embodiments, when an R^{L101.1} substituent group is substituted, the R^{L101.1} substituent group is substituted with one or more second substituent groups denoted by R^{L101.2} as explained in the definitions section above in the description of “first substituent group(s)”. In embodiments, when an R^{L101.2} substituent group is substituted, the R^{L101.2} substituent group is substituted with one or more third substituent groups denoted by R^{L101.3} as explained in the definitions section above in the description of “first substituent group(s)”. In the above embodiments, L¹⁰¹, R^{L101.1}, R^{L101.2}, and R^{L101.3} have values corresponding to the values of L^{WW}, R^{LWW.1}, R^{LWW.2}, and R^{LWW.3}, respectively, as explained in the definitions section above in the description of “first substituent group(s)”, wherein L^{WW}, R^{LWW.1}, R^{LWW.2}, and R^{LWW.3} are L¹⁰¹, R^{L101.1}, R^{L101.2}, and R^{L101.3} respectively.

In embodiments, when L¹⁰² is substituted, L¹⁰² is substituted with one or more first substituent groups denoted by R^{L102.1} as explained in the definitions section above in the description of “first substituent group(s)”. In embodiments, when an R^{L102.1} substituent group is substituted, the R^{L102.1} substituent group is substituted with one or more second substituent groups denoted by R^{L102.2} as explained in the definitions section above in the description of “first substituent group(s)”. In embodiments, when an R^{L102.2} substituent group is substituted, the R^{L102.2} substituent group is substituted with one or more third substituent groups denoted by R^{L102.3} as explained in the definitions section above in the description of “first substituent group(s)”. In the above embodiments, L¹⁰², R^{L102.1}, R^{L102.2} and R^{L1023} have values corresponding to the values of L^{WW}, R^{LWW.1}, R^{LWW.2}, and R^{LWW.3}, respectively, as explained in the definitions section above in the description of “first substituent group(s)”, wherein L^{WW}, R^{LWW.1}, R^{LWW.2}, and R^{LWW.3} are L¹⁰², R^{L102.1}, R^{L102.2}, and R^{L102.3}, respectively.

In embodiments, when L¹⁰³ is substituted, L¹⁰³ is substituted with one or more first substituent groups denoted by R^{L103.1} as explained in the definitions section above in the description of “first substituent group(s)”. In embodiments, when an R^{L103.1} substituent group is substituted, the R^{L103.1} substituent group is substituted with one or more second substituent groups denoted by R^{L103.2} as explained in the definitions section above in the description of “first substituent group(s)”. In embodiments, when an R^{L1032} substituent group is substituted, the R^{L1032} substituent group is substituted with one or more third substituent groups denoted by R^{L103.3} as explained in the definitions section above in the description of “first substituent group(s)”. In the above embodiments, L¹⁰³, R^{L103.1}, R^{L103.2}, and R^{L103.3} have values corresponding to the values of L^{WW}, R^{LWW.1}, R^{LWW.2}, and R^{LWW.3}, respectively, as explained in the definitions section above in the description of “first substituent group(s)”, wherein L^{WW}, R^{LWW.1}, R^{LWW.2}, and R^{LWW.3} are L¹⁰³, R^{L103.1}, R^{L103.2} and R^{L103.3}, respectively.

In embodiments, the compound is a compound described herein (e.g., in an aspect, embodiment, example, table, figure, or claim).

### III. Compositions

In an aspect is provided an oxidized polyisobutene in a vessel including an oxidized polyisobutene and one or more additional compounds selected from the groups consisting of: (i) a metal catalyst; (ii) an oxidizing agent; (iii) a reducing agent; (iv) a polyisobutene; and (v) a hydroxylated polyisobutene.

The oxidized polyisobutene and hydroxylated polyisobutene are as described herein, including in embodiments.

The polyisobutene includes a non-oxidized subunit, wherein the non-oxidized subunit is as described herein.

In embodiments, the polyisobutene has a number average molecular weight from 250 Da to 20,000,000 Da. In embodiments, the polyisobutene has a number average molecular weight from 250 Da to 15,000,000 Da. In embodiments, the polyisobutene has a number average molecular weight from 250 Da to 10,000,000 Da. In embodiments, the polyisobutene has a number average molecular weight from 250 Da to 5,000,000 Da. In embodiments, the polyisobutene has a number average molecular weight from 250 Da to 2,000,000 Da. In embodiments, the polyisobutene has a number average molecular weight from 250 Da to 1,000,000 Da. In embodiments, the polyisobutene has a number average molecular weight from 250 Da to 500,000 Da. In embodiments, the polyisobutene has a number average molecular weight from 250 Da to 200,000 Da. In embodiments, the polyisobutene has a number average molecular weight from 250 Da to 100,000 Da. In embodiments, the polyisobutene has a number average molecular weight from 250 Da to 50,000 Da. In embodiments, the polyisobutene has a number average molecular weight from 250 Da to 20,000 Da. In embodiments, the polyisobutene has a number average molecular weight from 250 Da to 10,000 Da. In embodiments, the polyisobutene has a number average molecular weight from 250 Da to 5000 Da. In embodiments, the polyisobutene has a number average molecular weight from 250 Da to 2000 Da. In embodiments, the polyisobutene has a number average molecular weight from 250 Da to 1000 Da. In embodiments, the polyisobutene has a number average molecular weight from 500 Da to 20,000,000 Da. In embodiments, the polyisobutene has a number average molecular weight from 500 Da to 15,000,000 Da. In embodiments, the polyisobutene has a number average molecular weight from 500 Da to 10,000,000 Da. In embodiments, the polyisobutene has a number average molecular weight from 500 Da to 5,000,000 Da. In embodiments, the polyisobutene has a number average molecular weight from 500 Da to 2,000,000 Da. In embodiments, the polyisobutene has a number average molecular weight from 500 Da to 1,000,000 Da. In embodiments, the polyisobutene has a number average molecular weight from 500 Da to 500,000 Da. In embodiments, the polyisobutene has a number average molecular weight from 500 Da to 200,000 Da. In embodiments, the polyisobutene has a number average molecular weight from 500 Da to 100,000 Da. In embodiments, the polyisobutene has a number average molecular weight from 500 Da to 50,000 Da. In embodiments, the polyisobutene has a number average molecular weight from 500 Da to 20,000 Da. In embodiments, the polyisobutene has a number average molecular weight from 500 Da to 10,000 Da. In embodiments, the polyisobutene has a number average molecular weight from 500 Da to 5000 Da. In embodiments, the polyisobutene has a number average molecular weight from 500 Da to 2000 Da. In embodiments, the polyisobutene has a number average molecular weight from 500 Da to 1000 Da. In embodiments, the polyisobutene has a number average molecular weight from 750 Da to 20,000,000 Da. In embodiments, the polyisobutene has a number average molecular weight from 750 Da to 15,000,000 Da. In embodiments, the polyisobutene has a number average molecular weight from 750 Da to 10,000,000 Da. In embodiments, the polyisobutene has a number average molecular weight from 750 Da to 5,000,000 Da. In embodiments, the polyisobutene has a number average molecular weight from 750 Da to 2,000,000 Da. In embodiments, the polyisobutene has a number average molecular weight from 750 Da to 1,000,000 Da. In embodiments, the polyisobutene has a number average molecular weight from 750 Da to 500,000 Da. In embodiments, the polyisobutene has a number average molecular weight from 750 Da to 200,000 Da. In embodiments, the polyisobutene has a number average molecular weight from 750 Da to 100,000 Da. In embodiments, the polyisobutene has a number average molecular weight from 750 Da to 50,000 Da. In embodiments, the polyisobutene has a number average molecular weight from 750 Da to 20,000 Da. In embodiments, the polyisobutene has a number average molecular weight from 750 Da to 10,000 Da. In embodiments, the polyisobutene has a number average molecular weight from 750 Da to 5000 Da. In embodiments, the polyisobutene has a number average molecular weight from 750 Da to 2000 Da. In embodiments, the polyisobutene has a number average molecular weight from 750 Da to 1000 Da. In embodiments, the polyisobutene has a number average molecular weight from 1000 Da to 20,000,000 Da. In embodiments, the polyisobutene has a number average molecular weight from 1000 Da to 15,000,000 Da. In embodiments, the polyisobutene has a number average molecular weight from 1000 Da to 10,000,000 Da. In embodiments, the polyisobutene has a number average molecular weight from 1000 Da to 5,000,000 Da. In embodiments, the polyisobutene has a number average molecular weight from 1000 Da to 2,000,000 Da. In embodiments, the polyisobutene has a number average molecular weight from 1000 Da to 1,000,000 Da. In embodiments, the polyisobutene has a number average molecular weight from 1000 Da to 500,000 Da. In embodiments, the polyisobutene has a number average molecular weight from 1000 Da to 200,000 Da. In embodiments, the polyisobutene has a number average molecular weight from 1000 Da to 100,000 Da. In embodiments, the polyisobutene has a number average molecular weight from 1000 Da to 50,000 Da. In embodiments, the polyisobutene has a number average molecular weight from 1000 Da to 20,000 Da. In embodiments, the polyisobutene has a number average molecular weight from 1000 Da to 10,000 Da. In embodiments, the polyisobutene has a number average molecular weight from 1000 Da to 5000 Da. In embodiments, the polyisobutene has a number average molecular weight from 1000 Da to 2000 Da.

In embodiments, the polyisobutene has a number average molecular weight from about 250 Da to about 20,000,000 Da. In embodiments, the polyisobutene has a number average molecular weight from about 250 Da to about 15,000,000 Da. In embodiments, the polyisobutene has a number average molecular weight from about 250 Da to about 10,000,000 Da. In embodiments, the polyisobutene has a number average molecular weight from about 250 Da to about 5,000,000 Da. In embodiments, the polyisobutene has a number average molecular weight from about 250 Da to about 2,000,000 Da. In embodiments, the polyisobutene has a number average molecular weight from about 250 Da to about 1,000,000 Da. In embodiments, the polyisobutene has a number average molecular weight from about 250 Da to about 500,000 Da. In embodiments, the polyisobutene has a number average molecular weight from about 250 Da to about 200,000 Da. In embodiments, the polyisobutene has a number average molecular weight from about 250 Da to about 100,000 Da. In embodiments, the polyisobutene has a number average molecular weight from about 250 Da to about 50,000 Da. In embodiments, the polyisobutene has a number average molecular weight from about 250 Da to about 20,000 Da. In embodiments, the polyisobutene has a number average molecular weight from about 250 Da to about 10,000 Da. In embodiments, the polyisobutene has a number average molecular weight from about 250 Da to about 5000 Da. In embodiments, the polyisobutene has a number average molecular weight from about 250 Da to about 2000 Da. In embodiments, the polyisobutene has a number average molecular weight from about 250 Da to about 1000 Da. In embodiments, the polyisobutene has a number average molecular weight from about 500 Da to about 20,000,000 Da. In embodiments, the polyisobutene has a number average molecular weight from about 500 Da to about 15,000,000 Da. In embodiments, the polyisobutene has a number average molecular weight from about 500 Da to about 10,000,000 Da. In embodiments, the polyisobutene has a number average molecular weight from about 500 Da to about 5,000,000 Da. In embodiments, the polyisobutene has a number average molecular weight from about 500 Da to about 2,000,000 Da. In embodiments, the polyisobutene has a number average molecular weight from about 500 Da to about 1,000,000 Da. In embodiments, the polyisobutene has a number average molecular weight from about 500 Da to about 500,000 Da. In embodiments, the polyisobutene has a number average molecular weight from about 500 Da to about 200,000 Da. In embodiments, the polyisobutene has a number average molecular weight from about 500 Da to about 100,000 Da. In embodiments, the polyisobutene has a number average molecular weight from about 500 Da to about 50,000 Da. In embodiments, the polyisobutene has a number average molecular weight from about 500 Da to about 20,000 Da. In embodiments, the polyisobutene has a number average molecular weight from about 500 Da to about 10,000 Da. In embodiments, the polyisobutene has a number average molecular weight from about 500 Da to about 5000 Da. In embodiments, the polyisobutene has a number average molecular weight from about 500 Da to about 2000 Da. In embodiments, the polyisobutene has a number average molecular weight from about 500 Da to about 1000 Da. In embodiments, the polyisobutene has a number average molecular weight from about 750 Da to about 20,000,000 Da. In embodiments, the polyisobutene has a number average molecular weight from about 750 Da to about 15,000,000 Da. In embodiments, the polyisobutene has a number average molecular weight from about 750 Da to about 10,000,000 Da. In embodiments, the polyisobutene has a number average molecular weight from about 750 Da to about 5,000,000 Da. In embodiments, the polyisobutene has a number average molecular weight from about 750 Da to about 2,000,000 Da. In embodiments, the polyisobutene has a number average molecular weight from about 750 Da to about 1,000,000 Da. In embodiments, the polyisobutene has a number average molecular weight from about 750 Da to about 500,000 Da. In embodiments, the polyisobutene has a number average molecular weight from about 750 Da to about 200,000 Da. In embodiments, the polyisobutene has a number average molecular weight from about 750 Da to about 100,000 Da. In embodiments, the polyisobutene has a number average molecular weight from about 750 Da to about 50,000 Da. In embodiments, the polyisobutene has a number average molecular weight from about 750 Da to about 20,000 Da. In embodiments, the polyisobutene has a number average molecular weight from about 750 Da to about 10,000 Da. In embodiments, the polyisobutene has a number average molecular weight from about 750 Da to about 5000 Da. In embodiments, the polyisobutene has a number average molecular weight from about 750 Da to about 2000 Da. In embodiments, the polyisobutene has a number average molecular weight from about 750 Da to about 1000 Da. In embodiments, the polyisobutene has a number average molecular weight from about 1000 Da to about 20,000,000 Da. In embodiments, the polyisobutene has a number average molecular weight from about 1000 Da to about 15,000,000 Da. In embodiments, the polyisobutene has a number average molecular weight from about 1000 Da to about 10,000,000 Da. In embodiments, the polyisobutene has a number average molecular weight from about 1000 Da to about 5,000,000 Da. In embodiments, the polyisobutene has a number average molecular weight from about 1000 Da to about 2,000,000 Da. In embodiments, the polyisobutene has a number average molecular weight from about 1000 Da to about 1,000,000 Da. In embodiments, the polyisobutene has a number average molecular weight from about 1000 Da to about 500,000 Da. In embodiments, the polyisobutene has a number average molecular weight from about 1000 Da to about 200,000 Da. In embodiments, the polyisobutene has a number average molecular weight from about 1000 Da to about 100,000 Da. In embodiments, the polyisobutene has a number average molecular weight from about 1000 Da to about 50,000 Da. In embodiments, the polyisobutene has a number average molecular weight from about 1000 Da to about 20,000 Da. In embodiments, the polyisobutene has a number average molecular weight from about 1000 Da to about 10,000 Da. In embodiments, the polyisobutene has a number average molecular weight from about 1000 Da to about 5000 Da. In embodiments, the polyisobutene has a number average molecular weight from about 1000 Da to about 2000 Da.

In embodiments, the polyisobutene has from 5 to 300,000 number of total subunits. In embodiments, the polyisobutene has from 5 to 200,000 number of total subunits. In embodiments, the polyisobutene has from 5 to 150,000 number of total subunits. In embodiments, the polyisobutene has from 5 to 100,000 number of total subunits. In embodiments, the polyisobutene has from 5 to 50,000 number of total subunits. In embodiments, the polyisobutene has from 5 to 20,000 number of total subunits. In embodiments, the polyisobutene has from 5 to 10,000 number of total subunits. In embodiments, the polyisobutene has from 5 to 5000 number of total subunits. In embodiments, the polyisobutene has from 5 to 2000 number of total subunits. In embodiments, the polyisobutene has from 5 to 1000 number of total subunits. In embodiments, the polyisobutene has from 5 to 500 number of total subunits. In embodiments, the polyisobutene has from 5 to 200 number of total subunits. In embodiments, the polyisobutene has from 5 to 100 number of total subunits. In embodiments, the polyisobutene has from 5 to 50 number of total subunits. In embodiments, the polyisobutene has from 5 to 20 number of total subunits. In embodiments, the polyisobutene has from 10 to 300,000 number of total subunits. In embodiments, the polyisobutene has from 10 to 200,000 number of total subunits. In embodiments, the polyisobutene has from 10 to 150,000 number of total subunits. In embodiments, the polyisobutene has from 10 to 100,000 number of total subunits. In embodiments, the polyisobutene has from 10 to 50,000 number of total subunits. In embodiments, the polyisobutene has from 10 to 20,000 number of total subunits. In embodiments, the polyisobutene has from 10 to 10,000 number of total subunits. In embodiments, the polyisobutene has from 10 to 5000 number of total subunits. In embodiments, the polyisobutene has from 10 to 2000 number of total subunits. In embodiments, the polyisobutene has from 10 to 1000 number of total subunits. In embodiments, the polyisobutene has from 10 to 500 number of total subunits. In embodiments, the polyisobutene has from 10 to 200 number of total subunits. In embodiments, the polyisobutene has from 10 to 100 number of total subunits. In embodiments, the polyisobutene has from 10 to 50 number of total subunits. In embodiments, the polyisobutene has from 10 to 20 number of total subunits. In embodiments, the polyisobutene has from 15 to 300,000 number of total subunits. In embodiments, the polyisobutene has from 15 to 200,000 number of total subunits. In embodiments, the polyisobutene has from 15 to 150,000 number of total subunits. In embodiments, the polyisobutene has from 15 to 100,000 number of total subunits. In embodiments, the polyisobutene has from 15 to 50,000 number of total subunits. In embodiments, the polyisobutene has from 15 to 20,000 number of total subunits. In embodiments, the polyisobutene has from 15 to 10,000 number of total subunits. In embodiments, the polyisobutene has from 15 to 5000 number of total subunits. In embodiments, the polyisobutene has from 15 to 2000 number of total subunits. In embodiments, the polyisobutene has from 15 to 1000 number of total subunits. In embodiments, the polyisobutene has from 15 to 500 number of total subunits. In embodiments, the polyisobutene has from 15 to 200 number of total subunits. In embodiments, the polyisobutene has from 15 to 100 number of total subunits. In embodiments, the polyisobutene has from 15 to 50 number of total subunits. In embodiments, the polyisobutene has from 15 to 20 number of total subunits. In embodiments, the polyisobutene has from 20 to 300,000 number of total subunits. In embodiments, the polyisobutene has from 20 to 200,000 number of total subunits. In embodiments, the polyisobutene has from 20 to 150,000 number of total subunits. In embodiments, the polyisobutene has from 20 to 100,000 number of total subunits. In embodiments, the polyisobutene has from 20 to 50,000 number of total subunits. In embodiments, the polyisobutene has from 20 to 20,000 number of total subunits. In embodiments, the polyisobutene has from 20 to 10,000 number of total subunits. In embodiments, the polyisobutene has from 20 to 5000 number of total subunits. In embodiments, the polyisobutene has from 20 to 2000 number of total subunits. In embodiments, the polyisobutene has from 20 to 1000 number of total subunits. In embodiments, the polyisobutene has from 20 to 500 number of total subunits. In embodiments, the polyisobutene has from 20 to 200 number of total subunits. In embodiments, the polyisobutene has from 20 to 100 number of total subunits. In embodiments, the polyisobutene has from 20 to 50 number of total subunits.

In embodiments, the polyisobutene has from about 5 to about 300,000 number of total subunits. In embodiments, the polyisobutene has from about 5 to about 200,000 number of total subunits. In embodiments, the polyisobutene has from about 5 to about 150,000 number of total subunits. In embodiments, the polyisobutene has from about 5 to about 100,000 number of total subunits. In embodiments, the polyisobutene has from about 5 to about 50,000 number of total subunits. In embodiments, the polyisobutene has from about 5 to about 20,000 number of total subunits. In embodiments, the polyisobutene has from about 5 to about 10,000 number of total subunits. In embodiments, the polyisobutene has from about 5 to about 5000 number of total subunits. In embodiments, the polyisobutene has from about 5 to about 2000 number of total subunits. In embodiments, the polyisobutene has from about 5 to about 1000 number of total subunits. In embodiments, the polyisobutene has from about 5 to about 500 number of total subunits. In embodiments, the polyisobutene has from about 5 to about 200 number of total subunits. In embodiments, the polyisobutene has from about 5 to about 100 number of total subunits. In embodiments, the polyisobutene has from about 5 to about 50 number of total subunits. In embodiments, the polyisobutene has from about 5 to about 20 number of total subunits. In embodiments, the polyisobutene has from about 10 to about 300,000 number of total subunits. In embodiments, the polyisobutene has from about 10 to about 200,000 number of total subunits. In embodiments, the polyisobutene has from about 10 to about 150,000 number of total subunits. In embodiments, the polyisobutene has from about 10 to about 100,000 number of total subunits. In embodiments, the polyisobutene has from about 10 to about 50,000 number of total subunits. In embodiments, the polyisobutene has from about 10 to about 20,000 number of total subunits. In embodiments, the polyisobutene has from about 10 to about 10,000 number of total subunits. In embodiments, the polyisobutene has from about 10 to about 5000 number of total subunits. In embodiments, the polyisobutene has from about 10 to about 2000 number of total subunits. In embodiments, the polyisobutene has from about 10 to about 1000 number of total subunits. In embodiments, the polyisobutene has from about 10 to about 500 number of total subunits. In embodiments, the polyisobutene has from about 10 to about 200 number of total subunits. In embodiments, the polyisobutene has from about 10 to about 100 number of total subunits. In embodiments, the polyisobutene has from about 10 to about 50 number of total subunits. In embodiments, the polyisobutene has from about 10 to about 20 number of total subunits. In embodiments, the polyisobutene has from about 15 to about 300,000 number of total subunits. In embodiments, the polyisobutene has from about 15 to about 200,000 number of total subunits. In embodiments, the polyisobutene has from about 15 to about 150,000 number of total subunits. In embodiments, the polyisobutene has from about 15 to about 100,000 number of total subunits. In embodiments, the polyisobutene has from about 15 to about 50,000 number of total subunits. In embodiments, the polyisobutene has from about 15 to about 20,000 number of total subunits. In embodiments, the polyisobutene has from about 15 to about 10,000 number of total subunits. In embodiments, the polyisobutene has from about 15 to about 5000 number of total subunits. In embodiments, the polyisobutene has from about 15 to about 2000 number of total subunits. In embodiments, the polyisobutene has from about 15 to about 1000 number of total subunits. In embodiments, the polyisobutene has from about 15 to about 500 number of total subunits. In embodiments, the polyisobutene has from about 15 to about 200 number of total subunits. In embodiments, the polyisobutene has from about 15 to about 100 number of total subunits. In embodiments, the polyisobutene has from about 15 to about 50 number of total subunits. In embodiments, the polyisobutene has from about 15 to about 20 number of total subunits. In embodiments, the polyisobutene has from about 20 to about 300,000 number of total subunits. In embodiments, the polyisobutene has from about 20 to about 200,000 number of total subunits. In embodiments, the polyisobutene has from about 20 to about 150,000 number of total subunits. In embodiments, the polyisobutene has from about 20 to about 100,000 number of total subunits. In embodiments, the polyisobutene has from about 20 to about 50,000 number of total subunits. In embodiments, the polyisobutene has from about 20 to about 20,000 number of total subunits. In embodiments, the polyisobutene has from about 20 to about 10,000 number of total subunits. In embodiments, the polyisobutene has from about 20 to about 5000 number of total subunits. In embodiments, the polyisobutene has from about 20 to about 2000 number of total subunits. In embodiments, the polyisobutene has from about 20 to about 1000 number of total subunits. In embodiments, the polyisobutene has from about 20 to about 500 number of total subunits. In embodiments, the polyisobutene has from about 20 to about 200 number of total subunits. In embodiments, the polyisobutene has from about 20 to about 100 number of total subunits. In embodiments, the polyisobutene has from about 20 to about 50 number of total subunits.

In embodiments, the metal catalyst is a ruthenium catalyst, a manganese catalyst, an iron catalyst, or a nickel catalyst. In embodiments, the metal catalyst is a ruthenium catalyst, an iron catalyst, or a nickel catalyst. In embodiments, the metal catalyst is a ruthenium catalyst. In embodiments, the metal catalyst is a ruthenium porphyrin catalyst. In embodiments, the metal catalyst is a manganese catalyst. In embodiments, the metal catalyst is an iron catalyst. In embodiments, the metal catalyst is a nickel catalyst.

In embodiments, the metal catalyst is

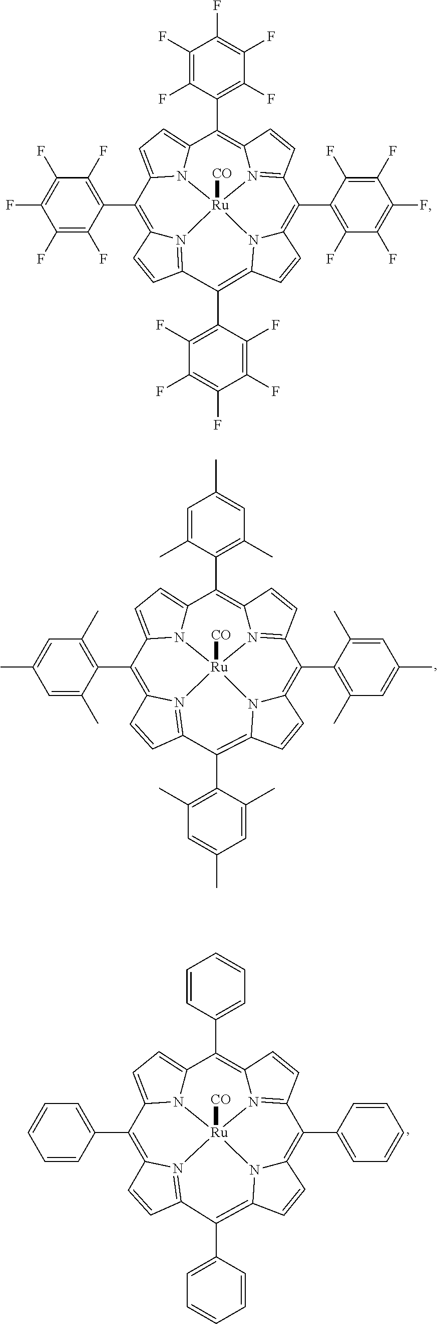

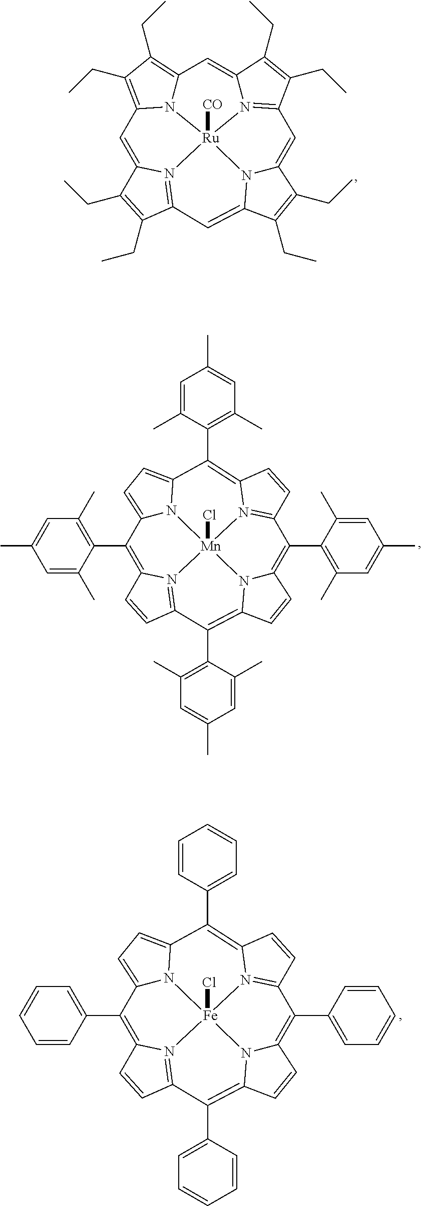

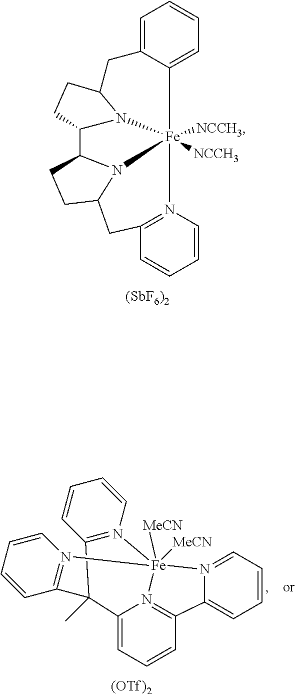

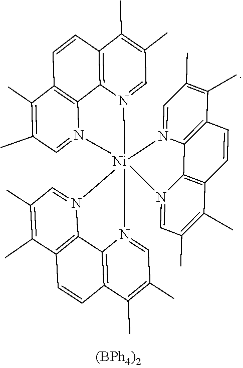

In embodiments, the metal catalyst is

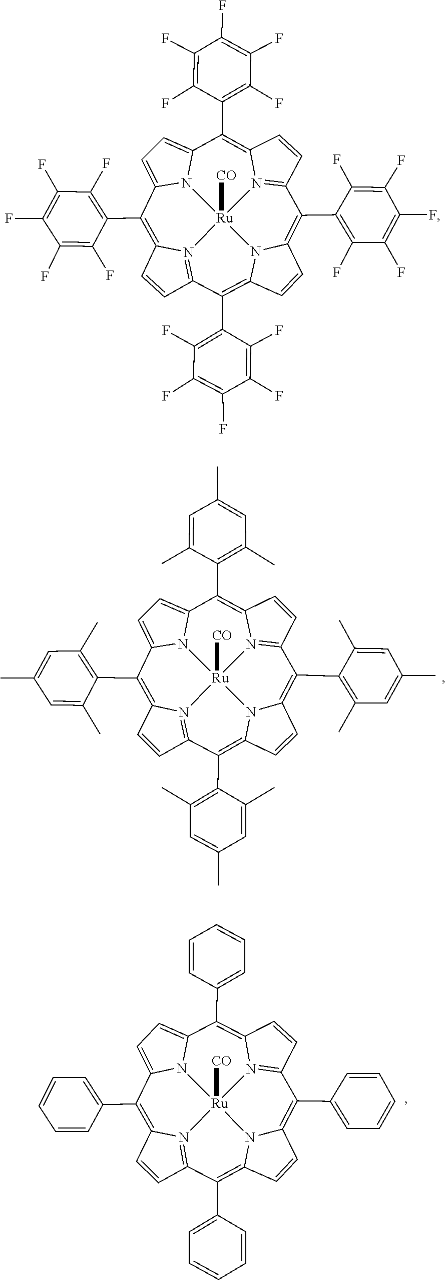

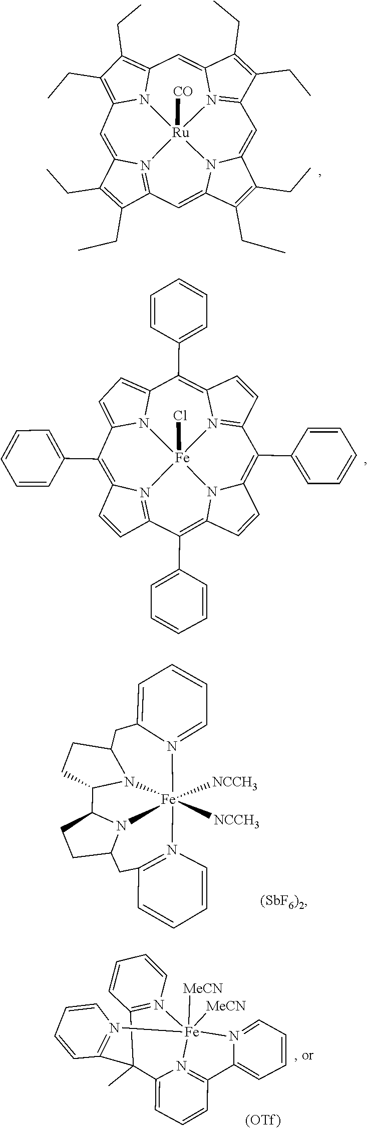

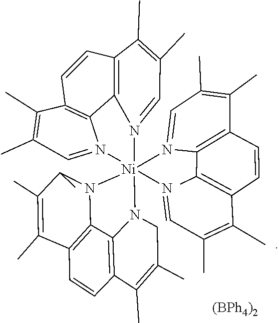

In embodiments, the metal catalyst is

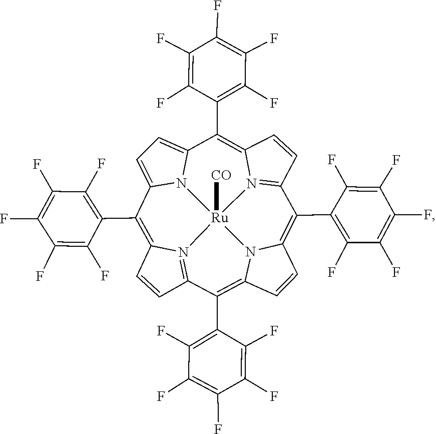

In embodiments, the metal catalyst is

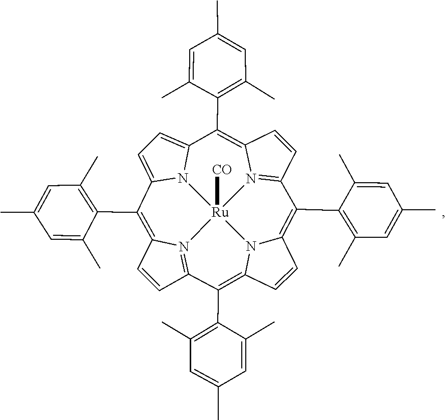

In embodiments, the metal catalyst is

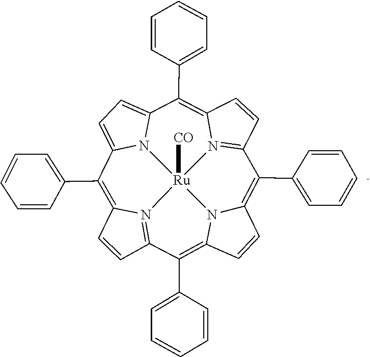

In embodiments, the metal catalyst is

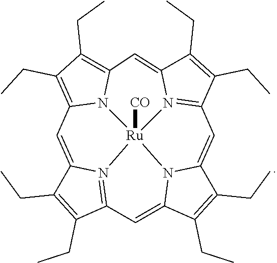

In embodiments, the metal catalyst is

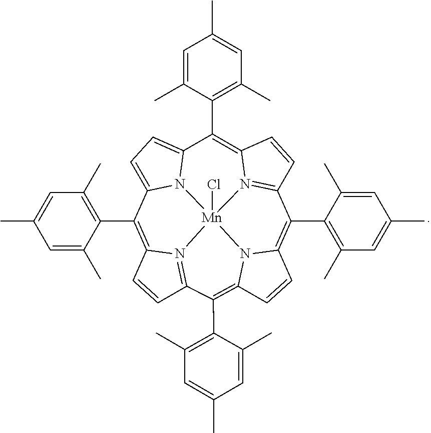

In embodiments, the metal catalyst is

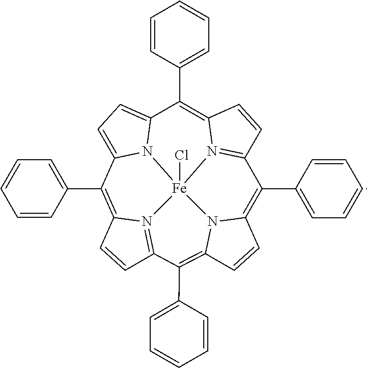

In embodiments, the metal catalyst is

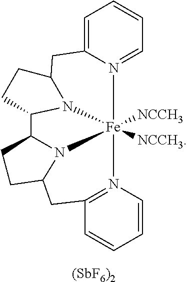

In embodiments, the metal catalyst is

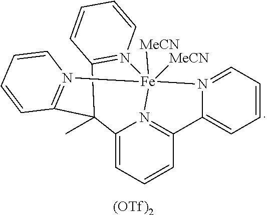

In embodiments, the metal catalyst is

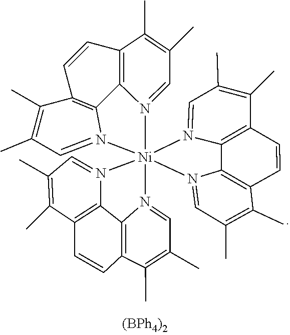

In embodiments, the metal catalyst is not a manganese catalyst. In embodiments, the metal catalyst is not a manganese porphyrin catalyst. In embodiments, the metal catalyst is not

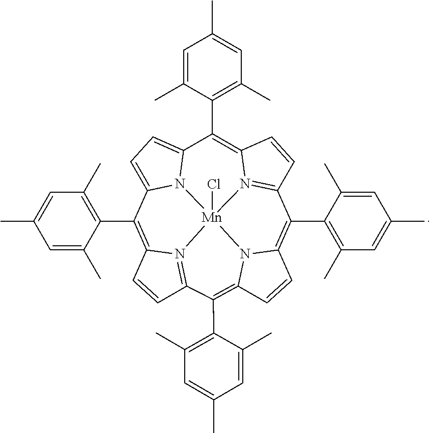

In embodiments, the metal catalyst is not an iron catalyst. In embodiments, the metal catalyst is not an iron porphyrin catalyst. In embodiments, the metal catalyst is not

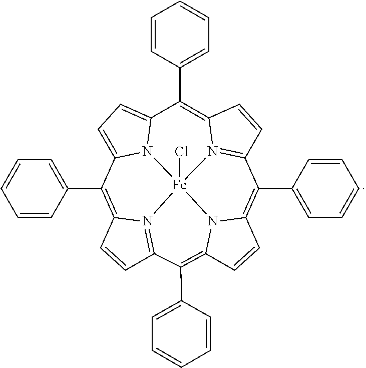

In embodiments, the one or more additional compounds is the oxidizing agent and the vessel does not include the reducing agent. In embodiments, the one or more additional compounds is the oxidizing agent. In embodiments, the vessel does not include the reducing agent. In embodiments, the vessel includes the hydroxylated polyisobutene and the oxidizing agent.

In embodiments, the oxidizing agent is a peroxide or a substituted pyridine N-oxide.

In embodiments, the oxidizing agent is

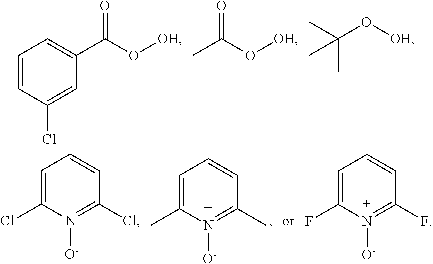

In embodiments, the oxidizing agent is

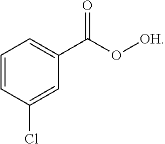 [SMILES: O=C(OO)c1cccc(Cl)c1]

In embodiments, the oxidizing agent is

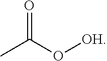

In embodiments, the oxidizing agent is

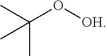

In embodiments, the oxidizing agent is

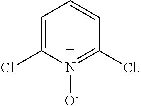

In embodiments, the oxidizing agent is

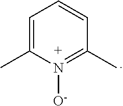

In embodiments, the oxidizing agent is

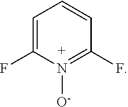

In embodiments, the one or more additional compound is the reducing agent and the vessel does not include the oxidizing agent. In embodiments, the one or more additional compound is the reducing agent. In embodiments, the vessel does not include the oxidizing agent. In embodiments, the vessel includes the oxidized polyisobutene and the reducing agent.

In embodiments, the reducing agent is an aluminum hydride or a boron hydride. In embodiments, the reducing agent is an aluminum hydride. In embodiments, the reducing agent is a boron hydride.

In embodiments, the reducing agent is lithium aluminum hydride, sodium bis(2-methoxyethoxy)aluminum hydride, or lithium triethylborohydride. In embodiments, the reducing agent is lithium aluminum hydride. In embodiments, the reducing agent is sodium bis(2-methoxyethoxy)aluminum hydride. In embodiments, the reducing agent is lithium triethylborohydride.

In an aspect is provided a mixture of polymers including an oxidized polyisobutene and a second polymer. The oxidized polyisobutene is as described herein, including in embodiments.

In an aspect is provided a cross-linked polymer and a second polymer. The cross-linked polymer is as described herein, including in embodiments.

In embodiments, the second polymer is a high-density polyethylene, a low-density polyethylene, or a linear low-density polyethylene. In embodiments, the second polymer is a high-density polyethylene. In embodiments, the second polymer is a low-density polyethylene. In embodiments, the second polymer is a linear low-density polyethylene.

### IV. Methods of Making

In an aspect is provided a method of making an oxidized polyisobutene, including mixing a polyisobutene, a metal catalyst, and an oxidizing agent. The oxidized polyisobutene, polyisobutene, metal catalyst, and oxidizing agent are as described herein, including in embodiments.

In embodiments, the method of making an oxidized polyisobutene includes mixing a polyisobutene, a metal catalyst, and an oxidizing agent. In embodiments, the polyisobutene comprises a non-oxidized subunit. In embodiments, the oxidized polyisobutene includes a first oxidized subunit and a non-oxidized subunit as described herein.

In embodiments, the ratio of the first oxidized subunit to the non-oxidized subunit is from 1:1000 to 1:10.

In embodiments, the oxidized polyisobutene has a number average molecular weight from 500 Da to 2,000,000 Da.

In embodiments, the metal catalyst is a ruthenium catalyst, a manganese catalyst, an iron catalyst, or a nickel catalyst. In embodiments, the metal catalyst is a ruthenium catalyst, an iron catalyst, or a nickel catalyst. In embodiments, the metal catalyst is a ruthenium catalyst. In embodiments, the metal catalyst is a ruthenium porphyrin catalyst. In embodiments, the metal catalyst is a manganese catalyst. In embodiments, the metal catalyst is an iron catalyst. In embodiments, the metal catalyst is a nickel catalyst.

In embodiments, the metal catalyst is

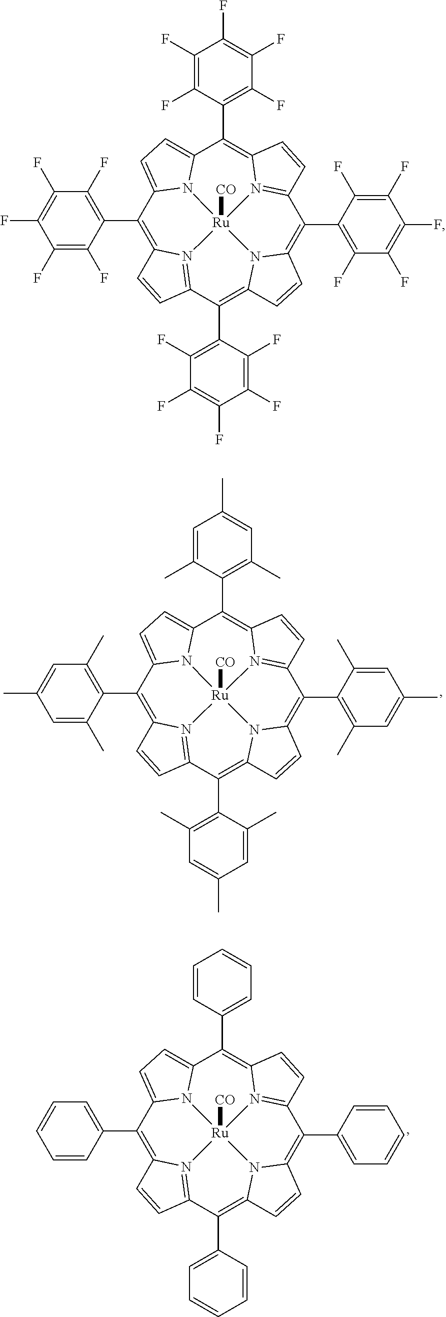

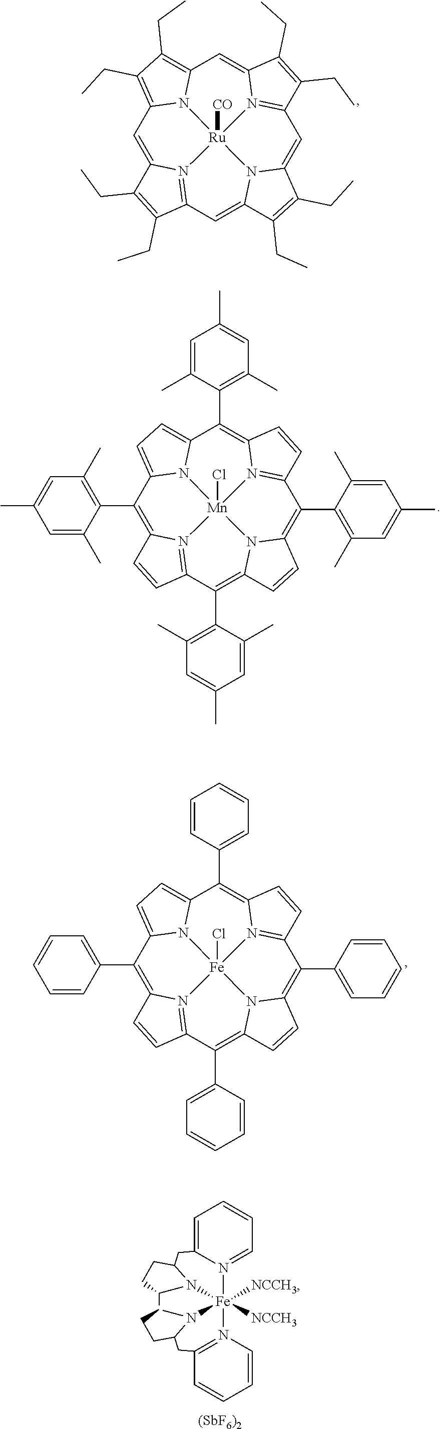

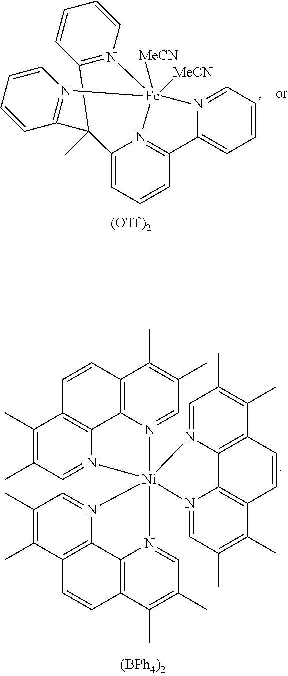

In embodiments, the metal catalyst is

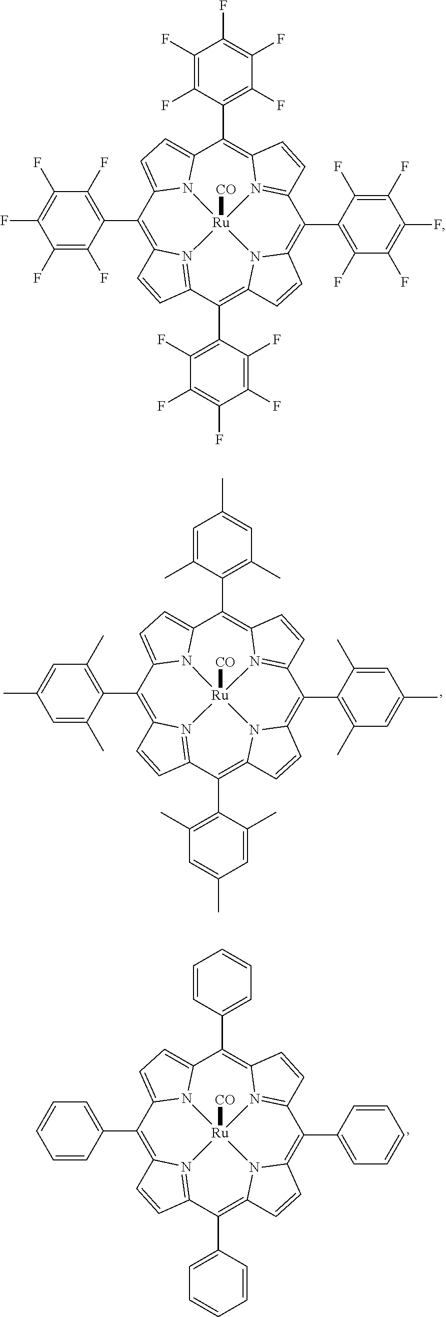

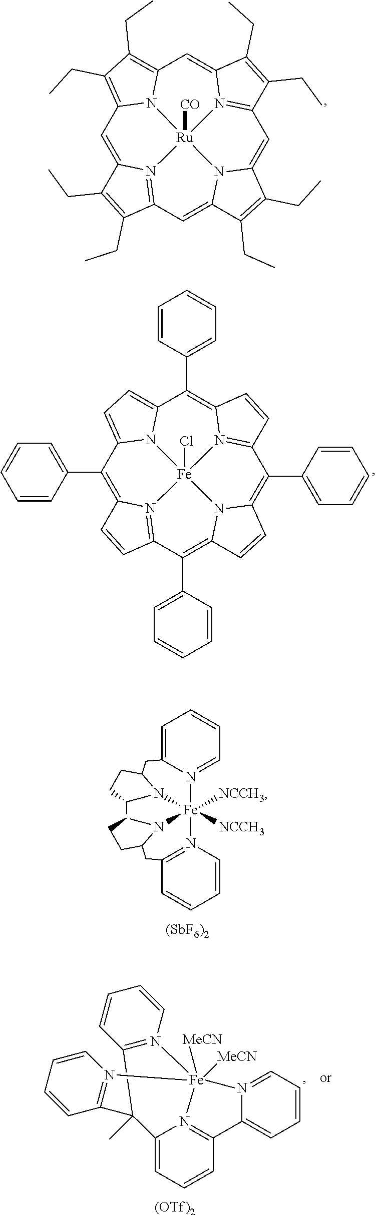

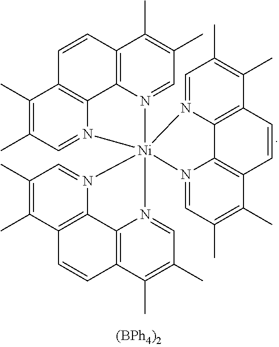

In embodiments, the metal catalyst is

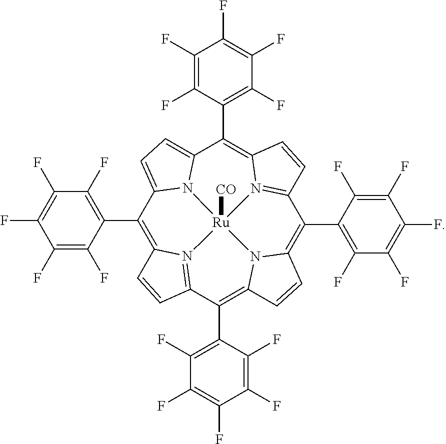

In embodiments, the metal catalyst is

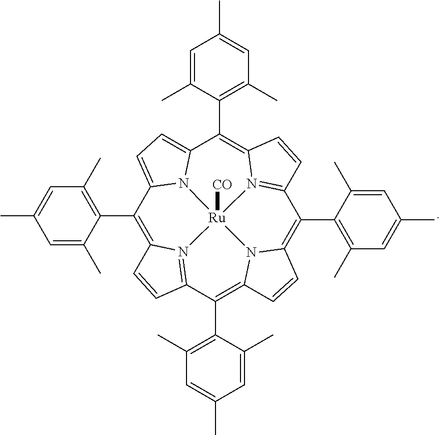

In embodiments the metal catalyst is

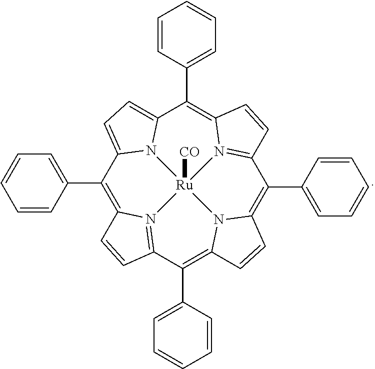

In embodiments, the metal catalyst is

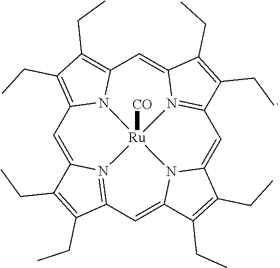

In embodiments, the metal catalyst is

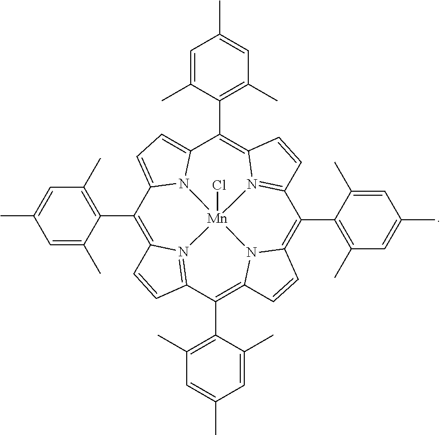

In embodiments, the metal catalyst is

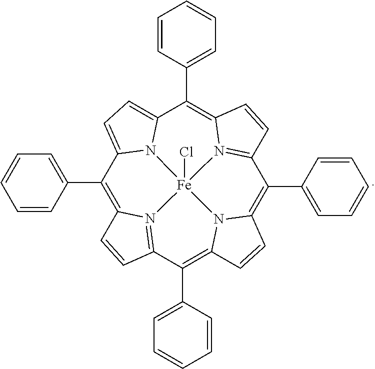

In embodiments, the metal catalyst is

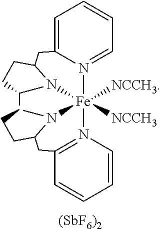

In embodiments, the metal catalyst is

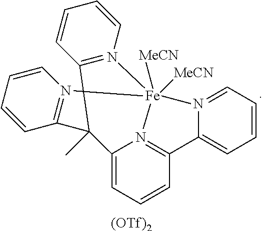

In embodiments, the metal catalyst is

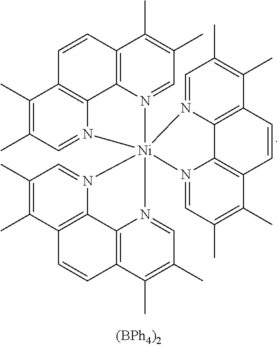

In embodiments, the metal catalyst is not a manganese catalyst. In embodiments, the metal catalyst is not a manganese porphyrin catalyst. In embodiments, the metal catalyst is not

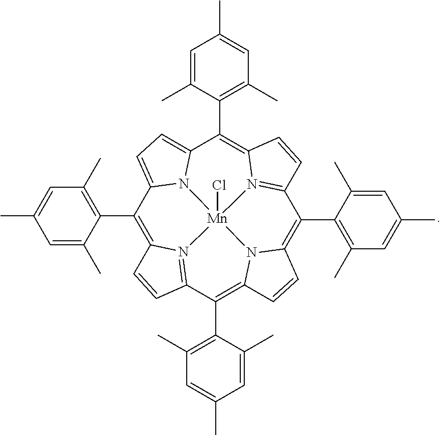

In embodiments, the metal catalyst is not an iron catalyst. In embodiments, the metal catalyst is not an iron porphyrin catalyst. In embodiments, the metal catalyst is not

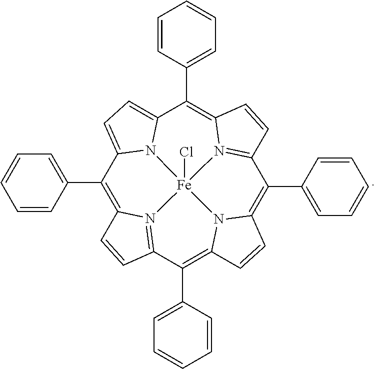

In embodiments, the oxidizing agent is a peroxide or a substituted pyridine N-oxide. In embodiments, the oxidizing agent is a peroxide or a substituted pyridine N-oxide. In embodiments, the oxidizing agent is selected from

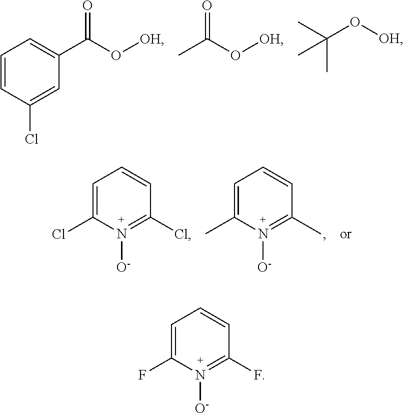

In embodiments, the oxidizing agent is

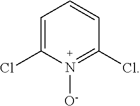

In embodiments, the method further includes contacting the oxidized polyethylene with a reducing agent thereby forming a reduced-oxidized polyethylene, wherein the first oxidized subunit is reduced to form a reduced subunit having the formula

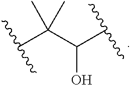 [SMILES: *C(O)C(*)(C)C]

In embodiments,
the oxidized polyisobutene includes a first oxidized subunit, a second oxidized submit having the formula

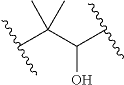 [SMILES: *C(O)C(*)(C)C]

and a non-oxidized subunit.

In embodiments, the reducing agent is an aluminum hydride or a boron hydride. In embodiments, the reducing agent is an aluminum hydride. In embodiments, the reducing agent is a boron hydride.

In embodiments, the reducing agent is lithium aluminum hydride, sodium bis(2-methoxyethoxy)aluminum hydride, or lithium triethylborohydride. In embodiments, the reducing agent is lithium aluminum hydride. In embodiments, the reducing agent is sodium bis(2-methoxyethoxy)aluminum hydride. In embodiments, the reducing agent is lithium triethylborohydride.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

### V. Embodiments P

Embodiment P1. A method of making an oxidized polyisobutene, comprising mixing a polyisobutene, a metal catalyst, and an oxidizing agent;

wherein
the oxidized polyisobutene comprises a first oxidized subunit and a non-oxidized subunit;
the polyisobutene comprises a non-oxidized subunit;
the first oxidized subunit has the formula:

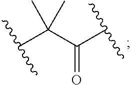 [SMILES: *C(=O)C(*)(C)C]

the non-oxidized subunit has the formula:

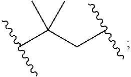 [SMILES: *CC(*)(C)C]

the ratio of the first oxidized subunit to the non-oxidized subunit is from 1:10,000 to 1:5; and
the oxidized polyisobutene has a number average molecular weight from 250 Da to 20,000,000 Da.

Embodiment P2. The method of Embodiment P1, wherein the ratio of the first oxidized subunit to the non-oxidized subunit is from 1:1000 to 1:10.

Embodiment P3. The method of one of Embodiments P1 to P2, wherein the oxidized polyisobutene has a number average molecular weight from 500 Da to 2,000,000 Da.

Embodiment P4. The method of one of Embodiments P1 to P3, wherein the metal catalyst is a ruthenium catalyst, an iron catalyst, or a nickel catalyst.

Embodiment P5. The method of one of Embodiments P1 to P3, wherein the metal catalyst is

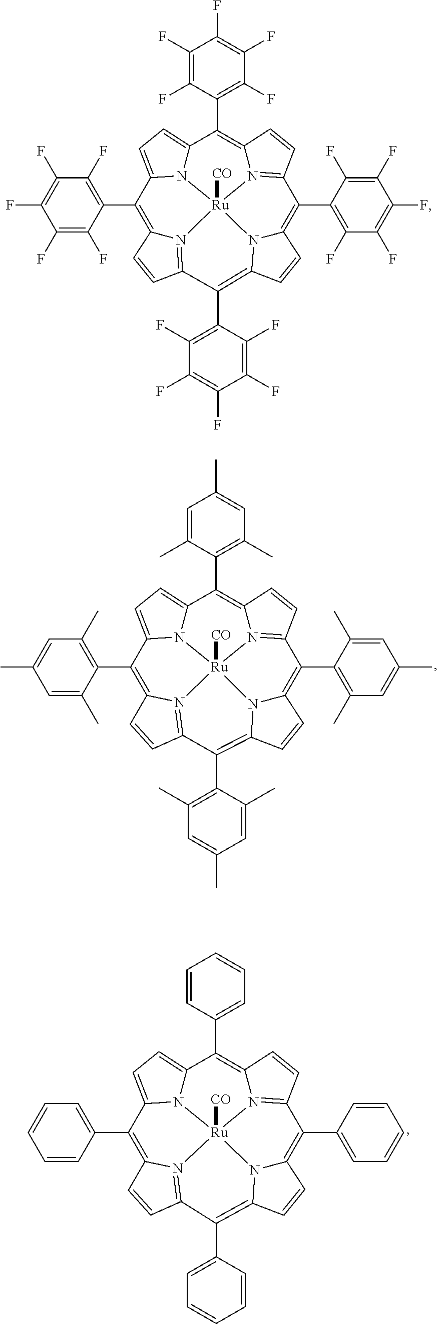

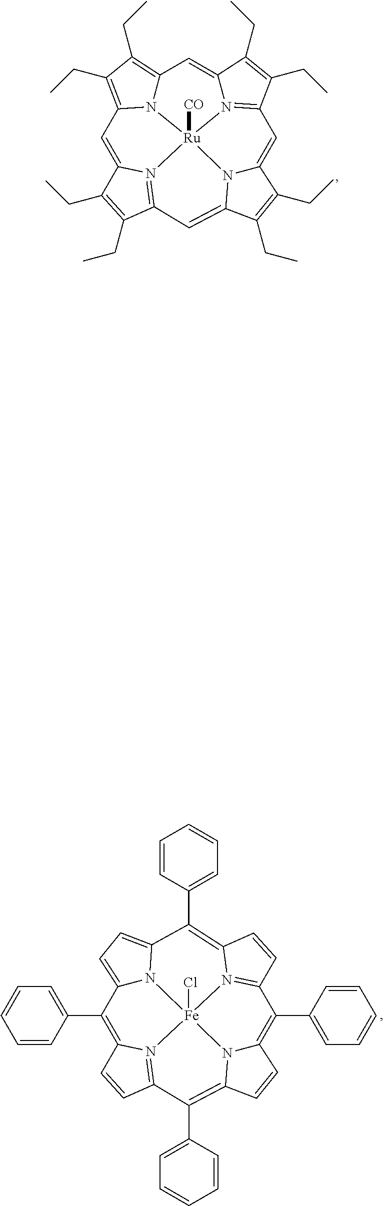

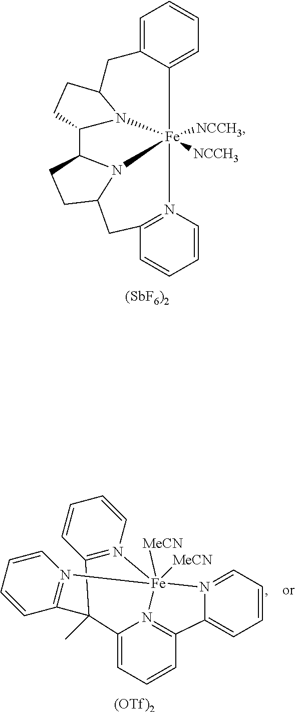

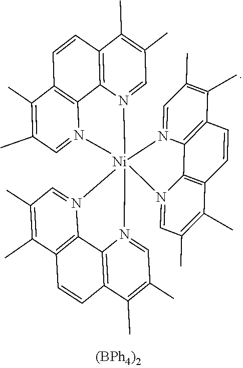

Embodiment P6. The method of one of Embodiments P1 to P3, wherein the metal catalyst is

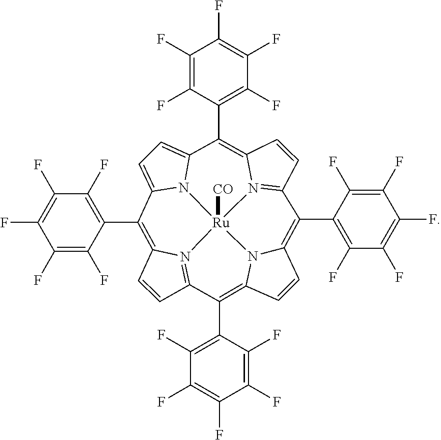

Embodiment P7. The method of one of Embodiments P1 to P6, wherein the oxidizing agent is a peroxide or a substituted pyridine N-oxide.

Embodiment P8. The method of one of Embodiments P1 to P6, wherein the oxidizing agent is

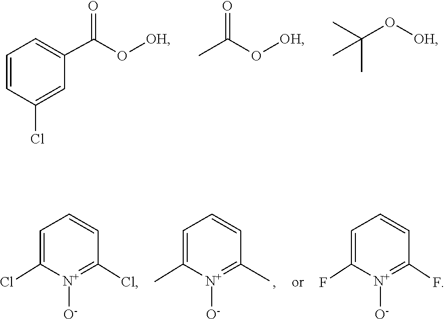

Embodiment P9. The method of one of Embodiments P1 to P6, wherein the oxidizing agent is

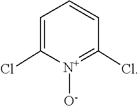

Embodiment P10. An oxidized polyisobutene in a vessel comprising an oxidized polyisobutene and one or more additional compounds selected from the groups consisting of: (i) a metal catalyst; (ii) an oxidizing agent; (iii) a reducing agent; (iv) a polyisobutene; and (v) a hydroxylated polyisobutene;
wherein
the oxidized polyisobutene comprises a first oxidized subunit and a non-oxidized subunit;
the polyisobutene comprises a non-oxidized subunit;
the hydroxylated polyisobutene comprises a second oxidized subunit and a non-oxidized subunit;
the first oxidized subunit has the formula:

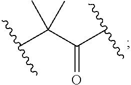 [SMILES: *C(=O)C(*)(C)C]

the second oxidized subunit has the formula:

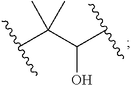 [SMILES: *C(O)C(*)(C)C]

the non-oxidized subunit has the formula:

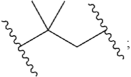 [SMILES: *CC(*)(C)C]

the ratio of the first oxidized subunit to the non-oxidized subunit in the oxidized polyisobutene is from 1:10,000 to 1:5;
the oxidized polyisobutene has a number average molecular weight from 250 Da to 20,000,000 Da; and
the hydroxylated polyisobutene has a number average molecular weight from 250 Da to 20,000,000 Da.

Embodiment P11. The oxidized polyisobutene in a vessel of Embodiment P10, wherein the ratio of the first oxidized subunit to the non-oxidized subunit in the oxidized polyisobutene is from 1:1000 to 1:10.

Embodiment P12. The oxidized polyisobutene in a vessel of one of Embodiments P10 to P11, wherein the oxidized polyisobutene has a number average molecular weight from 500 Da to 2,000,000 Da.

Embodiment P13. The oxidized polyisobutene in a vessel of one of Embodiments P10 to P12, wherein the hydroxylated polyisobutene has a number average molecular weight from 500 Da to 2,000,000 Da.

Embodiment P14. The oxidized polyisobutene in a vessel of one of Embodiments P10 to P13, wherein the metal catalyst is a ruthenium catalyst, an iron catalyst, or a nickel catalyst.

Embodiment P15. The oxidized polyisobutene in a vessel of one of Embodiments P10 to P13, wherein the metal catalyst is

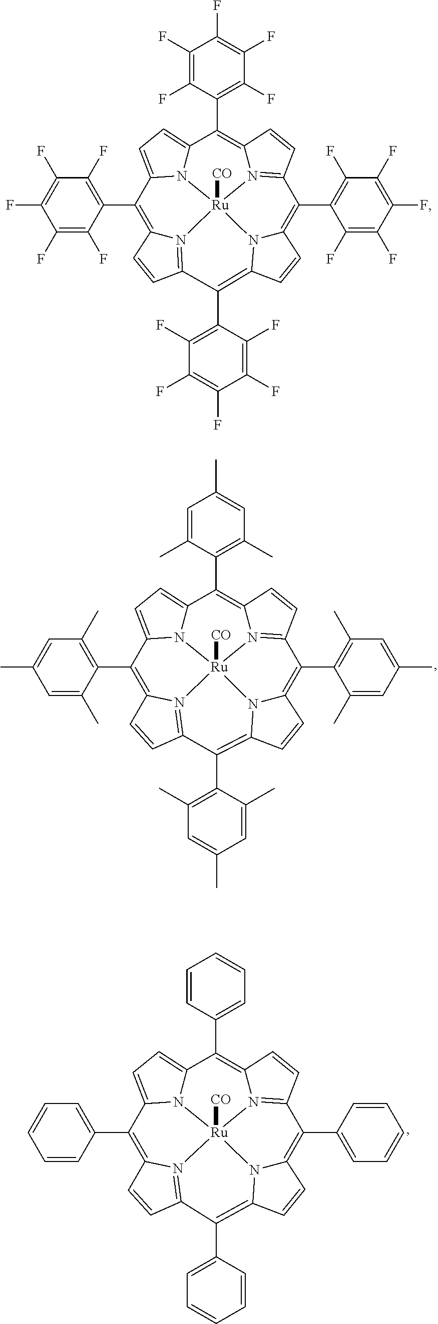

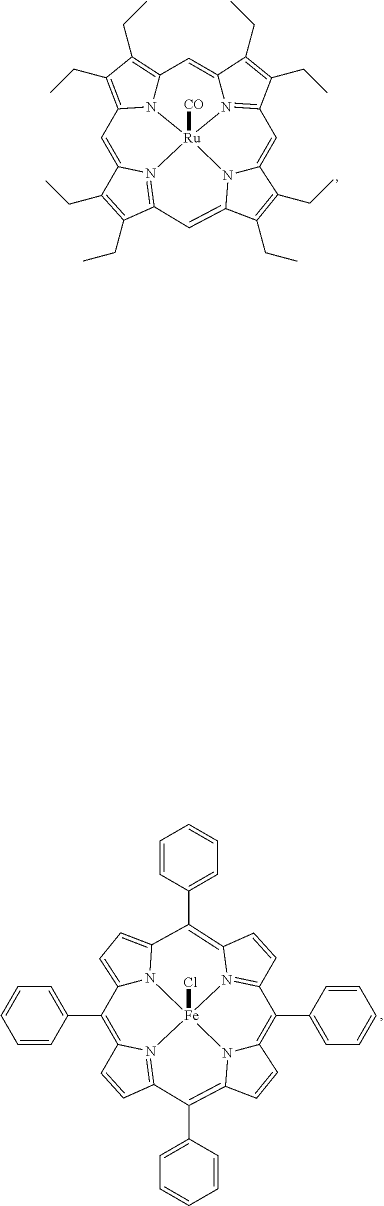

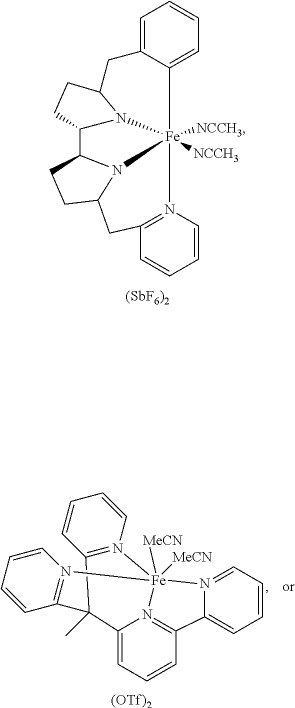

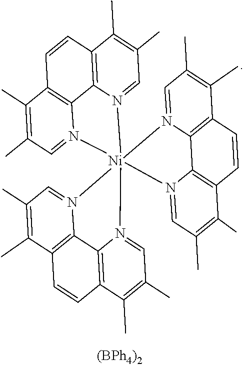

Embodiment P16. The oxidized polyisobutene in a vessel of one of Embodiments P10 to P13, wherein the metal catalyst is

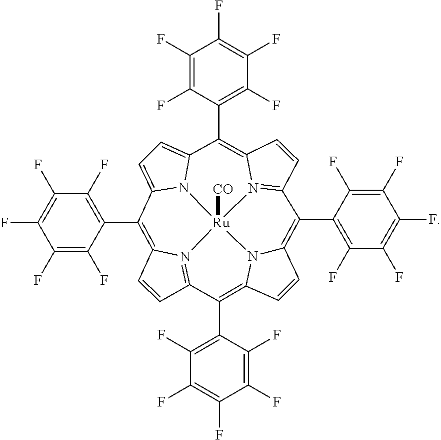

Embodiment P17. The oxidized polyisobutene in a vessel of one of Embodiments P10 to P16, wherein the oxidizing agent is a peroxide or a substituted pyridine N-oxide.

Embodiment P18. The oxidized polyisobutene in a vessel of one of Embodiments P10 to P16, wherein the oxidizing agent is

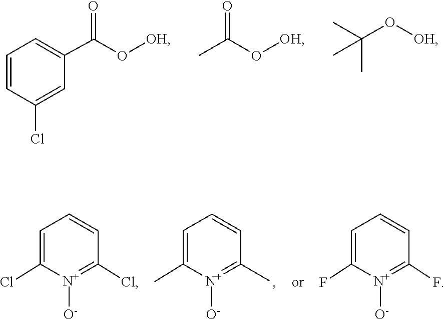

Embodiment P19. The oxidized polyisobutene in a vessel of one of Embodiments P10 to P16, wherein the oxidizing agent is

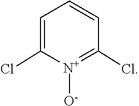

Embodiment P20. The oxidized polyisobutene in a vessel of one of Embodiments P10 to P19, wherein the reducing agent is an aluminum hydride or a boron hydride.

Embodiment P21. The oxidized polyisobutene in a vessel of one of Embodiments P10 to P19, wherein the reducing agent is lithium aluminum hydride, sodium bis(2-methoxyethoxy)aluminum hydride, or lithium triethylborohydride.

Embodiment P22. An oxidized polyisobutene, comprising a first oxidized subunit and a non-oxidized subunit;
the first oxidized subunit has the formula:

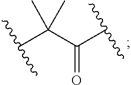 [SMILES: *C(=O)C(*)(C)C]

the non-oxidized subunit has the formula:

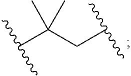 [SMILES: *CC(*)(C)C]

the ratio of the first oxidized subunit to the non-oxidized subunit is from 1:10,000 to 1:5; and
the oxidized polyisobutene has a number average molecular weight from 250 Da to 20,000,000 Da.

Embodiment P23. The oxidized polyisobutene of Embodiment P22, wherein the ratio of the first oxidized subunit to the non-oxidized subunit is from 1:1000 to 1:10.

Embodiment P24. The oxidized polyisobutene of one of Embodiments P22 to P23, wherein the oxidized polyisobutene has a number average molecular weight from 500 Da to 2,000,000 Da.

Embodiment P25. A mixture of polymers comprising an oxidized polyisobutene of one of Embodiments P22 to P24 and a second polymer.

Embodiment P26. The mixture of polymers of Embodiment P25, wherein the second polymer is a high-density polyethylene, a low-density polyethylene, or a linear low-density polyethylene.

Embodiment P27. A cross-linked polymer, wherein a first oxidized polyisobutene of one of Embodiments P22 to P24 is covalently bonded to a second oxidized polyisobutene of one of Embodiments P22 to P24 via a covalent linker having the formula:

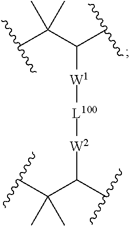

wherein
W¹ is —O— or —NR¹—;
W² is —O— or —NR²—;
R¹ and R² are independently hydrogen, halogen, —CX³₃, —CHX³₂, —CH₂X³, —OCX³₃, —OCH₂X³, —OCHX³₂, —CN, —SOₙ₃R³, —SOᵥ₃NR³R³, —NR³NR³R³, —ONR³R³,
—NHC(O)NR³NR³R³,
—NHC(O)NR³R³, —N(O)ₘ₃, —NR³R³, —C(O)R³, —C(O)OR³, —C(O)NR³R³, —OR³, —SR³, —NR³SO₂R³,
—NR³C(O)R³, —NR³C(O)OR³, —NR³OR³, —SF₅, —N₃, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl;
R³ is independently hydrogen, oxo, halogen, —CCl₃, —CBr₃, —CF₃, —CI₃, —CHCl₂, —CHBr₂, —CHF₂, —CHI₂, —CH₂Cl, —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂,
—NHSO₂H, —NHC(O)H, —NHC(O)OH, —NHOH, —OCCl₃, —OCF₃, —OCBr₃, —OCl₃, —OCHCl₂, —OCHBr₂, —OCHI₂, —OCHF₂, —OCH₂Cl, —OCH₂Br, —OCH₂I, —OCH₂F, —N₃, —SF₅, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl; two R³ substituents bonded to the same nitrogen atom may optionally be joined to form a substituted or unsubstituted heterocycloalkyl, or substituted or unsubstituted heteroaryl;
L¹⁰⁰ is -L¹⁰¹-L¹⁰²-L¹⁰³-;
L¹⁰¹ is a bond, —N(R¹⁰¹)—, —S—, —O—, —C(O)—, —C(O)O—, —OC(O)—, —N(R¹⁰¹)C(O)—, —C(O)N(R¹⁰¹)—, —NR¹⁰¹C(O)NR¹⁰¹—, —NR¹⁰¹C(NH)NH—, —C(S)—, —Si(R¹⁰¹)₂—, substituted or unsubstituted alkylene, substituted or unsubstituted heteroalkylene, substituted or unsubstituted cycloalkylene, substituted or unsubstituted heterocycloalkylene, substituted or unsubstituted arylene, or substituted or unsubstituted heteroarylene;
L¹⁰² is a bond, —N(R¹⁰²)—, —S—, —O—, —C(O)—, —C(O)O—, —OC(O)—, —N(R¹⁰²)C(O)—, —C(O)N(R¹⁰²)—, —NR¹⁰²C(O)NR¹⁰²—, —NR¹⁰²C(NH)NH—, —C(S)—, —Si(R¹⁰²)₂—, substituted or unsubstituted alkylene, substituted or unsubstituted heteroalkylene, substituted or unsubstituted cycloalkylene, substituted or unsubstituted heterocycloalkylene, substituted or unsubstituted arylene, or substituted or unsubstituted heteroarylene;
L¹⁰³ is a bond, —N(R¹⁰³)—, —S—, —O—, —C(O)—, —C(O)O—, —OC(O)—, —N(R¹⁰³)C(O)—, —C(O)N(R¹⁰³)—, —NR¹⁰³C(O)NR¹⁰³—, —NR¹⁰³C(NH)NH—, —C(S)—, —Si(R¹⁰³)₂—, substituted or unsubstituted alkylene, substituted or unsubstituted heteroalkylene, substituted or unsubstituted cycloalkylene, substituted or unsubstituted heterocycloalkylene, substituted or unsubstituted arylene, or substituted or unsubstituted heteroarylene;
R¹⁰¹, R¹⁰², and R¹⁰³ are each independently hydrogen, halogen, —CX¹⁰⁴₃, —CHX¹⁰⁴₂, —CH₂X¹⁰⁴, —OCX¹⁰⁴₃, —OCH₂X¹⁰⁴, —OCHX¹⁰⁴², —CN, —SOₙ₁₀₄R¹⁰⁴, —SOᵥ₁₀₄NR¹⁰⁴R¹⁰⁴, —NR¹⁰⁴NR¹⁰⁴R¹⁰⁴, —ONR¹⁰⁴R¹⁰⁴, —NHC(O)NR¹⁰⁴NR¹⁰⁴R¹⁰⁴, —NHC(O)NR¹⁰⁴R¹⁰⁴, —N(O)ₘ₁₀₄, —NR¹⁰⁴R¹⁰⁴, —C(O)R¹⁰⁴, —C(O)OR¹⁰⁴, —C(O)NR¹⁰⁴R¹⁰⁴, —OR¹⁰⁴, —SR¹⁰⁴, —NR¹⁰⁴SO₂R¹⁰⁴, —NR¹⁰⁴C(O)R¹⁰⁴, —NR¹⁰⁴C(O)OR¹⁰⁴, —NR¹⁰⁴OR¹⁰⁴, —SF₅, —N₃, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl;
R¹⁰⁴ is independently hydrogen, oxo, halogen, —CCl₃, —CBr₃, —CF₃, —CI₃, —CHCl₂, —CHBr₂, —CHF₂, —CHI₂, —CH₂Cl, —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂,
—NHC(O)NH₂,
—NHSO₂H, —NHC(O)H, —NHC(O)OH, —NHOH, —OCCl₃, —OCF₃, —OCBr₃, —OCl₃, —OCHCl₂, —OCHBr₂, —OCHI₂, —OCHF₂, —OCH₂Cl, —OCH₂Br, —OCH₂I, —OCH₂F, —N₃, —SF₅, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl; two R¹⁰⁴ substituents bonded to the same nitrogen atom may optionally be joined to form a substituted or unsubstituted heterocycloalkyl, or substituted or unsubstituted heteroaryl;
X³ and X¹⁰⁴ are independently —F, —Cl, —Br, or —I;
n3 and n104 are independently an integer from 0 to 4; and
m3, m104, v3, and v104 are independently 1 or 2.

Embodiment P28. The cross-linked polymer of Embodiment P27, wherein W¹ is —O— or —NH—.

Embodiment P29. The cross-linked polymer of Embodiment P27, wherein W¹ is —O—.

Embodiment P30. The cross-linked polymer of one of Embodiments P27 to P29, wherein W² is —O— or —NH—.

Embodiment P31. The cross-linked polymer of one of Embodiments P27 to P29, wherein W² is —O—.

Embodiment P32. The cross-linked polymer of one of Embodiments P27 to P31, wherein
L¹⁰¹ is —C(O)—, —C(O)NH—, or —Si(R¹⁰¹)₂—;
L¹⁰² is an unsubstituted alkylene;
L¹⁰³ is —C(O)—, —NHC(O)—, or —Si(R¹⁰³)₂—; and
R¹⁰¹ and R¹⁰³ are independently halogen, —OH, —NH₂, or substituted or unsubstituted heteroalkylene.

Embodiment P33. The cross-linked polymer of Embodiment P32, wherein R¹⁰¹ and R¹⁰³ are each independently —Cl or —OH.

Embodiment P34. The cross-linked polymer of one of Embodiments P27 to P31, wherein L¹⁰⁰ is

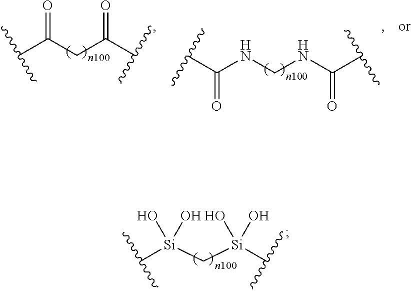

and
n100 is an integer from 1 to 20.

Embodiment P35. A mixture of polymers comprising a cross-linked polymer of one of Embodiments P27 to P34 and a second polymer.

Embodiment P36. The mixture of polymers of Embodiment P35, wherein the second polymer is a high-density polyethylene, a low-density polyethylene, or a linear low-density polyethylene.

### VI. Embodiments

Embodiment 1. A method of making an oxidized polyisobutene, comprising mixing a polyisobutene, a metal catalyst, and an oxidizing agent;
wherein the oxidized polyisobutene comprises a first oxidized subunit and a non-oxidized subunit;
the polyisobutene comprises a non-oxidized subunit;
the first oxidized subunit has the formula:

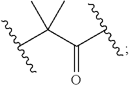 [SMILES: *C(=O)C(*)(C)C]

the non-oxidized subunit has the formula:

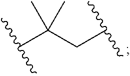 [SMILES: *CC(*)(C)C]

the ratio of the first oxidized subunit to the non-oxidized subunit is from 1:10,000 to 1:5; and
the oxidized polyisobutene has a number average molecular weight from 250 Da to 20,000,000 Da.

Embodiment 2. The method of Embodiment 1, wherein the ratio of the first oxidized subunit to the non-oxidized subunit is from 1:1000 to 1:10.

Embodiment 3. The method of one of Embodiments 1 to 2, wherein the oxidized polyisobutene has a number average molecular weight from 500 Da to 2,000,000 Da.

Embodiment 4. The method of one of Embodiments 1 to 3, wherein the metal catalyst is a ruthenium catalyst, an iron catalyst, or a nickel catalyst.

Embodiment 5. The method of one of Embodiments 1 to 3, wherein the metal catalyst is

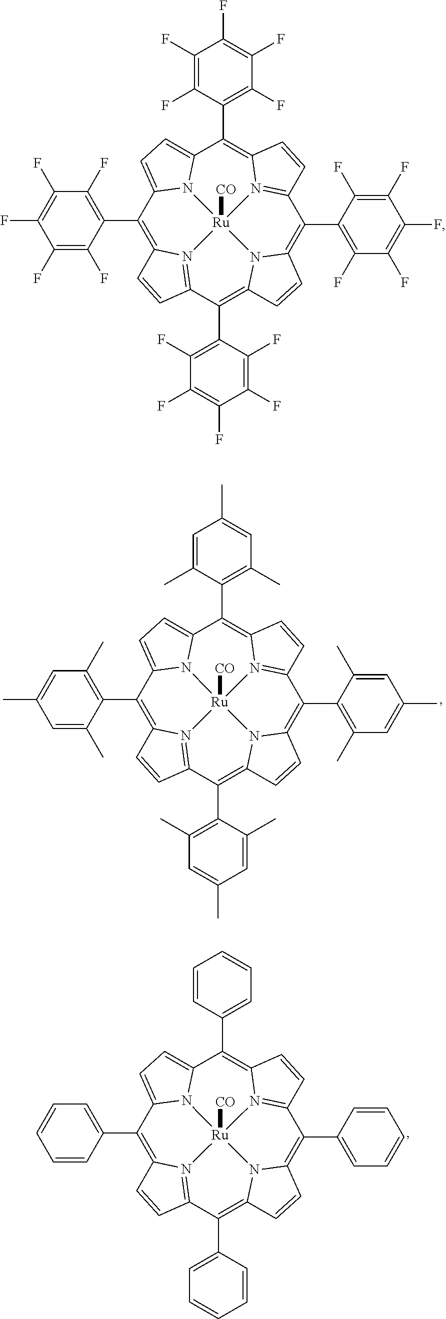

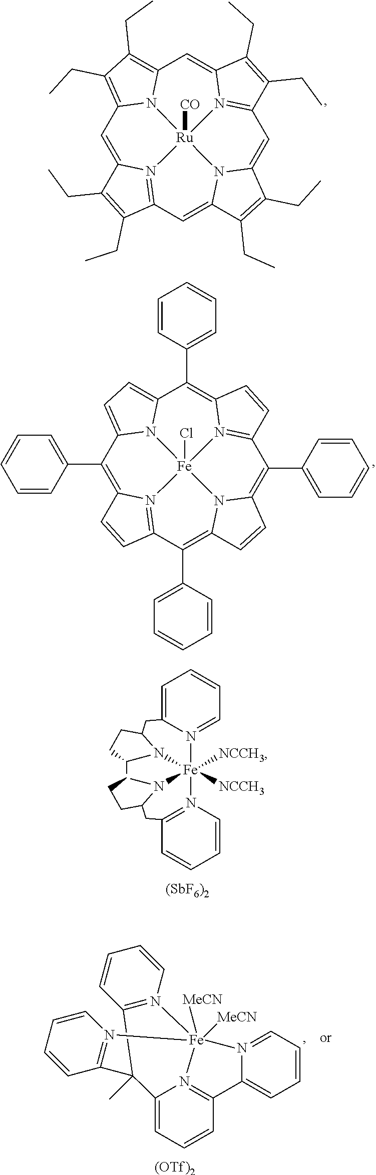

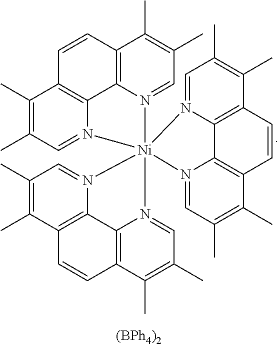

Embodiment 6. The method of one of Embodiments 1 to 3, wherein the metal catalyst is

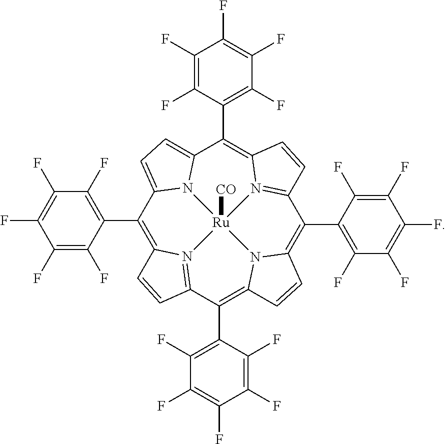

Embodiment 7. The method of one of Embodiments 1 to 6, wherein the oxidizing agent is a peroxide or a substituted pyridine N-oxide.

Embodiment 8. The method of one of Embodiments 1 to 6, wherein the oxidizing agent is

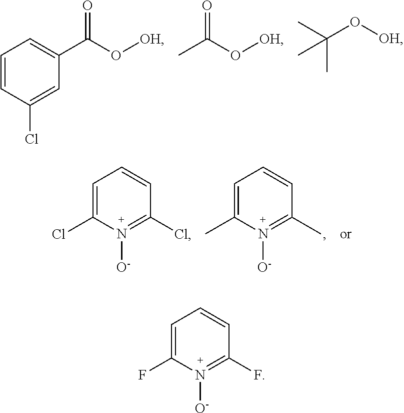

Embodiment 9. The method of one of Embodiments 1 to 6, wherein the oxidizing agent is

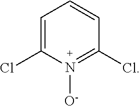

Embodiment 10. The method of one of Embodiments 1 to 9, further comprising contacting the oxidized polyethylene with a reducing agent thereby forming a reduced-oxidized polyethylene, wherein the first oxidized subunit is reduced to form a reduced subunit having the formula

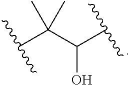 [SMILES: *C(O)C(*)(C)C]

Embodiment 11. The method of one of Embodiments 1 to 10, wherein the reducing agent is an aluminum hydride or a boron hydride.

Embodiment 12. The method of one of Embodiments 1 to 10, wherein the reducing agent is lithium aluminum hydride, sodium bis(2-methoxyethoxy)aluminum hydride, or lithium triethylborohydride.

Embodiment 13. An oxidized polyisobutene in a vessel comprising an oxidized polyisobutene and one or more additional compounds selected from the groups consisting of: (i) a metal catalyst; (ii) an oxidizing agent; (iii) a reducing agent; (iv) a polyisobutene; and (v) a hydroxylated polyisobutene;
wherein
the oxidized polyisobutene comprises a first oxidized subunit and a non-oxidized subunit;
the polyisobutene comprises a non-oxidized subunit;
the hydroxylated polyisobutene comprises a second oxidized subunit and a non-oxidized subunit;
the first oxidized subunit has the formula:

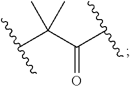 [SMILES: *C(=O)C(*)(C)C]

the second oxidized subunit has the formula:

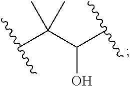 [SMILES: *C(O)C(*)(C)C]

the non-oxidized subunit has the formula:

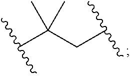 [SMILES: *CC(*)(C)C]

the ratio of the first oxidized subunit to the non-oxidized subunit in the oxidized polyisobutene is from 1:10,000 to 1:5;
the oxidized polyisobutene has a number average molecular weight from 250 Da to 20,000,000 Da; and
the hydroxylated polyisobutene has a number average molecular weight from 250 Da to 20,000,000 Da.

Embodiment 14. The oxidized polyisobutene in a vessel of Embodiment 13, wherein the ratio of the first oxidized subunit to the non-oxidized subunit in the oxidized polyisobutene is from 1:1000 to 1:10.

Embodiment 15. The oxidized polyisobutene in a vessel of one of Embodiments 13 to 14, wherein the oxidized polyisobutene has a number average molecular weight from 500 Da to 2,000,000 Da.

Embodiment 16. The oxidized polyisobutene in a vessel of one of Embodiments 13 to 15, wherein the hydroxylated polyisobutene has a number average molecular weight from 500 Da to 2,000,000 Da.

Embodiment 17. The oxidized polyisobutene in a vessel of one of Embodiments 13 to 16, wherein the metal catalyst is a ruthenium catalyst, an iron catalyst, or a nickel catalyst.

Embodiment 18. The oxidized polyisobutene in a vessel of one of Embodiments 13 to 16, wherein the metal catalyst is

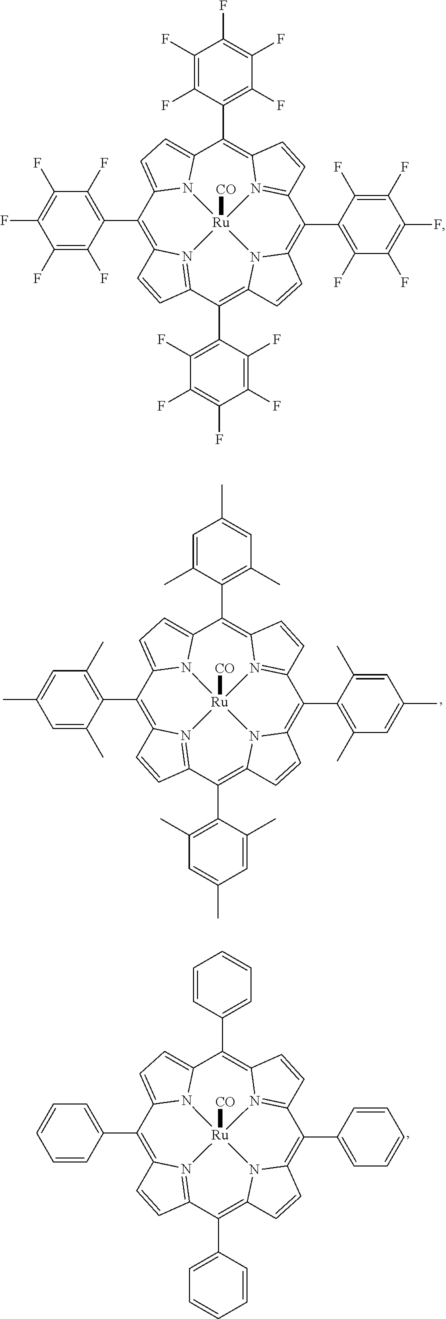

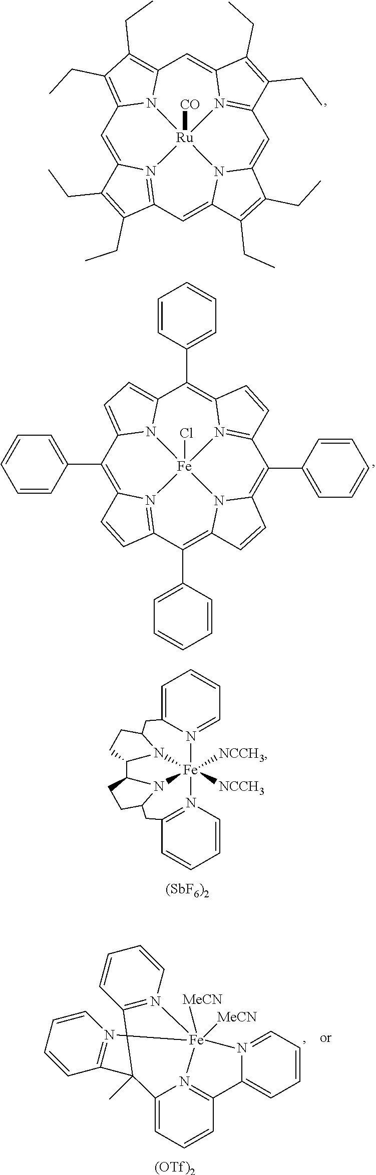

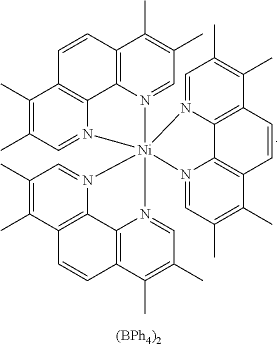

Embodiment 19. The oxidized polyisobutene in a vessel of one of Embodiments 13 to 16, wherein the metal catalyst is

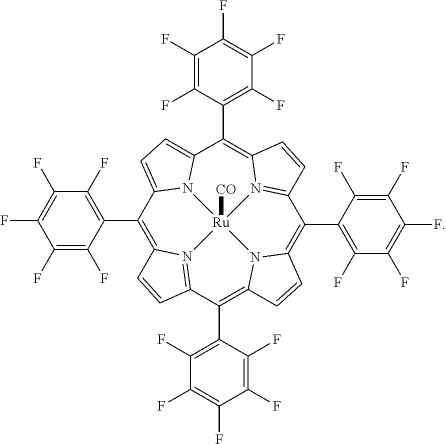

Embodiment 20. The oxidized polyethylene in a vessel of one of Embodiments 13 to 19, wherein the one or more additional compounds is the oxidizing agent and the vessel does not comprise the reducing agent.

Embodiment 21. The oxidized polyisobutene in a vessel of one of Embodiments 13 to 20, wherein the oxidizing agent is a peroxide or a substituted pyridine N-oxide.

Embodiment 22. The oxidized polyisobutene in a vessel of one of Embodiments 13 to 20, wherein the oxidizing agent is

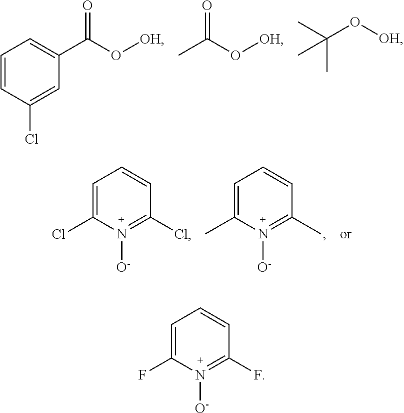

Embodiment 23. The oxidized polyisobutene in a vessel of one of Embodiments 13 to 20, wherein the oxidizing agent is

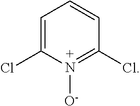

Embodiment 24. The oxidized polyethylene in a vessel of one of Embodiments 13 to 19, wherein the one or more additional compound is the reducing agent and the vessel does not comprise the oxidizing agent.

Embodiment 25. The oxidized polyisobutene in a vessel of one of Embodiments 13 to 19 and 24, wherein the reducing agent is an aluminum hydride or a boron hydride.

Embodiment 26. The oxidized polyisobutene in a vessel of one of Embodiments 13 to 19 and 24, wherein the reducing agent is lithium aluminum hydride, sodium bis(2-methoxyethoxy)aluminum hydride, or lithium triethylborohydride.

Embodiment 27. An oxidized polyisobutene, comprising a first oxidized subunit and a non-oxidized subunit;
the first oxidized subunit has the formula:

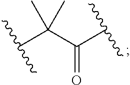 [SMILES: *C(=O)C(*)(C)C]

the non-oxidized subunit has the formula:

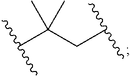 [SMILES: *CC(*)(C)C]

the ratio of the first oxidized subunit to the non-oxidized subunit is from 1:10,000 to 1:5; and
the oxidized polyisobutene has a number average molecular weight from 250 Da to 20,000,000 Da.

Embodiment 28. The oxidized polyisobutene of Embodiment 27, wherein the ratio of the first oxidized subunit to the non-oxidized subunit is from 1:1000 to 1:10.

Embodiment 29. The oxidized polyisobutene of one of Embodiments 27 to 28, wherein the oxidized polyisobutene has a number average molecular weight from 500 Da to 2,000,000 Da.

Embodiment 30. A mixture of polymers comprising an oxidized polyisobutene of one of Embodiments 27 to 29 and a second polymer.

Embodiment 31. The mixture of polymers of Embodiment 30, wherein the second polymer is a high-density polyethylene, a low-density polyethylene, or a linear low-density polyethylene.

Embodiment 32. A cross-linked polymer, wherein a first oxidized polyisobutene of one of Embodiments 27 to 29 is covalently bonded to a second oxidized polyisobutene of one of Embodiments 27 to 29 via a covalent linker having the formula:

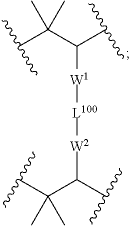

wherein
W¹ is —O— or —NR¹—;
W² is —O— or —NR²—;
R¹ and R² are independently hydrogen, halogen, —CX³₃, —CHX³₂, —CH₂X³, —OCX³₃, —OCH₂X³, —OCHX³₂, —CN, —SOₙ₃R³, —SOᵥ₃NR³R³, —NR³NR³R³, —ONR³R³,
—NHC(O)NR³NR³R³,
—NHC(O)NR³R³, —N(O)ₘ₃, —NR³R³, —C(O)R³, —C(O)OR³, —C(O)NR³R³, —OR³, —SR³, —NR³SO₂R³,
—NR³C(O)R³, —NR³C(O)OR³, —NR³OR³, —SF₅, —N₃, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl;
R³ is independently hydrogen, oxo, halogen, —CCl₁₃, —CBr₃, —CF₃, —CI₃, —CHCl₂, —CHBr₂, —CHF₂, —CHI₂, —CH₂Cl, —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂,
—NHC(O)NH₂,
—NHSO₂H, —NHC(O)H, —NHC(O)OH, —NHOH, —OCCl₃, —OCF₃, —OCBr₃, —OCl₃, —OCHCl₂, —OCHBr₂, —OCHI₂, —OCHF₂, —OCH₂Cl, —OCH₂Br, —OCH₂I, —OCH₂F, —N₃, —SF₅, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl; two R³ substituents bonded to the same nitrogen atom may optionally be joined to form a substituted or unsubstituted heterocycloalkyl, or substituted or unsubstituted heteroaryl;
L¹⁰⁰ is -L¹⁰¹-L¹⁰²-L¹⁰³-;
L¹⁰¹ is a bond, —N(R¹⁰¹)—, —S—, —O—, —C(O)—, —C(O)O—, —OC(O)—, —N(R¹⁰¹)C(O)—, —C(O)N(R¹⁰¹)—, —NR¹⁰¹C(O)NR¹⁰¹—, —NR¹⁰¹C(NH)NH—, —C(S)—, —Si(R¹⁰¹)₂—, substituted or unsubstituted alkylene, substituted or unsubstituted heteroalkylene, substituted or unsubstituted cycloalkylene, substituted or unsubstituted heterocycloalkylene, substituted or unsubstituted arylene, or substituted or unsubstituted heteroarylene;
L¹⁰² is a bond, —N(R¹⁰²)—, —S—, —O—, —C(O)—, —C(O)O—, —OC(O)—, —N(R¹⁰²)C(O)—, —C(O)N(R¹⁰²)—, —NR¹⁰²C(O)NR¹⁰²—, —NR¹⁰²C(NH)NH—, —C(S)—, —Si(R¹⁰²)₂—, substituted or unsubstituted alkylene, substituted or unsubstituted heteroalkylene, substituted or unsubstituted cycloalkylene, substituted or unsubstituted heterocycloalkylene, substituted or unsubstituted arylene, or substituted or unsubstituted heteroarylene;
L¹⁰³ is a bond, —N(R¹⁰³)—, —S—, —O—, —C(O)—, —C(O)O—, —OC(O)—, —N(R¹⁰³)C(O)—, —C(O)N(R¹⁰³)—, —NR¹⁰³C(O)NR¹⁰³—, —NR¹⁰³C(NH)NH—, —C(S)—, —Si(R¹⁰³)₂—, substituted or unsubstituted alkylene, substituted or unsubstituted heteroalkylene, substituted or unsubstituted cycloalkylene, substituted or unsubstituted heterocycloalkylene, substituted or unsubstituted arylene, or substituted or unsubstituted heteroarylene;
R¹⁰¹, R¹⁰², and R¹⁰³ are each independently hydrogen, halogen, —CX¹⁰⁴₃, —CHX¹⁰⁴², —CH₂X¹⁰⁴, —OCX¹⁰⁴₃, —OCH₂X¹⁰⁴, —OCHX¹⁰⁴₂, —CN, —SOₙ₁₀₄R¹⁰⁴, —SOᵥ₁₀₄NR¹⁰⁴R¹⁰⁴, —NR¹⁰⁴NR¹⁰⁴R¹⁰⁴, —ONR¹⁰⁴R¹⁰⁴, —NHC(O)NR¹⁰⁴NR¹⁰⁴R¹⁰⁴, —NHC(O)NR¹⁰⁴R¹⁰⁴, —N(O)ₘ₁₀₄, —NR¹⁰⁴R¹⁰⁴, —C(O)R¹⁰⁴, —C(O)OR¹⁰⁴, —C(O)NR¹⁰⁴R¹⁰⁴, —OR¹⁰⁴, —SR¹⁰⁴, —NR¹⁰⁴SO₂R¹⁰⁴, —NR¹⁰⁴C(O)R¹⁰⁴, —NR¹⁰⁴C(O)OR¹⁰⁴, —NR¹⁰⁴OR¹⁰⁴, —SF₅, —N₃, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl;
R¹⁰⁴ is independently hydrogen, oxo, halogen, —CCl₃, —CBr₃, —CF₃, —CI₃, —CHCl₂, —CHBr₂, —CHF₂, —CHI₂, —CH₂Cl, —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂,
—NHC(O)NH₂,
—NHSO₂H, —NHC(O)H, —NHC(O)OH, —NHOH, —OCCl₃, —OCF₃, —OCBr₃, —OCl₃, —OCHCl₂, —OCHBr₂, —OCHI₂, —OCHF₂, —OCH₂Cl, —OCH₂Br, —OCH₂I, —OCH₂F, —N₃, —SF₅, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl; two R¹⁰⁴ substituents bonded to the same nitrogen atom may optionally be joined to form a substituted or unsubstituted heterocycloalkyl, or substituted or unsubstituted heteroaryl;
X³ and X¹⁰⁴ are independently —F, —Cl, —Br, or —I;
n3 and n104 are independently an integer from 0 to 4; and
m3, m104, v3, and v104 are independently 1 or 2.

Embodiment 33. The cross-linked polymer of Embodiment 32, wherein W¹ is —O— or —NH—.

Embodiment 34. The cross-linked polymer of Embodiment 32, wherein W¹ is —O—.

Embodiment 35. The cross-linked polymer of one of Embodiments 32 to 34, wherein W² is —O— or —NH—.

Embodiment 36. The cross-linked polymer of one of Embodiments 32 to 34, wherein W² is —O—.

Embodiment 37. The cross-linked polymer of one of Embodiments 32 to 36, wherein
L¹⁰¹ is —C(O)—, —C(O)NH—, or —Si(R¹⁰¹)₂—;
L¹⁰² is an unsubstituted alkylene;
L¹⁰³ is —C(O)—, —NHC(O)—, or —Si(R¹⁰³)₂—; and
R¹⁰¹ and R¹⁰³ are independently halogen, —OH, —NH₂, or substituted or unsubstituted heteroalkylene.

Embodiment 38. The cross-linked polymer of Embodiment 37, wherein R¹⁰¹ and R¹⁰³ are each independently —Cl or —OH.

Embodiment 39. The cross-linked polymer of one of Embodiments 32 to 36, wherein L¹⁰⁰ is

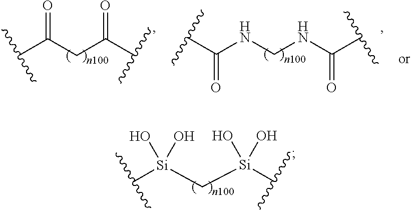

n100 is an integer from 1 to 20.

Embodiment 40. A mixture of polymers comprising a cross-linked polymer of one of Embodiments 32 to 39 and a second polymer.

Embodiment 41. The mixture of polymers of Embodiment 40, wherein the second polymer is a high-density polyethylene, a low-density polyethylene, or a linear low-density polyethylene.

### EXAMPLES

### Example 1: Ruthenium-Catalyzed, Chemoselective and Regioselective Oxidation of Polyisobutene

Polyisobutene is one of the earliest-studied polyolefins and remains commercially important in high-performance elastomers, adhesives, sealants, and additives in fuels and lubricants.¹ Because of its low glass transition temperature (<−60° C.), high thermal stability, damping properties, and impermeability, interests in expanding the applications of polyisobutene to biomaterials and recyclable elastomers are growing.² To meet the criteria of these applications, polyisobutenes containing randomly incorporated functional groups along the polymer main chain are desirable. Indeed, copolymers of isobutene and isoprene that carry low levels of unsaturation (ca. 2 mol %) are industrially produced and converted to crosslinked butyl rubber.^{1a} Polyisobutenes containing polar functionality have the potential to possess compatibility and chemical reactivity that are distinct from those of the original material, but synthesis by cationic copolymerization is challenging, due to the incompatibility of the functional groups with the polymerization reaction.

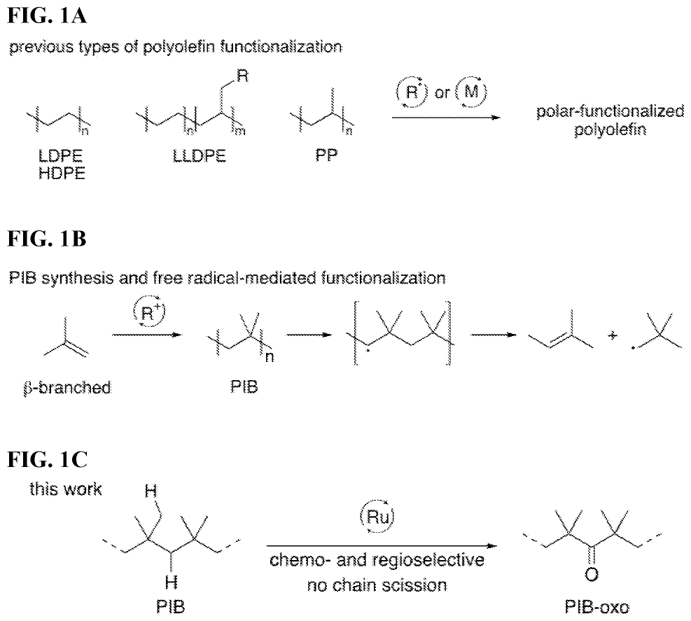

Such materials could be prepared by functionalization of the polymer. However, the vast majority of the prior work has been conducted on polymers of ethylene and linear α-alkenes using free radical or organometallic-mediated C—H functionalization methods (FIG. 1A), shedding little light on how to functionalize even the simplest 0-branched α-olefin, polyisobutene (FIG. 1B).³ Previous attempts to functionalize polyisobutene by free radicals induced by chlorine, peroxide, or high energy radiation have led to significant chain scission and polymer degradation (FIG. 1B).^{1a, 4}

Transition-metal catalyzed reactions have been developed that do not involve free radicals, for the functionalization of polyolefins,⁵ but these reactions are sensitive to the steric properties of C—H bonds. Because polyisobutene contains only sterically congested primary and secondary C—H bonds flanked by quatemary centers (FIG. 1C), a C—H functionalization process that occurs on this hindered polymer has been elusive. We describe herein, inter alia, the oxidation of methylene positions of polyisobutylene to ketone units catalyzed by a ruthenium-porphyrin complex without altering the molecular weight parameters of the polymer. The resulting materials are thermally stable, yet reactive towards programmed transformations.

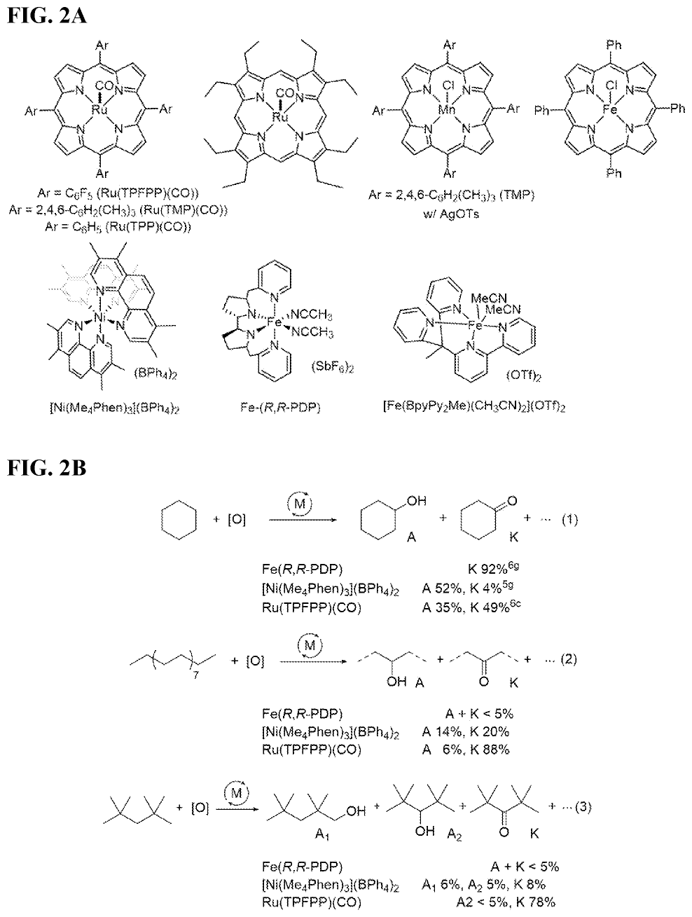

To achieve selective functionalization of polyisobutene, we studied the oxidation of model alkanes, octadecane and 2,2,4,4-tetramethylpentane, catalyzed by selected transition-metal complexes (FIG. 2A).^{5g, 6} The former alkane serves as a model for higher alkanes, and the latter serves to model the sterically congested C—H bonds in polyisobutene. While most of the complexes we tested have been reported to catalyze the oxidation of cyclohexane (FIG. 2B, equation (1)), only the nickel complex [Ni(Me₄Phen)₃](BPh₄)₂ in this set has been reported to catalyze the oxidation of polyolefins.^{5g}

These experiments revealed that many complexes known to catalyze the oxidation of cyclohexane are not optimal for the oxidation of octadecane or 2,2,4,4-tetramethylpentane under conditions relevant to polyolefin functionalization (FIG. 2B). For instance, oxidation of cyclohexane catalyzed by White's catalyst occurs with high yield in polar media (H₂O₂, acetic acid, and acetonitrile, 92% of cyclohexanone, FIG. 2B, equation (₁)),^{6g} whereas reactions with the same catalyst in less polar media (^{m}CPBA, 80% dichloromethane, and 20% acetonitrile) formed a mixture of cyclohexanol, cyclohexanone, and ε-caprolactone with total yield of only 8%. Moreover, oxidations of octadecane in nonpolar media conducted with this catalyst led to undetectable amounts of products (FIG. 2B, equation (2)). We attributed the low performance of White's catalyst for the oxidation of long-chain hydrocarbons to the mismatch between nonpolar media, which dissolve higher alkanes or polyolefins,⁷ and polar media that lead to an active catalyst.^{6d}

Oxidation catalyzed by Jurss' catalyst [Fe(BpyPy₂Me)(CH₃CN)₂]—(OTf)₂, a nonheme iron complex that could possess higher stability towards ligand degradation than White's catalyst,^{6e} also led to low yield of products in less polar media (cyclohexane, 8%; octadecane, 6%).

The oxidation of cyclohexane with ^{m}CPBA catalyzed by [Ni(Me₄Phen)₃](BPh₄)₂ occurred with a total yield of products >56%, and the yield of products from chlorination was 10% (FIG. 2B, equation (1));^{5g} in contrast, the combined yield of products from oxidation of octadecane was only 34% (FIG. 2B, equation (2)), and that from chlorination (12%) was slightly higher.

In contrast, the oxidation of octadecane with 2,6-dichloropyridine N-oxide catalyzed by Ru(TPFPP)(CO) occurred with a yield (94%, FIG. 2B, equation (2)) that was similar to that for the oxidation of cyclohexane (84%, FIG. 2B, equation (1)), and the chemoselectivity of the reaction of octadecane (K:A=15:1) was higher than that for oxidation of cyclohexane.

The high efficiency of this catalyst for the oxidation of long-chain n-alkanes led us to investigate other metalloporphyrin complexes for the functionalization of model alkanes. Reactions with Mn, Fe, and non-fluorinated Ru porphyrin complexes did not generate products from oxidation of octadecane in yields higher than 6%, suggesting that the reactivity of metalloporphyrin catalysts for the oxidation of alkanes is dependent on the electronic properties of the meso-substituents and the metal.⁸

The oxidation of 2,2,4,4-tetramethylpentane, which contains only sterically hindered primary and secondary C—H bonds, is more challenging than that of octadecane. Consistent with this assertion, the reactions of this alkane catalyzed by White's and Jurss' catalyst, as well as Mn, Fe and non-fluorinated Ru porphyrin complexes, did not form detectable amounts of oxidation product, and the nickel-catalyzed reaction yielded a complex mixture of oxygenation products in 19% combined yield (FIG. 2B, equation (3)). The oxidation of this alkane with [Ni(Me₄Phen)₃](BPh₄)₂ was accompanied by a significant level of chlorination (18%), and this low chemoselectivity could hamper its use for the functionalization of polyisobutene because the product from chlorination of the polymer is challenging to remove by purification.

In contrast to other catalysts, Ru(TPFPP)(CO) catalyzed the oxidation of 2,2,4,4-tetramethylpentane to yield 2,2,4,4-tetramethylpentan-3-one (⁷⁸%) and 2,2,4,4-tetramethylpentan-3-ol (<5%). The lack of any alkyl chloride or 2,2,4,4-tetramethylpentan-1-ol as product indicated that the Ru-catalyzed oxidation is likely to be suitable for the functionalization of polyisobutene.

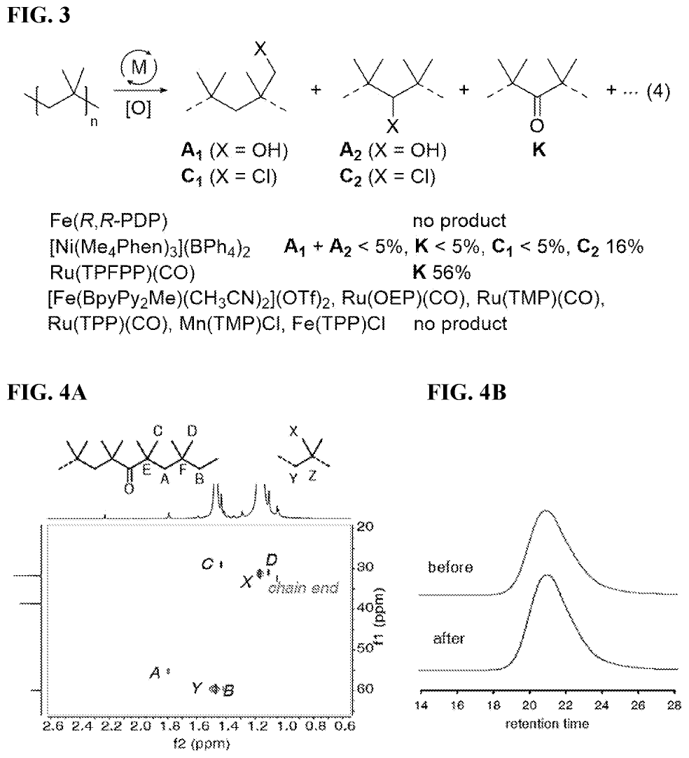

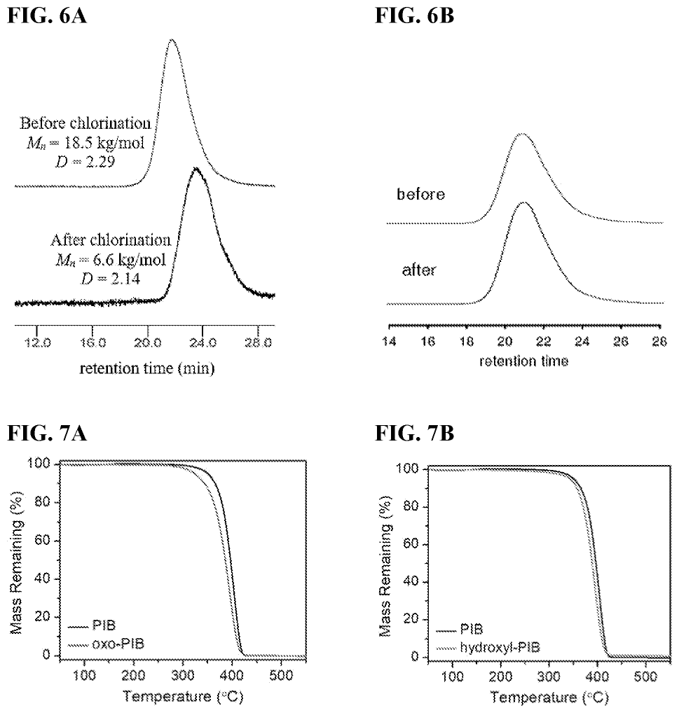

Guided by these results, we tested the oxidation of polyisobutene with the same series of catalysts (FIG. 3). Consistent with our results on the oxidation of model hydrocarbons, White's and Jurss' catalyst yielded no functionalized polyisobutene. Likewise, Mn, Fe, and Ru porphyrin complexes other than Ru(TPFPP)(CO) did not generate detectable amounts of oxidation product. The nickel-catalyzed oxidation led to trace amounts of oxygenation products, but generated significant levels of secondary alkyl chloride (FIG. 3, equation (3)). The chlorinated polyisobutene was analyzed by gel permeation chromatography, and a significant decrease in molecular weight (Mₙ=6.6 kg/mol, D=2.14, FIGS. 6A-6B) was observed. These results indicate that the chlorination process involves free alkyl radicals, which undergo chain scission in parallel with functionalization.

In contrast to the halogenation and chain cleavage observed from the nickel-catalyzed reactions of PIB, the reactions of PIB catalyzed by Ru(TPFPP)(CO) incorporated solely ketone functionality at the position of secondary C—H bonds (FIG. 3). The reaction occurred in high yield (56%), even at 0.2 mol % loading of Ru(TPFPP)(CO) when performed at 65° C. The degree of functionalization at this loading was 1.4 mol % and corresponds to a turnover number of 280. This value is similar to the largest value in prior reports of catalytic functionalization of less hindered polyolefins.⁵ The high catalytic performance of Ru(TPFPP)(CO) was maintained, even when the oxidation was run on a scale greater than 10 g, and the reaction was conveniently performed under ambient atmosphere using commercial grades of catalyst, reagent, and solvent without special precautions.

The structure of the ketone-functionalized polyisobutene (oxo-PIB) was confirmed by infrared and nuclear magnetic resonance (NMR) spectroscopy. The stretching frequency of the carbonyl group (1682 cm⁻¹) is similar to that of 2,2,4,4-tetramethylpentan-3-one (1685 cm⁻¹),⁹ and protons attached to β- and δ-carbons of the carbonyl group were unambiguously identified by ¹³C Distortionless Enhancement by Polarization Transfer, ¹H-¹³C Heteronuclear Single Quantum Coherence (HSQC), and ¹H-¹³C Heteronuclear Multiple Bond Correlation (HMBC) NMR spectroscopy (FIG. 4A).

The molecular weight of oxo-PIB (Mₙ=17.7 kg/mol, D=2.13, FIG. 4B) is similar to that of the original material (Mₙ=18.1 kg/mol, D=2.34). This similarity in molecular weight data is in stark contrast to the difference after nickel-catalyzed functionalization or after reactions with chlorine or peroxide.⁴ Furthermore, it indicates that abstraction of a hydrogen atom from a C—H bond by a porphyrin-ligated Ru-oxo intermediate is followed by fast radical rebound,^{6c} and β-fragmentation of the resulting alkyl radical of polyisobutene is negligible.

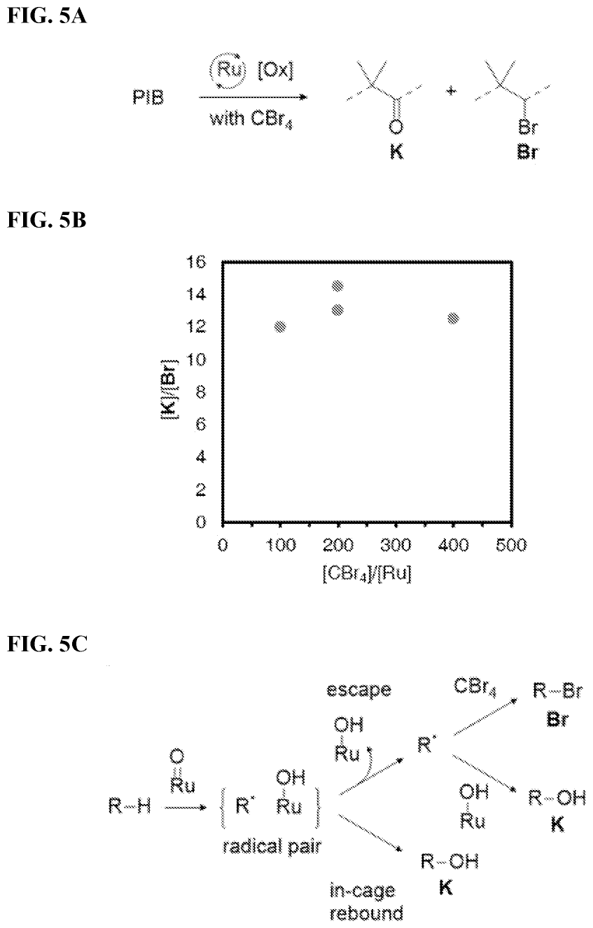

To probe the mechanism of the C—O bond-forming step during the functionalization of polyisobutene, we added CBr₄, a potent radical trap, to the oxidation reaction in varying amounts, relative to the ruthenium catalyst (FIG. 5A). The ratio of ketone to bromide incorporated into PIB did not depend on the ratio of CBr₄ to Ru. This constant ratio (FIG. 5B) indicates that transfer of bromine from CBr₄ (FIG. 5C) to the alkyl radical does not compete with the C—O bond forming step.

Crosslinked polyolefin materials often possess increased chemical resistance and mechanical strength,¹⁰ and these materials are commercially attractive and intensively investigated.¹¹ However, the crosslinking of branched polyolefins is difficult because methods based on free radicals lead to fragmentation.^{11b} Our catalytic method enables direct access to ketone-functionalized polyisobutenes and provides opportunities for further synthetic elaboration and crosslinking at the ketone units on polyisobutene.

We conducted the reduction of ketone units in oxo-PIB with both lithium aluminum hydride and sodium bis(2-methoxyethoxy)aluminum hydride to form hydroxylated polyisobutene (hydroxyl-PIB). Complete reduction from reaction with either reagent occurred, as indicated by the absence of a stretching frequency from a ketone unit in the infrared spectrum. The structure of hydroxyl-PIB was further confirmed by ¹H-¹³C HSQC and HMBC NMR spectroscopy. So far, efforts to reduce oxo-PIB with a milder metal hydride reductant (sodium borohydride) or by catalytic transfer hydrogenation have led to only intact starting polymer.

Hydroxyl-PIB was amenable to crosslinking.¹² The reaction of hydroxyl-PIB with 1,6-bis(trichlorosilyl)hexane (ca. 3 wt %) occurred at 80° C. to form, after two days, an almost colorless, rubber-like material. In contrast to polyisobutene, the resulting material is insoluble in DCM and has a high gel content of 98%.

The thermal properties of oxo-PIB and hydroxyl-PIB were evaluated by differential scanning colorimetry (DSC) and thermogravimetric analysis (TGA). The glass transition temperatures of oxo-PIB (−63.0° C.) and hydroxyl-PIB (−62.1° C.) are modestly higher than that of PIB (−66.5° C.). Likewise, the onset decomposition temperatures (oxo-PIB, 325° C.; hydroxyl-PIB, 344° C.) are only moderately lower than that of the unfunctionalized material (351° C.), and these temperatures are much higher than that of the chlorinated polyisobutene (170° C.).⁴a

Polyisobutenes have been used as additives to improve the plasticity, resistance to environmental stress cracking, and impact strength of polyethylenes.^{1a} To assess if oxo-PIB would increase the surface polarity of polyethylene and its compatibility to polar materials, we prepared films from HDPE and a blend of HDPE and oxo-PIB (9 wt %). The contact angle of the blended film (94°) was found to be 3° smaller than that of the HDPE film (97°). Thus, the ketone-functionalized polyisobutene as additive to HDPE increase the surface polarity of the HDPE.

In summary, we show that the oxidation of the hindered polyolefin, polyisobutene, occurs when catalyzed by a ruthenium porphyrin complex. This oxidation provides a direct route to polar-functionalized polyolefins derived from a β-branched α-alkenes. The oxidation is selective and rapid under mild conditions and occurs in high yield, with high turnover numbers, and without significantly changing the molecular weight of the original material.

### References for Example 1

1. (a) Brydson, J. A., Plastics Materials. Elsevier Science: 1999; (b) Mach, H.; Rath, P., Lubrication Science 1999, 11 (2), 175-185. 2. (a) Puskas, J. E.; Chen, Y.; Dahman, Y.; Padavan, D., J. Polym. Sci., Part A: Polym. Chem. 2004, 42 (13), 3091-3109; (b) Puskas, J. E.; Chen, Y., Biomacromolecules 2004, 5 (4), 1141-1154; (c) Imbemon, L.; Norvez, S., Eur. Polym. J. 2016, 82, 347-376; (d) Schneiderman, D. K.; Hillmyer, M. A., Macromolecules 2017, 50 (10), 3733-3749. 3. (a) Chung, T. C., Functionalization of Polyolefins. Elsevier Science: 2002; (b) Boaen, N. K.; Hillmyer, M. A., Chem. Soc. Rev. 2005, 34 (3), 267-275; (c) Franssen, N. M. G.; Reek, J. N. H.; de Bruin, B., Chem. Soc. Rev. 2013, 42 (13), 5809-5832; (d) Williamson, J. B.; Lewis, S. E.; Johnson III, R. R.; Manning, I. M.; Leibfarth, F., Angew. Chem., Int. Ed. 2018, 0 (ja). 4. (a) McGuchan, R.; McNeill, I. C., Journal of Polymer Science Part A-1: Polymer Chemistry 1968, 6 (1), 205-213; (b) Thomas, D. K., Transactions of the Faraday Society 1961, 57 (0), 511-517. 5. (a) Boaen, N. K.; Hillmyer, M. A., Macromolecules 2003, 36 (19), 7027-7034; (b) Kondo, Y.; Garcia-Cuadrado, D.; Hartwig, J. F.; Boaen, N. K.; Wagner, N. L.; Hillmyer, M. A., J. Am. Chem. Soc. 2002, 124 (7), 1164-1165; (c) Bae, C.; Hartwig, J. F.; Boaen Harris, N. K.; Long, R. O.; Anderson, K. S.; Hillmyer, M. A., J. Am. Chem. Soc. 2005, 127 (2), 767-776; (d) Bae, C.; Hartwig, J. F.; Chung, H.; Harris, N. K.; Switek, K. A.; Hillmyer, M. A., Angew. Chem., Int. Ed. 2005, 44 (39), 6410-6413; (e) Ray, A.; Zhu, K.; Kissin, Y. V.; Cherian, A. E.; Coates, G. W.; Goldman, A. S., Chem. Commun. 2005, (27), 3388-3390; (f) Diaz-Requejo, M. M.; Wehrmann, P.; Leatherman, M. D.; Trofimenko, S.; Mecking, S.; Brookhart, M.; Pérez, P. J., Macromolecules 2005, 38 (12), 4966-4969; (g) Bunescu, A.; Lee, S.; Li, Q.; Hartwig, J. F., ACS Central Science 2017, 3 (8), 895-903. 6. (a) Groves, J. T.; Bonchio, M.; Carofiglio, T.; Shalyaev, K., J. Am. Chem. Soc. 1996, 118 (37), 8961-8962; (b) Bravo, A.; Bjorsvik, H.-R.; Fontana, F.; Minisci, F.; Serri, A., J. Org. Chem. 1996, 61 (26), 9409-9416; (c) Wang, C.; Shalyaev, K. V.; Bonchio, M.; Carofiglio, T.; Groves, J. T., Inorg. Chem. 2006, 45 (12), 4769-4782; (d) Chen, M. S.; White, M. C., Science 2007, 318 (5851), 783; (e) Chen, L.; Su, X.-J.; Jurss, J. W., Organometallics 2018, 37 (24), 4535-4539; (f) Liu, W.; Cheng, M.-J.; Nielsen, R. J.; Goddard, W. A.; Groves, J. T., ACS Catal. 2017, 7 (6), 4182-4188; (g) Chen, M. S.; White, M. C., Science 2010, 327 (5965), 566. 7. Ferguson, A. L.; Debenedetti, P. G.; Panagiotopoulos, A. Z., The Journal of Physical Chemistry B 2009, 113 (18), 6405-6414. 8. (a) Fujii, H., J. Am. Chem. Soc. 1993, 115 (11), 4641-4648; (b) Ishimizu, Y.; Ma, Z.; Hada, M.; Fujii, H., JBIC Journal of Biological Inorganic Chemistry 2019, 24 (4), 483-494; (c) Ogliaro, F.; de Visser, S. P.; Groves, J. T.; Shaik, S., Angew. Chem., Int. Ed. 2001, 40 (15), 2874-2878; (d) Sharma, P. K.; de Visser, S. P.; Ogliaro, F.; Shaik, S., J. Am. Chem. Soc. 2003, 125 (8), 2291-2300. 9. Neuman, R. C.; Frink, M. E., J. Org. Chem. 1983, 48 (14), 2430-2432. 10. Chodák, I., Prog. Polym. Sci. 1995, 20 (6), 1165-1199. 11. (a) Rottger, M.; Domenech, T.; van der Weegen, R.; Breuilac, A.; Nicolay, R.; Leibler, L., Science 2017, 356 (6333), 62; (b) Lepage, M. L.; Simhadri, C.; Liu, C.; Takaffoli, M.; Bi, L.; Crawford, B.; Milani, A. S.; Wulff, J. E., Science 2019, 366 (6467), 875; (c) Leibfarth, F. A.; Schneider, Y.; Lynd, N. A.; Schultz, A.; Moon, B.; Kramer, E. J.; Bazan, G. C.; Hawker, C. J., J. Am. Chem. Soc. 2010, 132 (42), 14706-14709; (d) Lin, W.; Shao, Z.; Dong, J.-y.; Chung, T. C. M., Macromolecules 2009, 42 (11), 3750-3754. 12. (a) Kim, C.; Wang, Z.; Choi, H.-J.; Ha, Y.-G.; Facchetti, A.; Marks, T. J., J. Am. Chem. Soc. 2008, 130 (21), 6867-6878; (b) Nishimura, Y.; Chung, J.; Muradyan, H.; Guan, Z., J. Am. Chem. Soc. 2017, 139 (42), 14881-14884.

### Example 2: Materials and Methods

General remarks. All reactions were conducted under air unless otherwise noted. Solvents were purchased from Aldrich or Fisher and used as received. All chemical reagents were used as received from Aldrich, TCI, Strem, and Acros unless otherwise noted. Polyisobutene (Oppanol® B 10 SFN) was a gift from 3M Corporation. Fourier-transform infrared (FT-IR) spectra were obtained on a Bruker Vertex 80 spectrometer with attenuated total reflection. ¹H, ¹³C{¹H}, nuclear magnetic resonance spectra (NMR) were obtained on a Bruker 500 or 600 MHz spectrometer, and values reported in ppm (δ) referenced against the resonance of residual solvent (¹H NMR: CDCl₃, 7.26 ppm; ¹³C{¹H} NMR: CDCl₃, 77.16 ppm). Spin-spin coupling are described as singlet (s), doublet (d), triplet (t), quartet (q), quintet (quint), broad (br) or multiplet (m), with coupling constants (J) in Hz. Gel permeation chromatography (GPC) was performed on a Varian PL-GPC 50 with a refractive index detector (THF, 35° C., 1.0 mL/min). Molecular weight and dispersity are reported relative to commercial polystyrene standards. Differential scanning calorimetry (DSC) was performed on a TA Q200 instrument, and thermogravimetric analysis (TGA) was performed on a TA Q5000 instrument under air. Contact angles were measured using a VCA Optima Goniometer (AST Products, Inc).

Evaluation of Catalytic C—H Oxidation Methods.

Representative protocol for the catalytic oxidation with nonheme iron-oxo catalysts in less polar media. A solution of a model alkane (cyclohexane, 33 μL, 0.30 mmol; octadecane, 26 mg, 0.10 mmol; 2,2,4,4-tetramethylpentane, 0.36 mL, 2.0 mmol) or PIB (0.11 g, 2.0 mmol) in DCM (0.8 mL) was added a cosolvent MeCN (0.2 mL), Fe(R, R-PDP) (5.0 mol %, 4.7 mg, 5.0 μmol), and ^{m}CPBA (23 mg, 0.10 mmol). The reaction was heated at 50° C. overnight. After cooling the reaction to room temperature, an internal standard (CH₂Br₂, 18 uL, 0.25 mmol) was added. An aliquot of the crude mixture was removed, diluted with CDCl₃, and analyzed by ¹H NMR spectroscopy.

Representative protocol for the catalytic oxidation with [Ni(Me₄Phen)₃](BPh₄)₂. A catalyst stock solution was prepared by dissolving [Ni(Me₄Phen)₃](BPh₄)₂ (14 mg, 10 μmol) in DCM (1.5 mL) and MeCN (0.5 mL). A solution of a model alkane (octadecane, 26 mg, 0.10 mmol; 2,2,4,4-tetramethylpentane, 0.36 mL, 2.0 mmol) or PIB (0.11 g, 2.0 mmol) in DCM (0.8 mL) was added the catalyst stock solution (0.1 mol %, 0.02 mL) and ^{m}CPBA (23 mg, 0.10 mmol). The reaction was heated at 50° C. overnight. After cooling the reaction to room temperature, an internal standard (CH₂Br₂, 18 uL, 0.25 mmol) was added. An aliquot of the crude mixture was removed, diluted with CDCl₃, and analyzed by ¹H NMR spectroscopy.

Representative protocol for the catalytic oxidation with the Mn-porphyrin complex. A catalyst stock solution was prepared by dissolving Mn(TMP)Cl (3.3 mg, 4.0 μmol) and AgOTs (2.2 mg, 8.0 μmol) in DCM (1 mL).¹ A solution of a model alkane (cyclohexane, 33 μL, 0.30 mmol; octadecane, 26 mg, 0.10 mmol; 2,2,4,4-tetramethylpentane, 0.36 mL, 2.0 mmol) or PIB (0.11 g, 2.0 mmol) in DCM (0.5 mL) was added the catalyst stock solution (2 mol %, 0.5 mL) and ^{m}CPBA (23 mg, 0.10 mmol). The reaction was heated at 65° C. overnight. After cooling the reaction to room temperature, an internal standard (CH₂Br₂, 18 uL, 0.25 mmol) was added. An aliquot of the crude mixture was removed, diluted with CDCl₃, and analyzed by ¹H NMR spectroscopy.

Representative protocol for the catalytic oxidation with the Ru-porphyrin complexes. A catalyst stock solution was prepared by dissolving Ru(TPFPP)(CO) (22 mg, 20 μmol) in DCM (20 mL). A solution of a model alkane (octadecane, 26 mg, 0.10 mmol; 2,2,4,4-tetramethylpentane, 0.36 mL, 2.0 mmol) or PIB (0.11 g, 2.0 mmol) in DCM (0.8 mL) was added the catalyst stock solution (0.2 mol %, 0.2 mL) and 2,6-dichloropyridine N-oxide (16 mg, 0.10 mmol). The reaction was heated at 65° C. overnight. After cooling the reaction to room temperature, an internal standard (CH₂Br₂, 18 uL, 0.25 mmol) was added. An aliquot of the crude mixture was removed, diluted with CDCl₃, and analyzed by ¹H NMR spectroscopy.

TABLE 1
Catalytic oxidation of cyclohexane.
(1)

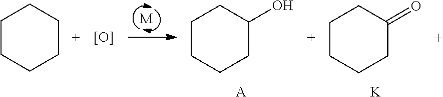

| | | | Cyclo- |
|---|---|---|---|
| | Cyclo- | Cyclo- | hexyl |
| | hexanol | hexanone | chloride |
| Catalyst | (A, %)ª | (K, %)^{b} | (Cl, %)^{c} |
| Fe(R, R-PDP), polar media² | 0 | 92 | 0 |
| Fe(R, R-PDP), less polar media^{d} | 3 | 3 | 0 |
| [Fe(BpyPy₂Me)(CH₃CN)₂](OTf)₂³ | 71 | 19 | 0 |
| [Fe(BpyPy₂Me)(CH₃CN)₂](OTf)₂, | 6 | 2 | 10 |
| less polar media^{e} | | | |
| Fe(TPP)Cl^{e} | 1 | 1 | 0 |
| [Ni(Me₄Phen)₃](BPh₄)₂⁴ | 52 | 4 | 10 |
| Mn(TMP)Cl | 2 | 6 | 0 |
| Ru(TPFPP)(CO)⁵ | 35 | 49 | 0 |
| Ru(OEP)(CO) | 0 | 0 | 0 |
| Ru(TPP)(CO) | 0 | 0 | 0 |
| Ru(TMP)(CO) | 0 | 0 | 0 |

^{a}Yield (alcohol) = [alcohol]/[oxidant].
^{b}Yield (ketone) = 2 × [ketone]/[oxidant].
^{c}Yield (alkyl chloride) = [alkyl chloride]/[oxidant].
^{d}Yield (ε-caprolactone) = 3 × [ester]/[oxidant] = 2%.
^{e}Yield (ε-caprolactone) = 5%.

TABLE 2
Catalytic oxidation of octadecane.
(2)

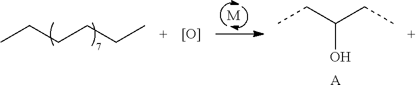

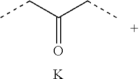

| | | | Alkyl |
|---|---|---|---|
| | Alcohols | Ketones | chlorides |
| Catalyst | (A, %)ª | (K, %)^{b} | (Cl, %)^{c} |
| Fe(R, R-PDP) | 1 | 2 | 0 |
| [Fe(BpyPy₂Me)(CH₃CN)₂](OTf)₂ | 4 | 2 | 7 |
| Fe(TPP)Cl | 2 | 4 | 0 |
| [Ni(Me₄Phen)₃](BPh₄)₂ | 14 | 20 | 12 |
| Mn(TMP)Cl | 1 | 0 | 0 |
| Ru(TPFPP)(CO) | 6 | 88 | 0 |
| Ru(OEP)(CO) | 0 | 0 | 0 |
| Ru(TPP)(CO) | 0 | 0 | 0 |
| Ru(TMP)(CO) | 0 | 0 | 0 |

^{a}Yield (alcohol) = [alcohol]/[oxidant].
^{b}Yield (ketone) = 2 × [ketone]/[oxidant].
^{c}Yield (alkyl chloride) = [alkyl chloride]/[oxidant].

TABLE 3
Catalytic oxidation of 2,2,4,4-tetramethylpentane.
(3)

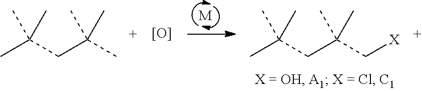

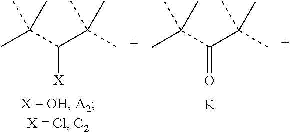

| | A₁ | A₂ | K | C₁ | C₂ |
|---|---|---|---|---|---|
| Catalyst | (%)ª | (%)ª | (%)^{b} | (%)^{c} | (%)^{c} |
| Fe(R, R-PDP) | 0 | 1 | 0 | 0 | 0 |
| [Fe(BpyPy₂Me)(CH₃CN)₂](OTf)₂ | 1 | 1 | 1 | 8 | 4 |
| Fe(TPP)Cl | 1 | 0 | 0 | 1 | 0 |
| [Ni(Me₄Phen)₃](BPh₄)₂ | 6 | 5 | 8 | 11 | 7 |
| Mn(TMP)Cl | 0 | 0 | 0 | 0 | 1 |
| Ru(TPFPP)(CO) | 0 | 1 | 78 | 0 | 0 |
| Ru(OEP)(CO) | 0 | 0 | 0 | 0 | 0 |
| Ru(TPP)(CO) | 0 | 0 | 0 | 0 | 0 |
| Ru(TMP)(CO) | 0 | 0 | 0 | 0 | 0 |

^{a}Yield (alcohol) = [alcohol]/[oxidant].
^{b}Yield (ketone) = 2 × [ketone]/[oxidant].
^{c}Yield (alkyl chloride) = [alkyl chloride]/[oxidant].

TABLE 4
Catalytic oxidation of PIB.
(4)

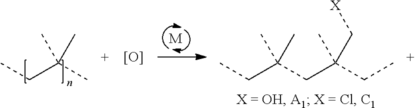

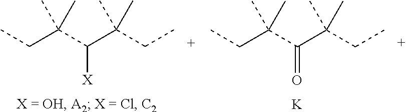

| | A₁ | A₂ | K | C₁ | C₂ |
|---|---|---|---|---|---|
| Catalyst | (%)ª | (%)ª | (%)^{b} | (%)^{c} | (%)^{c} |
| Fe(R, R-PDP) | 0 | 0 | 0 | 0 | 0 |
| [Fe(BpyPy₂Me)(CH₃CN)₂](OTf)₂ | 0 | 0 | 0 | 0 | 0 |
| Fe(TPP)Cl | 0 | 0 | 0 | 0 | 0 |
| [Ni(Me₄Phen)₃](BPh₄)₂ | 1 | 2 | 3 | 3 | 16 |
| Mn(TMP)Cl | 0 | 0 | 0 | 0 | 0 |
| Ru(TPFPP)(CO) | 0 | 0 | 56 | 0 | 0 |
| Ru(OEP)(CO) | 0 | 0 | 0 | 0 | 0 |
| Ru(TPP)(CO) | 0 | 0 | 0 | 0 | 0 |
| Ru(TMP)(CO) | 0 | 0 | 0 | 0 | 0 |

^{a}Yield (alcohol) = [alcohol]/[oxidant].
^{b}Yield (ketone) = 2 × [ketone]/[oxidant].
^{c}Yield (alkyl chloride) = [alkyl chloride]/[oxidant].

### Systhesis and Derivatization of Oxyfunctionalized Polyisobutenes

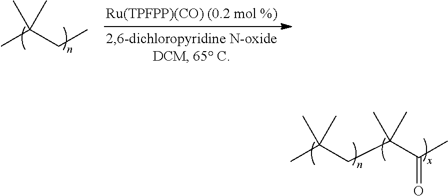

Representative protocol for the synthesis of oxo-PIB. PIB (11.2 g, 200 mmol) was dissolved in DCM (50 mL) at 80° C. and then cooled to room temperature. A solution of Ru(TPFPP)(CO) (0.20 mol %, 22 mg, 20 μmol) in DCM (20 mL) and another solution of 2,6-dichloropyridine N-oxide (1.64 g, 10.0 mmol) in DCM (25 mL) were added. The reaction mixture was stirred and heated at 65° C. overnight. After cooling the reaction to room temperature, an aliquot of the crude mixture was removed and diluted with CDCl₃ and analyzed by ¹H NMR spectroscopy. Another aliquot of the crude mixture was removed. The solvent was evaporated, and the residual polymer was dissolved in THF and analyzed by GPC. To the remaining reaction mixture was added acetone (150 mL), and the resulting solution was heated at 65° C. for 1 h. After cooling the mixture to room temperature, the supernatant was removed. The residual polymer was dissolved in DCM (20 mL), and another portion of acetone (150 mL) was added. The mixture was heated at 65° C. for 1 h. After cooling the mixture to room temperature, the supernatant was removed, and the polymer was dried in a vacuum oven at 90° C. for 2 days. 11.3 g of oxo-PIB (1.1 mol % ketone unit) was isolated.

¹H NMR (500 MHz, CDCl₃) δ 1.74 (s, CH₂C(CH₃)₂C(O)C(CH₃)₂CH₂), 1.56-1.28 (m, CH₂C(CH₃)₂), 1.26-0.96 (m, CH₂C(CH₃)₂). ¹³C NMR (126 MHz, CDCl₃) δ 59.7 (CH₂C(CH₃)₂), 59.4 (CH₂C(CH₃)₂CH₂C(CH₃)₂C(O)C(CH₃)₂CH₂C(CH₃)₂CH₂), 55.4 (CH₂C(CH₃)₂C(O)C(CH₃)₂CH₂), 51.3 (CH₂C(CH₃)₂C(O)C(CH₃)₂CH₂), 38.3 (CH₂C(CH₃)₂), 37.9 (CH₂C(CH₃)₂CH₂C(CH₃)₂C(O)C(CH₃)₂CH₂C(CH₃)₂CH₂), 32.6, 31.4 (CH₂C(CH₃)₂), 31.0 (CH₂C(CH₃)₂CH₂C(CH₃)₂C(O)C(CH₃)₂CH₂C(CH₃)₂CH₂), 29.2 (CH₂C(CH₃)₂C(O)C (CH₃)₂CH₂).

Determination of degrees of functionalization of oxo-PIB and hydroxyl-PIB by ¹H NMR spectra. The integration of peaks between 1.6 ppm and 1.3 ppm were set to 2 methylene protons (per monomer unit). The integration of the methylene protons at the S-position of the carbonyl group that appear at 1.7 ppm was used to determine the level of functionalization of carbonyl groups (4 protons per ketone unit in oxo-PIB). The integration of the methine proton next to the hydroxyl group that appears at 3.1 ppm was used to determine the level of functionalization for hydroxyl-PIB (1 proton per alcohol unit in hydroxyl-PIB).

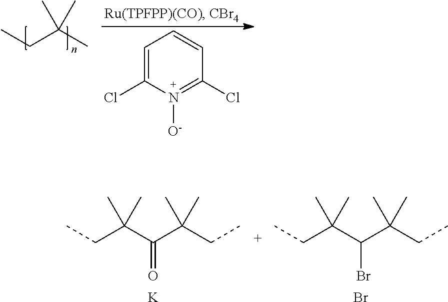

Representative protocol for the competition between oxidation and bromination. PIB (4.0 mmol, 0.22 g) was dissolved in DCM (0.8 mL). To this solution was then added 2,6-dichloropyridine N-oxide (0.20 mmol, 33 mg), CBr₄ (20 μmol, 6.6 mg), and a solution of Ru(TPFPP)(CO) (0.20 μmol, 0.22 mg, 0.10 mol %) in DCM (0.2 mL). The mixture was heated at 80° C. for 0.5 h. After cooling the reaction to room temperature, an aliquot of the crude mixture was removed and diluted with CDCl₃ and analyzed by ¹H NMR spectroscopy. ¹H NMR (500 MHz, CDCl₃) δ 4.07 (s, CH₂C(CH₃)₂CH(Br)C(CH₃)₂CH₂, 0.0008H), 1.73 (s, CH₂C(CH₃)₂C(O)C(CH₃)₂CH₂, 0.04H), 1.56-1.28 (m, CH₂C(CH₃)₂, 2H), 1.26-0.96 (m, CH₂C(CH₃)₂, 6H).

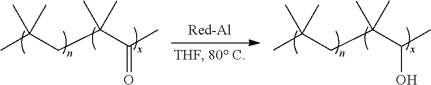

Representative protocol for the reduction of oxo-PIB. Oxo-PIB (11.2 g, 200 mol, 1.1 mol % ketone unit) was dissolved in THF (50 mL) at 80° C. and then cooled to room temperature. To the mixture was added a solution of sodium bis(2-methoxyethoxy)aluminium hydride (17.6 mmol, 10.4 mL, 65 wt % in toluene) dropwise. The reaction was heated at 80° C. overnight. After cooling the reaction to room temperature, MeOH (20 mL) was added to quench the reaction. Another portion of acetone (150 mL) was added, and the mixture was heated at 80° C. for 1 h. After cooling the reaction to room temperature, the supernatant was removed. The residual polymer was dissolved in DCM (200 mL) and filtered through two consecutive silica columns to remove aluminum byproduct. The solvent was removed by evaporation, and the polymer was dried in a vacuum oven at 100° C. for 2 days. 5.3 g of hydroxyl-PIB (0.8 mol % alcohol unit) was isolated.

¹H NMR (500 MHz, CDCl₃) δ 3.10 (s, CH(OH)), 1.73-1.28 (m, CH₂C(CH₃)₂), 1.26-0.96 (m, CH₂C (CH₃)₂). ¹³C NMR (126 MHz, CDCl₃) δ 87.1 (s, CH₂C(CH₃)₂CH(OH)C(CH₃)₂CH₂), 59.7 (CH₂C(CH₃)₂), 54.3 (CH₂C(CH₃)₂CH(OH)C(CH₃)₂CH₂), 43.4 (CH₂C(CH₃)₂CH(OH)C(CH₃)₂CH₂), 38.3 (CH₂C(CH₃)₂), 31.4 (CH₂C(CH₃)₂), 28.7 (C(CH₃)₂CH(OH)C(CH₃)₂).

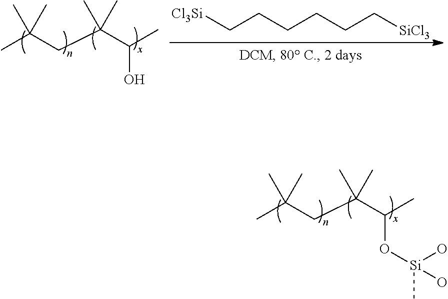

Crosslinking of hydroxyl-PIB. Hydroxyl PIB (0.16 g, 2.9 mmol, 1.4 mol % alcohol unit) was dissolved in DCM (1 mL). To this solution was then added 1,6-bis(trichlorosilyl)hexane (4.0 μL, 13 μmol). The reaction was heated at 80° C. for 2 days. After cooling the reaction to room temperature, the supernatant was removed. The polymer was washed with DCM (2 mL) twice and dried in a vacuum oven at 80° C. overnight. 0.17 g of crosslinked material was isolated.

Gel fraction test. Crosslinked polyisobutene (168 mg) was weighed, DCM (2 mL) was added, and the resulting solution was heated at 80° C. in a 4 mL vial over 10 h. After cooling to room temperature, the supernatant was removed. The polymer was washed with DCM (1 mL) and dried in a vacuum oven at 80° C. overnight. After cooling to room temperature, the recovered material (165 mg) was weighed, and the gel fraction (98%) was calculated based on the mass of insoluble fraction.

Gel permeation chromatography. The sample was dissolved in THF (ca. 2.5 mg/mL) at 80° C., and the resulting solution was injected for GPC analysis (FIG. 4B and FIGS. 6A-6B).

Thermogravimetric analysis. Each sample (ca. 5 mg) was heated from 40° C. to 600° C. at a rate of 10° C./min. Decomposition onset temperatures (Td) were measured at 5% mass loss (FIGS. 7A-7C).

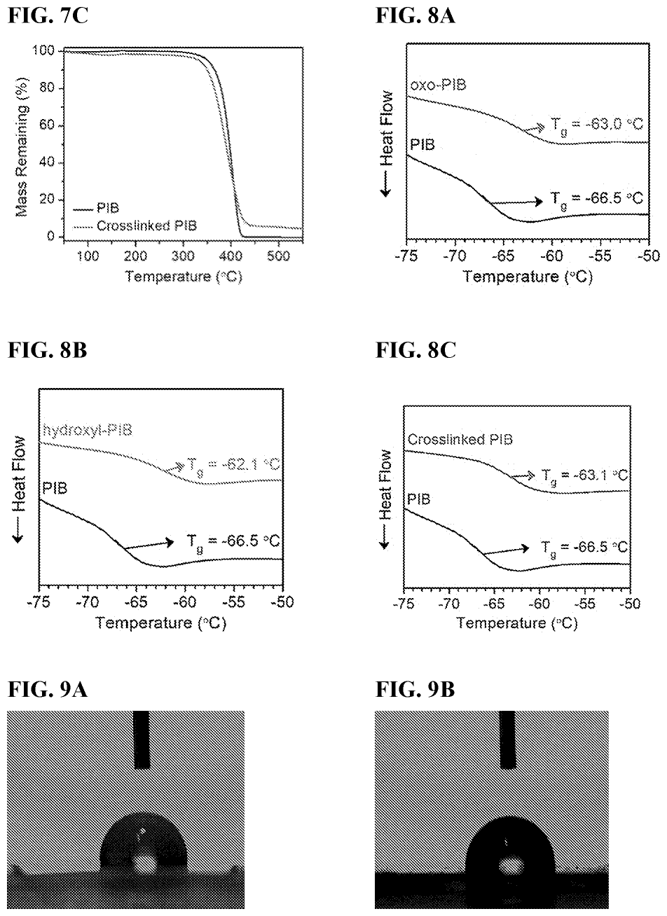

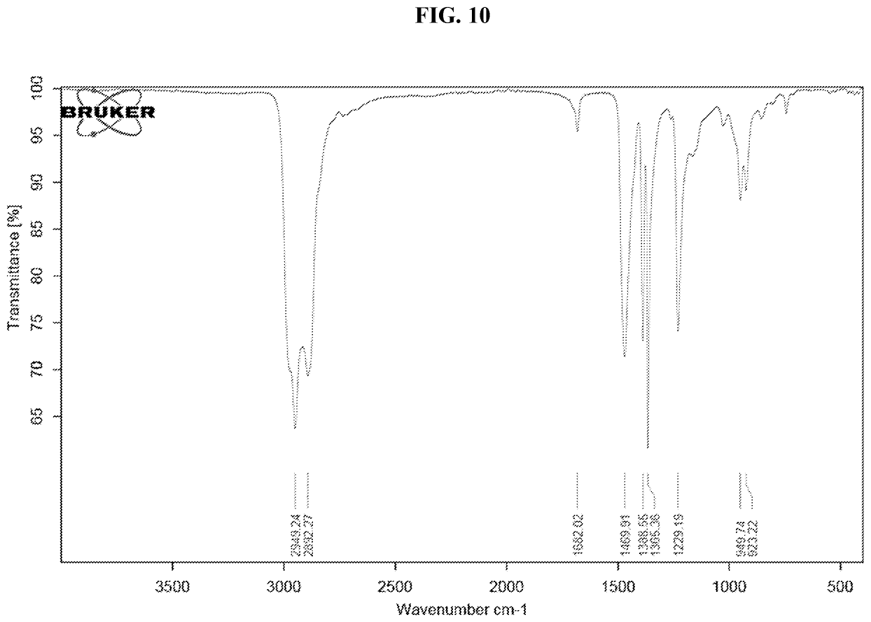

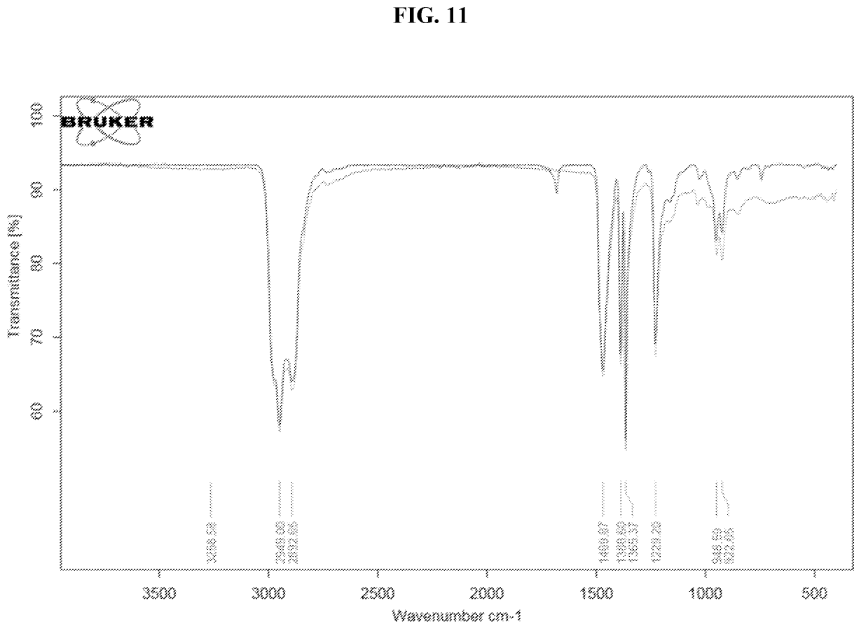

Differential scanning calorimetry. Each sample (ca. 5 mg) was placed in a hermitic aluminum pan, sealed, and scanned at a rate of 10° C./min from −80° C. to 150° C. Glass transition temperatures (T_{g}) were recorded for the second scan (FIGS. 8A-8C).

Contact angle measurements. Polymer films from HDPE (50 mg) and a blend of HDPE (50 mg) and oxidized PIB (5 mg, 9 wt %) were prepared by drop casting in 1,2-dichlorobenzene (2 mL). Static water contact angles were measured with deionized water (Milli-Q, 2 μL) in 10 repetitive experiments (Table 1 and FIGS. 8A-8C), and the average of these values of contact angles was calculated. HDPE film, 97±4°; blend film, 94±3°.

TABLE 5
Static contact angles for films from HDPE and polymer blend.

| | contact angle of | |
|---|---|---|
| Entry | HDPE film (°) | contact angle of blend film (°) |
| 1 | 100 | 101 |
| 2 | 95 | 89 |
| 3 | 92 | 93 |
| 4 | 92 | 92 |
| 5 | 96 | 92 |
| 6 | 104 | 94 |
| 7 | 99 | 92 |
| 8 | 100 | 95 |
| 9 | 92 | 94 |
| 10 | 99 | 94 |

### References for Example 2

1. 1. Liu, W.; Huang, X.; Placzek, M. S.; Krska, S. W.; McQuade, P.; Hooker, J. M.; Groves, J. T., Chem. Sci. 2018, 9 (5), 1168-1172. 2. Chen, M. S.; White, M. C., Science 2010, 327 (5965), 566. 3. Chen, L.; Su, X.-J.; Jurss, J. W., Organometallics 2018, 37 (24), 4535-4539. 4. Bunescu, A.; Lee, S.; Li, Q.; Hartwig, J. F., ACS Central Science 2017, 3 (8), 895-903. 5. Wang, C.; Shalyaev, K. V.; Bonchio, M.; Carofiglio, T.; Groves, J. T., Inorg. Chem. 2006, 45 (12), 4769-4782. 6. Brandolini, A. J.; Hills, D. D., NMR Spectra of Polymers and Polymer Additives. CRC Press: 2000.

1. A method of making an oxidized polyisobutene, comprising mixing a polyisobutene, a metal catalyst, and an oxidizing agent;
wherein
the oxidized polyisobutene comprises a first oxidized subunit and a non-oxidized subunit;
the polyisobutene comprises a non-oxidized subunit;
the first oxidized subunit has the formula: 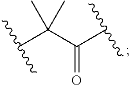 [SMILES: *C(=O)C(*)(C)C]
the non-oxidized subunit has the formula: 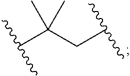 [SMILES: *CC(*)(C)C]
the ratio of the first oxidized subunit to the non-oxidized subunit is from 1:10,000 to 1:5; and
the oxidized polyisobutene has a number average molecular weight from 250 Da to 20,000,000 Da.

2-3. (canceled)

4. The method of claim 1, wherein the metal catalyst is a ruthenium catalyst, an iron catalyst, or a nickel catalyst.

5. The method of claim 4, wherein the metal catalyst is

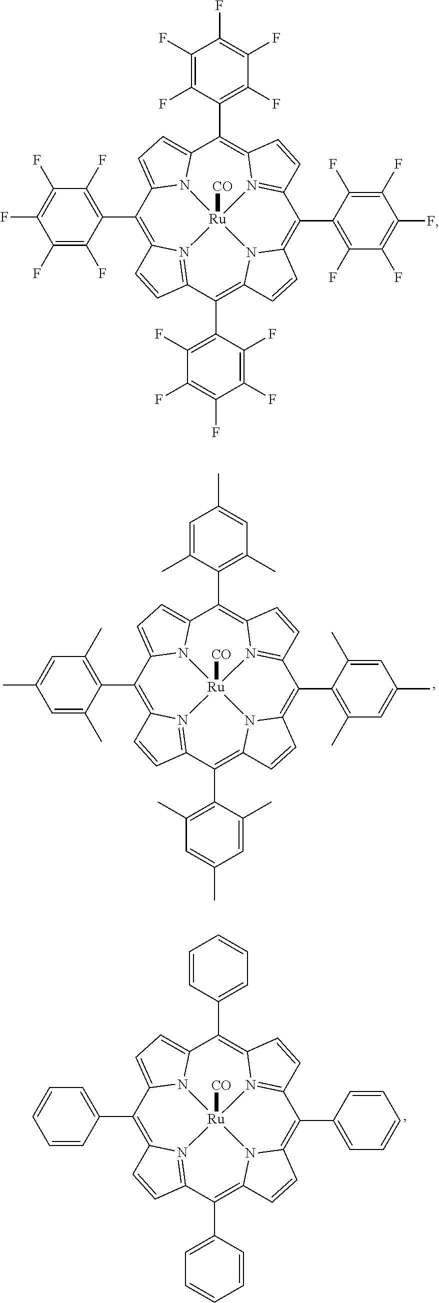

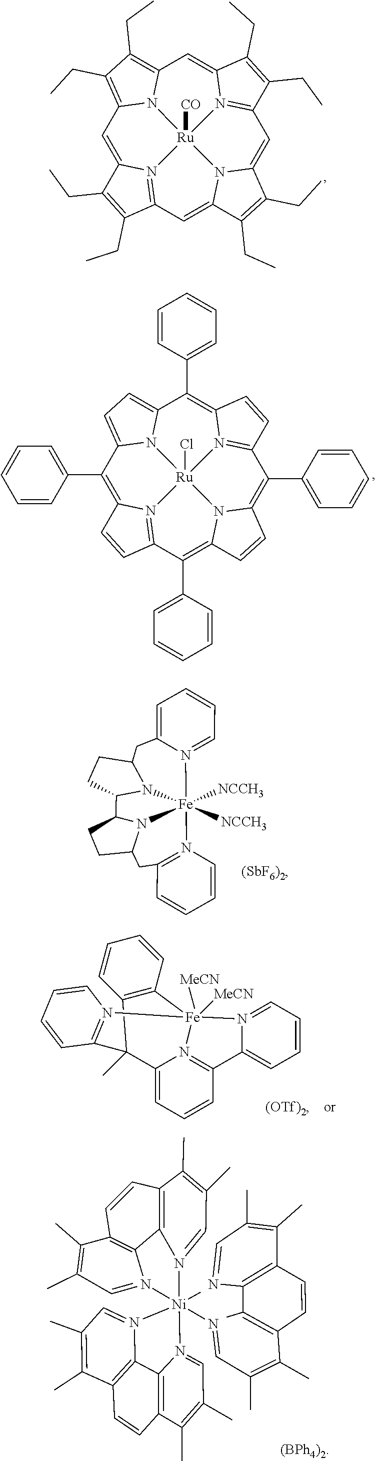

6. (canceled)

7. The method of claim 1, wherein the oxidizing agent is a peroxide or a substituted pyridine N-oxide.

8.-9. (canceled)

10. The method of claim 1, further comprising contacting the oxidized polyisobutene with a reducing agent thereby forming a reduced-oxidized polyisobutene, wherein the first oxidized subunit is reduced to form a reduced subunit having the formula

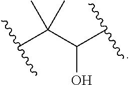 [SMILES: *C(O)C(*)(C)C]

11. The method of claim 10, wherein the reducing agent is an aluminum hydride or a boron hydride.

12. (canceled)

13. An oxidized polyisobutene in a vessel comprising an oxidized polyisobutene and one or more additional compounds selected from the groups consisting of: (i) a metal catalyst; (ii) an oxidizing agent; (iii) a reducing agent; (iv) a polyisobutene; and (v) a hydroxylated polyisobutene;
wherein
the oxidized polyisobutene comprises a first oxidized subunit and a non-oxidized subunit;
the polyisobutene comprises a non-oxidized subunit;
the hydroxylated polyisobutene comprises a second oxidized subunit and a non-oxidized subunit;
the first oxidized subunit has the formula: 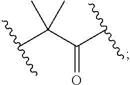 [SMILES: *C(=O)C(*)(C)C]
the second oxidized subunit has the formula: 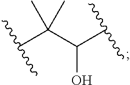 [SMILES: *C(O)C(*)(C)C]
the non-oxidized subunit has the formula: 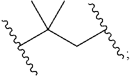 [SMILES: *CC(*)(C)C]
the ratio of the first oxidized subunit to the non-oxidized subunit in the oxidized polyisobutene is from 1:10,000 to 1:5;
the oxidized polyisobutene has a number average molecular weight from 250 Da to 20,000,000 Da; and
the hydroxylated polyisobutene has a number average molecular weight from 250 Da to 20,000,000 Da.

14.-16. (canceled)

17. The oxidized polyisobutene in a vessel of claim 13, wherein the metal catalyst is a ruthenium catalyst, an iron catalyst, or a nickel catalyst.

18. The oxidized polyisobutene in a vessel of claim 17, wherein the metal catalyst is

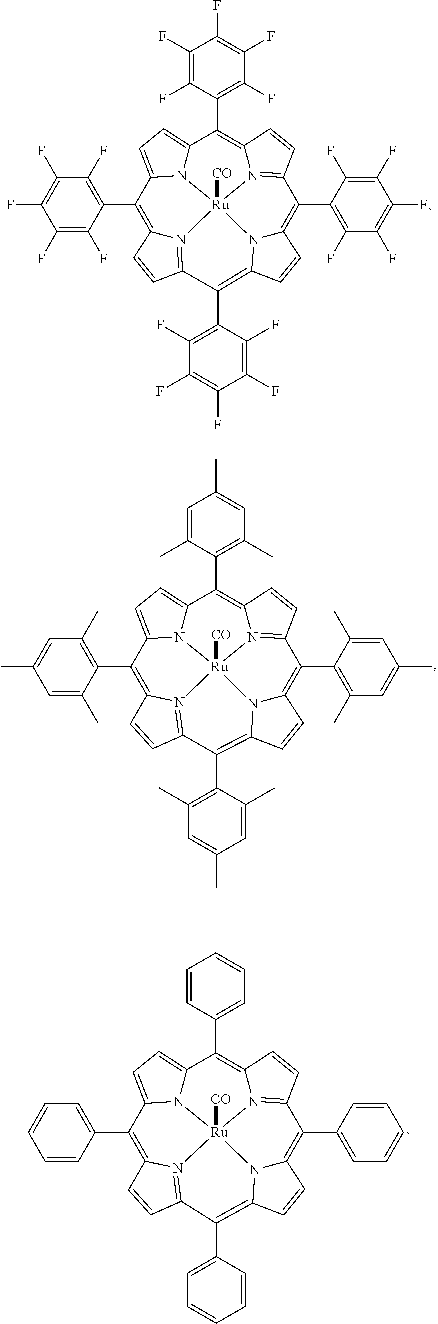

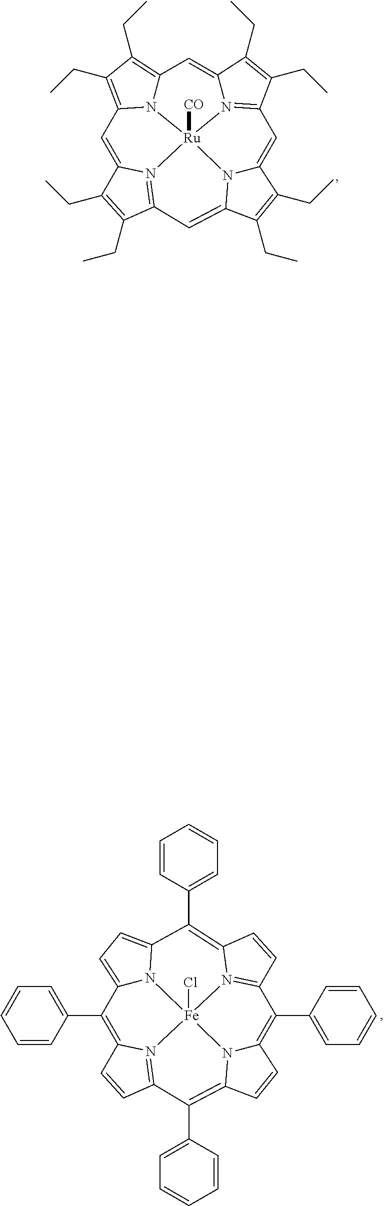

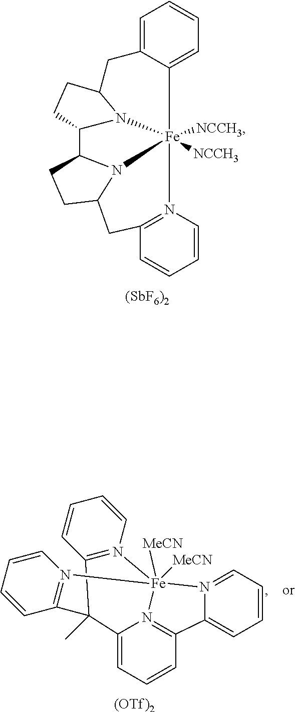

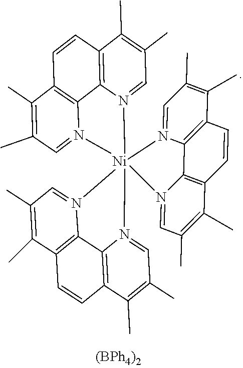

19. (canceled)

20. The oxidized polyisobutene in a vessel of claim 13, wherein the one or more additional compounds is the oxidizing agent and the vessel does not comprise the reducing agent.

21. The oxidized polyisobutene in a vessel of claim 20, wherein the oxidizing agent is a peroxide or a substituted pyridine N-oxide.

22.-23. (canceled)

24. The oxidized polyisobutene in a vessel of claim 13, wherein the one or more additional compound is the reducing agent and the vessel does not comprise the oxidizing agent.

25. The oxidized polyisobutene in a vessel of claim 24, wherein the reducing agent is an aluminum hydride or a boron hydride.

26. (canceled)

27. An oxidized polyisobutene, comprising a first oxidized subunit and a non-oxidized subunit;
the first oxidized subunit has the formula: 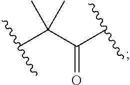 [SMILES: *C(=O)C(*)(C)C]
the non-oxidized subunit has the formula: 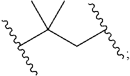 [SMILES: *CC(*)(C)C]
the ratio of the first oxidized subunit to the non-oxidized subunit is from 1:10,000 to 1:5; and
the oxidized polyisobutene has a number average molecular weight from 250 Da to 20,000,000 Da.

28. (canceled)

29. (canceled)

30. A mixture of polymers comprising an oxidized polyisobutene of claim 27 and a second polymer, wherein the second polymer is a high-density polyisobutene, a low-density polyisobutene, or a linear low-density polyisobutene.

31. (canceled)

32. A cross-linked polymer, wherein a first oxidized polyisobutene of claim 27 is covalently bonded to a second oxidized polyisobutene of claim 27 via a covalent linker having the formula: 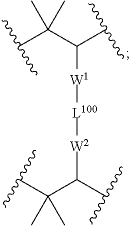
wherein
W¹ is —O— or —NR¹—;
W² is —O— or —NR²—;
R¹ and R² are independently hydrogen, halogen, —CX³₃, —CHX³₂, —CH₂X³, —OCX³₃, —OCH₂X³, —OCHX³₂, —CN, —SOₙ₃R³, —SOᵥ₃NR³R³, —NR³NR³R³, —ONR³R³, —NHC(O)NR³NR³R³, —NHC(O)NR³R³, —N(O)ₘ₃, —NR³R³, —C(O)R³, —C(O)OR³, —C(O)NR³R³, —OR³, —SR³, —NR³SO₂R³, —NR³C(O)R³, —NR³C(O)OR³, —NR³OR³, —SF₅, —N₃, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl;
R³ is independently hydrogen, oxo, halogen, —CCl₃, —CBr₃, —CF₃, —CI₃, —CHCl₂, —CHBr₂, —CHF₂, —CHI₂, —CH₂Cl, —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —OCCl₃, —OCF₃, —OCBr₃, —OCl₃, —OCHCl₂, —OCHBr₂, —OCHI₂, —OCHF₂, —OCH₂Cl, —OCH₂Br, —OCH₂I, —OCH₂F, —N₃, —SF₅, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl; two R³ substituents bonded to the same nitrogen atom may optionally be joined to form a substituted or unsubstituted heterocycloalkyl, or substituted or unsubstituted heteroaryl;
L¹⁰⁰ is -L¹⁰¹-L¹⁰²-L¹⁰³-;
L¹⁰¹ is a bond, —N(R¹⁰¹)—, —S—, —O—, —C(O)—, —C(O)O—, —OC(O)—, —N(R¹⁰¹)C(O)—, —C(O)N(R¹⁰¹)—, —NR¹¹⁰C(O)NR¹⁰¹—, —NR¹⁰¹C(NH)NH—, —C(S)—, —Si(R¹⁰¹)₂—, substituted or unsubstituted alkylene, substituted or unsubstituted heteroalkylene, substituted or unsubstituted cycloalkylene, substituted or unsubstituted heterocycloalkylene, substituted or unsubstituted arylene, or substituted or unsubstituted heteroarylene;
L¹⁰² is a bond, —N(R¹⁰²)—, —S—, —O—, —C(O)—, —C(O)O—, —OC(O)—, —N(R¹⁰²)C(O)—, —C(O)N(R¹⁰²)—, —NR¹⁰²C(O)NR¹⁰²—, —NR¹⁰²C(NH)NH—, —C(S)—, —Si(R¹⁰²)₂—, substituted or unsubstituted alkylene, substituted or unsubstituted heteroalkylene, substituted or unsubstituted cycloalkylene, substituted or unsubstituted heterocycloalkylene, substituted or unsubstituted arylene, or substituted or unsubstituted heteroarylene;
L¹⁰³ is a bond, —N(R¹⁰³)—, —S—, —O—, —C(O)—, —C(O)O—, —OC(O)—, —N(R¹⁰³)C(O)—, —C(O)N(R¹⁰³)—, —NR¹⁰³C(O)NR¹⁰³—, —NR¹⁰³C(NH)NH—, —C(S)—, —Si(R¹⁰³)₂—, substituted or unsubstituted alkylene, substituted or unsubstituted heteroalkylene, substituted or unsubstituted cycloalkylene, substituted or unsubstituted heterocycloalkylene, substituted or unsubstituted arylene, or substituted or unsubstituted heteroarylene;
R¹⁰¹, R¹⁰², and R¹⁰³ are each independently hydrogen, halogen, —CX¹⁰⁴₃, —CHX¹⁰⁴₂, —CH₂X¹⁰⁴, —OCX¹⁰⁴₃, —OCH₂X¹⁰⁴, —OCHX¹⁰⁴₂, —CN, —SOᵥ₁₀₄R¹⁰⁴, —SOᵥ₁₀₄NR¹⁰⁴R¹⁰⁴, —NR¹⁰⁴NR¹⁰⁴R¹⁰⁴, —ONR¹⁰⁴R¹⁰⁴, —NHC(O)NR¹⁰⁴NR¹⁰⁴R¹⁰⁴, —NHC(O)NR¹⁰⁴R¹⁰⁴, —N(O)ₘ₁₀₄, —NR¹⁰⁴R¹⁰⁴, —C(O)R¹⁰⁴, —C(O)OR¹⁰⁴, —C(O)NR¹⁰⁴R¹⁰⁴, —OR¹⁰⁴, —SR¹⁰⁴, —NR¹⁰⁴SO₂R¹⁰⁴, —NR¹⁰⁴C(O)R¹⁰⁴, —NR¹⁰⁴C(O)OR¹⁰⁴, —NR¹⁰⁴OR¹⁰⁴, —SF₅, —N₃, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl;
R¹⁰⁴ is independently hydrogen, oxo, halogen, —CCl₃, —CBr₃, —CF₃, —CI₃, —CHCl₂, —CHBr₂, —CHF₂, —CHI₂, —CH₂Cl, —CH₂Br, —CH₂F, —CH₂I, —CN, —OH, —NH₂, —COOH, —CONH₂, —NO₂, —SH, —SO₃H, —OSO₃H, —SO₂NH₂, —NHNH₂, —ONH₂, —NHC(O)NHNH₂, —NHC(O)NH₂, —NHSO₂H, —NHC(O)H, —NHC(O)OH, —NHOH, —OCCl₃, —OCF₃, —OCBr₃, —OCl₃, —OCHCl₂, —OCHBr₂, —OCHI₂, —OCHF₂, —OCH₂Cl, —OCH₂Br, —OCH₂I, —OCH₂F, —N₃, —SF₅, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl; two R¹⁰⁴ substituents bonded to the same nitrogen atom may optionally be joined to form a substituted or unsubstituted heterocycloalkyl, or substituted or unsubstituted heteroaryl;
X³ and X¹⁰⁴ are independently —F, —Cl, —Br, or —I;
n3 and n104 are independently an integer from 0 to 4; and
m3, m104, v3, and v104 are independently 1 or 2.

33. The cross-linked polymer of claim 32, wherein W¹ is —O— or —NH—.

34. (canceled)

35. The cross-linked polymer of claim 32, wherein W² is —O— or —NH—.

36. (canceled)

37. The cross-linked polymer of claim 32, wherein
L¹⁰¹ is —C(O)—, —C(O)NH—, or —Si(R¹⁰¹)₂—;
L¹⁰² is an unsubstituted alkylene;
L¹⁰³ is —C(O)—, —NHC(O)—, or —Si(R¹⁰³)₂—; and
R¹⁰¹ and R¹⁰³ are independently halogen, —OH, —NH₂, or substituted or unsubstituted heteroalkylene.

38. (canceled)

39. (canceled)

40. A mixture of polymers comprising a cross-linked polymer of claim 32 and a second polymer, wherein the second polymer is a high-density polyisobutene, a low-density polyisobutene, or a linear low-density polyisobutene.

41. (canceled)
